(19) United States
(12) Patent Application Publication
(10) Pub. No.: US 2025/0258575 A1
(43) Pub. Date: Aug. 14, 2025

(54) TECHNIQUES FOR MOTION MITIGATION

(71) Applicant: Apple Inc., Cupertino, CA (US)

(72) Inventors: Walter ROSINGER, Los Altos, CA (US); Andrew S. KIM, Walnut Creek, CA (US); Daniel DE ROCHA ROSARIO, San Francisco, CA (US); Korbinian B. SCHECK, San Francisco, CA (US); Manfred A. HARRER, Palo Alto, CA (US); Moritz VON VOLKMANN, Sunnyvale, CA (US); Yersultan SAPAR, Cupertino, CA (US)

(21) Appl. No.: 18/799,126

(22) Filed: Aug. 9, 2024

Related U.S. Application Data
(60) Provisional application No. 63/657,587, filed on Jun. 7, 2024.
(60) Provisional application No. 63/645,666, filed on May 10, 2024.
(60) Provisional application No. 63/552,602, filed on Feb. 12, 2024.

(51) Int. Cl. G06F 3/0481; G06F 1/16

(52) U.S. Cl. CPC G06F 3/0481; G06F 1/1694

(57) ABSTRACT

The present disclosure generally relates to the performance of motion mitigation techniques. Some techniques are for shifting the display of content, shifting the output of a sound field, altering content based on a gaze of a user, and/or altering content based on a state of a user.

### CROSS-REFERENCE TO RELATED APPLICATIONS

This application claims priority to U.S. Provisional Patent Application Ser. No. 63/657,587, entitled “TECHNIQUES FOR MOTION MITIGATION” filed Jun. 7, 2024, to U.S. Provisional Patent Application Ser. No. 63/645,666, entitled “TECHNIQUES FOR MOTION MITIGATION” filed May 10, 2024, and to U.S. Provisional Patent Application Ser. No. 63/552,602, entitled “TECHNIQUES FOR MOTION MITIGATION” filed Feb. 12, 2024, which are hereby incorporated by reference in their entireties for all purposes.

### BACKGROUND

Various hardware exists for providing visual and sound effects, such as speakers, lights, and displays. Such hardware can be controlled and/or programmed to provide visual and sound effects under various circumstances.

### BRIEF SUMMARY

In some embodiments, a method includes: while displaying, via the display, a user interface object in an initial manner, detecting, via the one or more input devices, acceleration in a first direction; in response to detecting the acceleration in the first direction, displaying, via the display, the user interface object in a subsequent manner different than the initial manner based on the acceleration; after displaying the user interface object in the subsequent manner based on the acceleration, continuing to detect, via the one or more input devices, the acceleration in the first direction; and in response to continuing to detect the acceleration in the first direction, displaying, via the display, the user interface object in the initial manner.

In some embodiments, a computer-readable storage medium (e.g., a non-transitory computer-readable storage medium or a transitory computer-readable storage medium) stores one or more programs configured to be executed by one or more processors of a computer system that is in communication with a display and one or more input devices. The one or more programs include instructions for: while displaying, via the display, a user interface object in an initial manner, detecting, via the one or more input devices, acceleration in a first direction; in response to detecting the acceleration in the first direction, displaying, via the display, the user interface object in a subsequent manner different than the initial manner based on the acceleration; after displaying the user interface object in the subsequent manner based on the acceleration, continuing to detect, via the one or more input devices, the acceleration in the first direction; and in response to continuing to detect the acceleration in the first direction, displaying, via the display, the user interface object in the initial manner.

In some embodiments, a computer system includes a display, one or more input devices, one or more processors, and memory storing one or more programs configured to be executed by the one or more processors. The one or more programs include instructions for: while displaying, via the display, a user interface object in an initial manner, detecting, via the one or more input devices, acceleration in a first direction; in response to detecting the acceleration in the first direction, displaying, via the display, the user interface object in a subsequent manner different than the initial manner based on the acceleration; after displaying the user interface object in the subsequent manner based on the acceleration, continuing to detect, via the one or more input devices, the acceleration in the first direction; and in response to continuing to detect the acceleration in the first direction, displaying, via the display, the user interface object in the initial manner.

In some embodiments, a computer system includes: while displaying a user interface object in an initial manner, means for detecting acceleration in a first direction; in response to detecting the acceleration in the first direction, means for displaying the user interface object in a subsequent manner different than the initial manner based on the acceleration; after displaying the user interface object in the subsequent manner based on the acceleration, means for continuing to detect the acceleration in the first direction; and in response to continuing to detect the acceleration in the first direction, means for displaying the user interface object in the initial manner.

In some embodiments, a computer program product includes one or more programs configured to be executed by one or more processors of a computer system that is in communication with a display and one or more input devices. The one or more programs include instructions for: while displaying, via the display, a user interface object in an initial manner, detecting, via the one or more input devices, acceleration in a first direction; in response to detecting the acceleration in the first direction, displaying, via the display, the user interface object in a subsequent manner different than the initial manner based on the acceleration; after displaying the user interface object in the subsequent manner based on the acceleration, continuing to detect, via the one or more input devices, the acceleration in the first direction; and in response to continuing to detect the acceleration in the first direction, displaying, via the display, the user interface object in the initial manner.

In some embodiments, a method that is performed at a computer system that is in communication with an input device and a display generation component is described. In some embodiments, the method comprises: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a non-transitory computer-readable storage medium storing one or more programs configured to be executed by one or more processors of a computer system that is in communication with an input device and a display generation component is described. In some embodiments, the one or more programs includes instructions for: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a transitory computer-readable storage medium storing one or more programs configured to be executed by one or more processors of a computer system that is in communication with an input device and a display generation component is described. In some embodiments, the one or more programs includes instructions for: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a computer system configured to communicate with an input device and a display generation component is described. In some embodiments, the computer system comprises one or more processors and memory storing one or more programs configured to be executed by the one or more processors. In some embodiments, the one or more programs includes instructions for: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a computer system configured to communicate with an input device and a display generation component is described. In some embodiments, the computer system comprises means for performing each of the following steps: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a computer program product is described. In some embodiments, the computer program product comprises one or more programs configured to be executed by one or more processors of a computer system that is in communication with an input device and a display generation component. In some embodiments, the one or more programs include instructions for: while displaying, via the display generation component, content, detecting, via the input device, motion that satisfies a first set of one or more criteria; in response to detecting the motion that satisfies the first set of one or more criteria: continuing display of a first portion of the content; and ceasing display of a second portion, different from the first portion, of the content; while displaying the first portion of the content and not displaying the second portion of the content, detecting, via the input device, motion that no longer satisfies the first set of one or more criteria; and in response to detecting the motion that no longer satisfies the first set of one or more criteria: continuing display of the first portion of the content; and displaying, via the display generation component, the second portion of the content.

In some embodiments, a method that is performed at a computer system that is in communication with an input device, a display generation component, and an audio generation component is described. In some embodiments, the method comprises: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a non-transitory computer-readable storage medium storing one or more programs configured to be executed by one or more processors of a computer system that is in communication with an input device, a display generation component, and an audio generation component is described. In some embodiments, the one or more programs includes instructions for: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a transitory computer-readable storage medium storing one or more programs configured to be executed by one or more processors of a computer system that is in communication with an input device, a display generation component, and an audio generation component is described. In some embodiments, the one or more programs includes instructions for: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a computer system configured to communicate with an input device, a display generation component, and an audio generation component is described. In some embodiments, the computer system comprises one or more processors and memory storing one or more programs configured to be executed by the one or more processors. In some embodiments, the one or more programs includes instructions for: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a computer system configured to communicate with an input device, a display generation component, and an audio generation component is described. In some embodiments, the computer system comprises means for performing each of the following steps: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a computer program product is described. In some embodiments, the computer program product comprises one or more programs configured to be executed by one or more processors of a computer system that is in communication with an input device, a display generation component, and an audio generation component. In some embodiments, the one or more programs include instructions for: while displaying, via the display generation component, content, detecting, via the input device, motion; in response to detecting the motion: in accordance with a determination that a first set of one or more criteria is satisfied, wherein the first set of one or more criteria includes a criterion that is satisfied when the motion is a first amount of motion, altering, via the audio generation component, an audio characteristic of a sound field corresponding to the content by a first amount; and in accordance with a determination that a second set of one or more criteria, different from the first set of one or more criteria, is satisfied, wherein the second set of one or more criteria includes a criterion that is satisfied when the motion is a second amount of motion different from the first amount of motion, altering, via the audio generation component, the audio characteristic of the sound field corresponding to the content by a second amount different from the first amount.

In some embodiments, a method that is performed at a computer system that is in communication with an input device and a display generation component is described. In some embodiments, the method comprises: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a non-transitory computer-readable storage medium storing one or more programs configured to be executed by one or more processors of a computer system that is in communication with an input device and a display generation component is described. In some embodiments, the one or more programs includes instructions for: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a transitory computer-readable storage medium storing one or more programs configured to be executed by one or more processors of a computer system that is in communication with an input device and a display generation component is described. In some embodiments, the one or more programs includes instructions for: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a computer system configured to communicate with an input device and a display generation component is described. In some embodiments, the computer system comprises one or more processors and memory storing one or more programs configured to be executed by the one or more processors. In some embodiments, the one or more programs includes instructions for: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a computer system configured to communicate with an input device and a display generation component is described. In some embodiments, the computer system comprises means for performing each of the following steps: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a computer program product is described. In some embodiments, the computer program product comprises one or more programs configured to be executed by one or more processors of a computer system that is in communication with an input device and a display generation component. In some embodiments, the one or more programs include instructions for: while displaying, via the display generation component, content in a first manner, detecting, via the input device, motion; and in response to detecting the motion: in accordance with a determination that a user is directing attention to a first portion of the content, displaying, via the display generation component, the first portion of the content in a second manner, different from the first manner, based on the motion; and in accordance with a determination that the user is directing attention to a second portion of the content different from the first portion of the content, continuing display of, via the display generation component, the first portion of the content in the first manner.

In some embodiments, a method that is performed at a computer system that is in communication with an input device and a display generation component is described. In some embodiments, the method comprises: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, a non-transitory computer-readable storage medium storing one or more programs configured to be executed by one or more processors of a computer system that is in communication with an input device and a display generation component is described. In some embodiments, the one or more programs includes instructions for: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, a transitory computer-readable storage medium storing one or more programs configured to be executed by one or more processors of a computer system that is in communication with an input device and a display generation component is described. In some embodiments, the one or more programs includes instructions for: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, a computer system configured to communicate with an input device and a display generation component is described. In some embodiments, the computer system comprises one or more processors and memory storing one or more programs configured to be executed by the one or more processors. In some embodiments, the one or more programs includes instructions for: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, a computer system configured to communicate with an input device and a display generation component is described. In some embodiments, the computer system comprises means for performing each of the following steps: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, a computer program product is described. In some embodiments, the computer program product comprises one or more programs configured to be executed by one or more processors of a computer system that is in communication with an input device and a display generation component. In some embodiments, the one or more programs include instructions for: while displaying, via the display generation component, content, detecting, via the input device, motion; in response to detecting the motion: continuing display of, via the display generation component, a first portion of the content; and ceasing display of, via the display generation component, a second portion of the content different from the first portion of the content; while forgoing display of the second portion of the content, continuing to detect, via the input device, the motion; and in response to continuing to detect the motion: in accordance with a determination that a user satisfies a first set of one or more criteria, ceasing display of, via the display generation component, a third portion of the content different from the first portion of the content and the second portion of the content, wherein the third portion of the content includes the second portion of the content; and in accordance with a determination that the user does not satisfy the first set of one or more criteria, continuing display of, via the display component, the first portion of the content without ceasing display of the third portion of the content.

In some embodiments, executable instructions for performing these functions are included in a non-transitory computer-readable storage medium or other computer program product configured for execution by one or more processors. In some embodiments, executable instructions for performing these functions are included in a transitory computer-readable storage medium or other computer program product configured for execution by one or more processors.

### BRIEF DESCRIPTION OF THE FIGURES

To better understand the various described embodiments, reference should be made to the Description of Embodiments below, along with the following drawings in which like reference numerals refer to corresponding parts throughout the figures.

FIG. 1A illustrates an example system for implementing the techniques described herein.

FIGS. 1B-1G illustrate the use of Application Programming Interfaces (APIs) to perform operations in accordance with some embodiments.

FIGS. 2A-2Q illustrate techniques for displaying user interfaces based on detected motion according to some embodiments.

FIG. 3 is a flow diagram that illustrates a method for displaying user interfaces based on detected motion according to some embodiments.

FIGS. 4A-4C illustrate example techniques for displaying user interface elements based on motion in accordance with some embodiments.

FIGS. 5A-5D illustrate example graphs for how a graphical element can change as the graphical element changes position in accordance with some embodiments.

FIG. 6 is a flow diagram that illustrates a method for displaying user interfaces based on detected motion according to some embodiments.

FIGS. 7A-7H illustrate exemplary user interfaces for mitigating the effects of motion in accordance with some embodiments.

FIG. 8 is a flow diagram illustrating a method for shifting the display of content in accordance with some embodiments.

FIG. 9 is a flow diagram illustrating a method for shifting the output of a sound field in accordance with some embodiments.

FIGS. 10A-10G illustrate exemplary user interfaces for altering content based on a gaze of a user in accordance with some embodiments.

FIG. 11 is a flow diagram illustrating a method for altering content based on a gaze of a user in accordance with some embodiments.

FIGS. 12A-12L illustrate exemplary user interfaces altering content based on a state of a user in accordance with some embodiments.

FIG. 13 is a flow diagram illustrating a method for altering content based on a state of a user in accordance with some embodiments.

### DESCRIPTION OF EMBODIMENTS

The following description sets forth exemplary methods, parameters, and the like. However, such description is not intended as a limitation on the scope of the present disclosure but is instead provided as a description of exemplary embodiments.

Although the following description uses terms “first,” “second,” etc. to describe various elements, these elements should not be limited by the terms. In some embodiments, these terms are used to distinguish one element from another. For example, a first item could be termed a second item, and, similarly, a second item could be termed a first item, without departing from the scope of the various described embodiments. In some embodiments, the first item and the second item are two separate references to the same item. In some embodiments, the first item and the second item are both the same type of item, but they are not the same item.

The terminology used in the description of the various described embodiments herein is for the purpose of describing particular embodiments only and is not intended to be limiting. The singular forms “a,” “an,” and “the” are intended to include the plural forms as well, unless the context clearly indicates otherwise. The term “and/or” refers to and encompasses any and all possible combinations of one or more of the associated listed items. The terms “includes,” “including,” “comprises,” and/or “comprising” specify the presence of stated features, steps, operations, elements, and/or components, but do not preclude the presence or addition of one or more other features, steps, operations, elements, components, and/or groups thereof.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

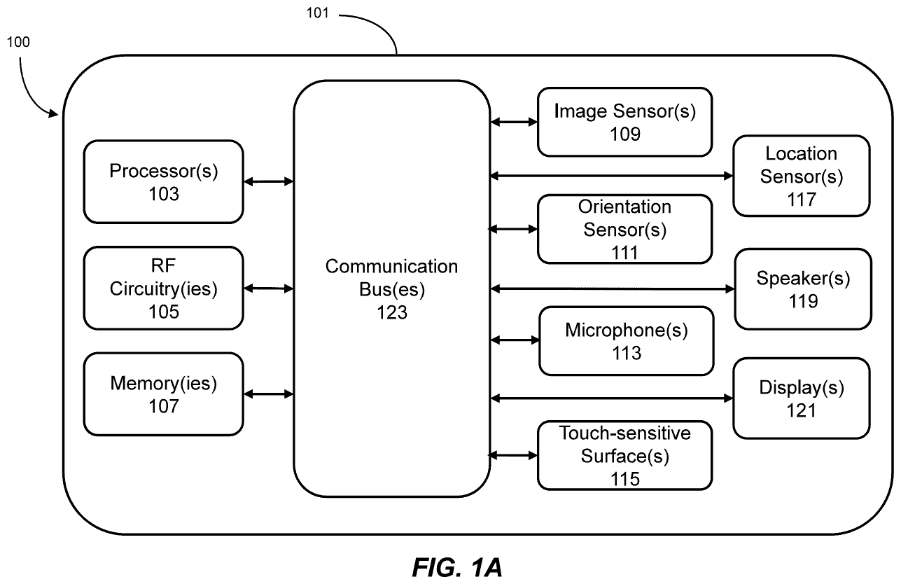

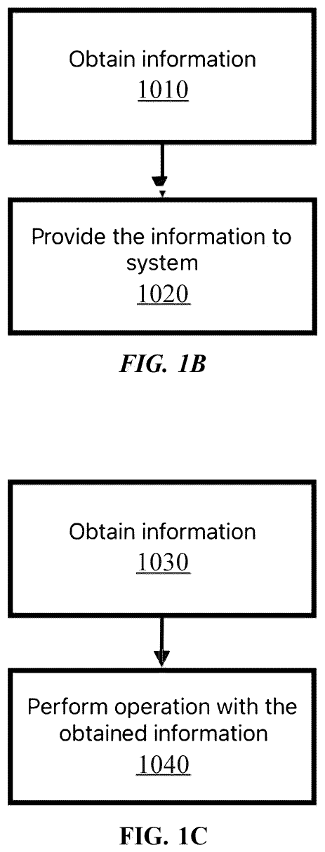

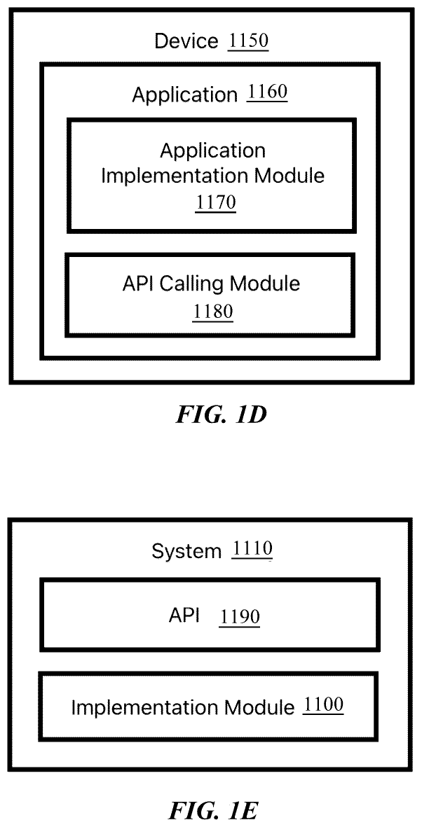

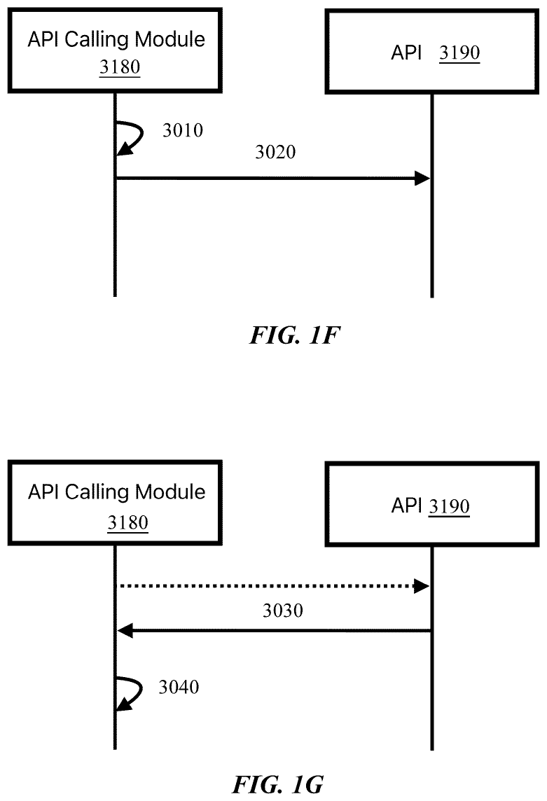

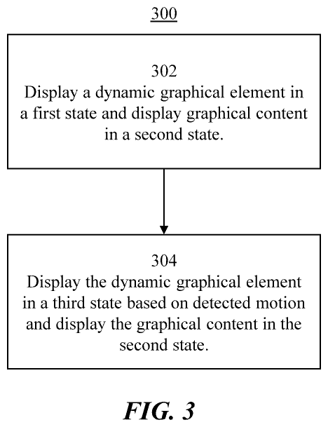

FIG. 1A illustrates an example system 100 for implementing the techniques described herein. System 100 can perform any of the methods described in FIGS. 3 and/or 6 (e.g., methods 300 and/or 600) or portions thereof.

In FIG. 1A, system 100 includes device 101. Device 101 includes various components, such as processor(s) 103, RF circuitry(ies) 105, memory(ies) 107, image sensor(s) 109, orientation sensor(s) 110, microphone(s) 113, location sensor(s) 117, speaker(s) 119, display(s) 121, and touch-sensitive surface(s) 115. These components optionally communicate over communication bus(es) 123 of device 101. In some embodiments, system 100 includes two or more devices that include some or all of the features of device 101.

In some examples, system 100 is a desktop computer, embedded computer, and/or a server. In some examples, system 100 is a mobile device such as, e.g., a smartphone, smartwatch, laptop computer, and/or tablet computer. In some examples, system 100 is a head-mounted display (HMD) device. In some examples, system 100 is a wearable HUD device.

System 100 includes processor(s) 103 and memory(ies) 107. Processor(s) 103 include one or more general processors, one or more graphics processors, and/or one or more digital signal processors. In some examples, memory(ies) 107 are one or more non-transitory computer-readable storage mediums (e.g., flash memory and/or random access memory) that store computer-readable instructions configured to be executed by processor(s) 103 to perform the techniques described herein.

System 100 includes RF circuitry(ies) 105. RF circuitry(ies) 105 optionally include circuitry for communicating with electronic devices, networks, such as the Internet, intranets, and/or a wireless network, such as cellular networks and wireless local area networks (LANs). RF circuitry(ies) 105 optionally includes circuitry for communicating using near-field communication and/or short-range communication, such as Bluetooth®.

System 100 includes display(s) 121. In some examples, display(s) 121 include one or more monitors, projectors, and/or screens. In some examples, display(s) 121 include a first display for displaying images to a first eye of the user and a second display for displaying images to a second eye of the user. Corresponding images are simultaneously displayed on the first display and the second display. Optionally, the corresponding images include the same virtual objects and/or representations of the same physical objects from different viewpoints, resulting in a parallax effect that provides a user with the illusion of depth of the objects on the displays. In some examples, display(s) 121 include a single display. Corresponding images are simultaneously displayed on a first area and a second area of the single display for each eye of the user. Optionally, the corresponding images include the same virtual objects and/or representations of the same physical objects from different viewpoints, resulting in a parallax effect that provides a user with the illusion of depth of the objects on the single display.

In some examples, system 100 includes touch-sensitive surface(s) 115 for receiving user inputs, such as tap inputs and swipe inputs. In some examples, display(s) 121 and touch-sensitive surface(s) 115 form touch-sensitive display(s).

System 100 includes image sensor(s) 109. Image sensor(s) 109 optionally include one or more visible light image sensor, such as charged coupled device (CCD) sensors, and/or complementary metal-oxide-semiconductor (CMOS) sensors operable to obtain images of physical objects. Image sensor(s) also optionally include one or more infrared (IR) sensor(s), such as a passive IR sensor or an active IR sensor, for detecting infrared light. For example, an active IR sensor includes an IR emitter, such as an IR dot emitter, for emitting infrared light. Image sensor(s) 109 also optionally include one or more camera(s) configured to capture movement of physical objects. Image sensor(s) 109 also optionally include one or more depth sensor(s) configured to detect the distance of physical objects from system 100. In some examples, system 100 uses CCD sensors, cameras, and depth sensors in combination to detect the physical environment around system 100. In some examples, image sensor(s) 109 include a first image sensor and a second image sensor. In some examples, system 100 uses image sensor(s) 109 to receive user inputs, such as hand gestures. In some examples, system 100 uses image sensor(s) 109 to detect the position and orientation of system 100 in the physical environment.

In some examples, system 100 includes microphones(s) 113. System 100 uses microphone(s) 113 to detect sound from the user and/or the physical environment of the user. In some examples, microphone(s) 113 includes an array of microphones (including a plurality of microphones) that optionally operate in tandem, such as to identify ambient noise or to locate the source of sound in space of the physical environment.

System 100 includes orientation sensor(s) 111 for detecting orientation and/or movement of system 100. For example, system 100 uses orientation sensor(s) 111 to track changes in the position and/or orientation of system 100, such as with respect to physical objects in the physical environment. Orientation sensor(s) 111 optionally include one or more gyroscopes, one or more inertial measurement units, and/or one or more accelerometers.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 1160) that, when executed by one or more processing units, control an electronic device (e.g., device 1150) to perform the method of FIG. 1B, the method of FIG. 1C, and/or one or more other processes and/or methods described herein.

It should be recognized that application 1160 (shown in FIG. 1D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 1160 is an application that is pre-installed on device 1150 at purchase (e.g., a first party application). In some embodiments, application 1160 is an application that is provided to device 1150 via an operating system update file (e.g., a first party application or a second-party application). In some embodiments, application 1160 is an application that is provided via an application store. In some embodiments, the application store can be an application store that is pre-installed on device 1150 at purchase (e.g., a first-party application store). In some embodiments, the application store is a third-party application store (e.g., an application store that is provided by another application store, downloaded via a network, and/or read from a storage device).

Referring to FIG. 1B and FIG. 1F, application 1160 obtains information (e.g., 1010). In some embodiments, at 1010, information is obtained from at least one hardware component of device 1150. In some embodiments, at 1010, information is obtained from at least one software module of device 1150. In some embodiments, at 1010, information is obtained from at least one hardware component external to device 1150 (e.g., a peripheral device, an accessory device, and/or a server, etc.). In some embodiments, the information obtained at 1010 includes positional information, time information, notification information, user information, environment information, electronic device state information, weather information, media information, historical information, event information, hardware information, and/or motion information. In some embodiments, in response to and/or after obtaining the information at 1010, application 1160 provides the information to a system (e.g., 1020).

In some embodiments, the system (e.g., 1110 shown in FIG. 1E) is an operating system hosted on device 1150. In some embodiments, the system (e.g., 1110 shown in FIG. 1E) is an external device (e.g., a server, a peripheral device, an accessory, and/or a personal computing device.) that includes an operating system.

Referring to FIG. 1C and FIG. 1G, application 1160 obtains information (e.g., 1030). In some embodiments, the information obtained at 1030 includes positional information, time information, notification information, user information, environment information, electronic device state information, weather information, media information, historical information, event information, hardware information, and/or motion information. In response to and/or after obtaining the information at 1030, application 1160 performs an operation with the information (e.g., 1040). In some embodiments, the operation performed at 1040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1110 based on the information.

In some embodiments, one or more steps of the method of FIG. 1B and/or the method of FIG. 1C is performed in response to a trigger. In some embodiments, the trigger includes detection of an event, a notification received from system 1110, a user input, and/or a response to a call to an API provided by system 1110.

In some embodiments, the instructions of application 1160, when executed, control device 1150 to perform the method of FIG. 1B and/or the method of FIG. 1C by calling an application programming interface (API) (e.g., API 1190) provided by system 1110. In some embodiments, application 1160 performs at least a portion of the method of FIG. 1B and/or the method of FIG. 1C without calling API 1190.

In some embodiments, one or more steps of the method of FIG. 1B and/or the method of FIG. 1C includes calling an API (e.g., API 1190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1D, device 1150 is illustrated. In some embodiments, device 1150 is a personal computing device, a smart phone, a smart watch, a fitness tracker, a head mounted display (HMD) device, a media device, a communal device, a speaker, a television, and/or a tablet. As illustrated in FIG. 1D, device 1150 includes application 1160 and an operating system (e.g., system 1110 shown in FIG. 1E). Application 1160 includes application implementation module 1170 and API-calling module 1180. System 1110 includes API 1190 and implementation module 1100. It should be recognized that device 1150, application 1160, and/or system 1110 can include more, fewer, and/or different components than illustrated in FIGS. 1D and 1E.

In some embodiments, application implementation module 1170 includes a set of one or more instructions corresponding to one or more operations performed by application 1160. For example, when application 1160 is a messaging application, application implementation module 1170 can include operations to receive and send messages. In some embodiments, application implementation module 1170 communicates with API-calling module 1180 to communicate with system 1110 via API 1190 (shown in FIG. 1E).

In some embodiments, API 1190 is a software module (e.g., a collection of computer-readable instructions) that provides an interface that allows a different module (e.g., API-calling module 1180) to access and/or use one or more functions, methods, procedures, data structures, classes, and/or other services provided by implementation module 1100 of system 1110. For example, API-calling module 1180 can access a feature of implementation module 1100 through one or more API calls or invocations (e.g., embodied by a function or a method call) exposed by API 1190 (e.g., a software and/or hardware module that can receive API calls, respond to API calls, and/or send API calls) and can pass data and/or control information using one or more parameters via the API calls or invocations. In some embodiments, API 1190 allows application 1160 to use a service provided by a Software Development Kit (SDK) library. In some embodiments, application 1160 incorporates a call to a function or method provided by the SDK library and provided by API 1190 or uses data types or objects defined in the SDK library and provided by API 1190. In some embodiments, API-calling module 1180 makes an API call via API 1190 to access and use a feature of implementation module 1100 that is specified by API 1190. In such embodiments, implementation module 1100 can return a value via API 1190 to API-calling module 1180 in response to the API call. The value can report to application 1160 the capabilities or state of a hardware component of device 1150, including those related to aspects such as input capabilities and state, output capabilities and state, processing capability, power state, storage capacity and state, and/or communications capability. In some embodiments, API 1190 is implemented in part by firmware, microcode, or other low-level logic that executes in part on the hardware component.

In some embodiments, API 1190 allows a developer of API-calling module 1180 (which can be a third-party developer) to leverage a feature provided by implementation module 1100. In such embodiments, there can be one or more API-calling modules (e.g., including API-calling module 1180) that communicate with implementation module 1100. In some embodiments, API 1190 allows multiple API-calling modules written in different programming languages to communicate with implementation module 1100 (e.g., API 1190 can include features for translating calls and returns between implementation module 1100 and API-calling module 1180) while API 1190 is implemented in terms of a specific programming language. In some embodiments, API-calling module 1180 calls APIs from different providers such as a set of APIs from an OS provider, another set of APIs from a plug-in provider, and/or another set of APIs from another provider (e.g., the provider of a software library) or creator of the another set of APIs.

Examples of API 1190 can include one or more of: a pairing API (e.g., for establishing a secure connection, (e.g., with an accessory), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 1150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1100 is a system (e.g., operating system, and/or server system) software module (e.g., a collection of computer-readable instructions) that is constructed to perform an operation in response to receiving an API call via API 1190. In some embodiments, implementation module 1100 is constructed to provide an API response (via API 1190) as a result of processing an API call. By way of example, implementation module 1100 and API-calling module 1180 can each be any one of an operating system, a library, a device driver, an API, an application program, or other module. It should be understood that implementation module 1100 and API-calling module 1180 can be the same or different type of module from each other. In some embodiments, implementation module 1100 is embodied at least in part in firmware, microcode, or hardware logic.

In some embodiments, implementation module 1100 returns a value through API 1190 in response to an API call from API-calling module 1180. While API 1190 defines the syntax and result of an API call (e.g., how to invoke the API call and what the API call does), API 1190 might not reveal how implementation module 1100 accomplishes the function specified by the API call. Various API calls are transferred via the one or more application programming interfaces between API-calling module 1180 and implementation module 1100. Transferring the API calls can include issuing, initiating, invoking, calling, receiving, returning, and/or responding to the function calls or messages. In other words, transferring can describe actions by either of API-calling module 1180 or implementation module 1100. In some embodiments, a function call or other invocation of API 1190 sends and/or receives one or more parameters through a parameter list or other structure.

In some embodiments, implementation module 1100 provides more than one API, each providing a different view of or with different aspects of functionality implemented by implementation module 1100. For example, one API of implementation module 1100 can provide a first set of functions and can be exposed to third party developers, and another API of implementation module 1100 can be hidden (e.g., not exposed) and provide a subset of the first set of functions and also provide another set of functions, such as testing or debugging functions which are not in the first set of functions. In some embodiments, implementation module 1100 calls one or more other components via an underlying API and thus is both an API calling module and an implementation module. It should be recognized that implementation module 1100 can include additional functions, methods, classes, data structures, and/or other features that are not specified through API 1190 and are not available to API-calling module 1180. It should also be recognized that API-calling module 1180 can be on the same system as implementation module 1100 or can be located remotely and access implementation module 1100 using API 1190 over a network. In some embodiments, implementation module 1100, API 1190, and/or API-calling module 1180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

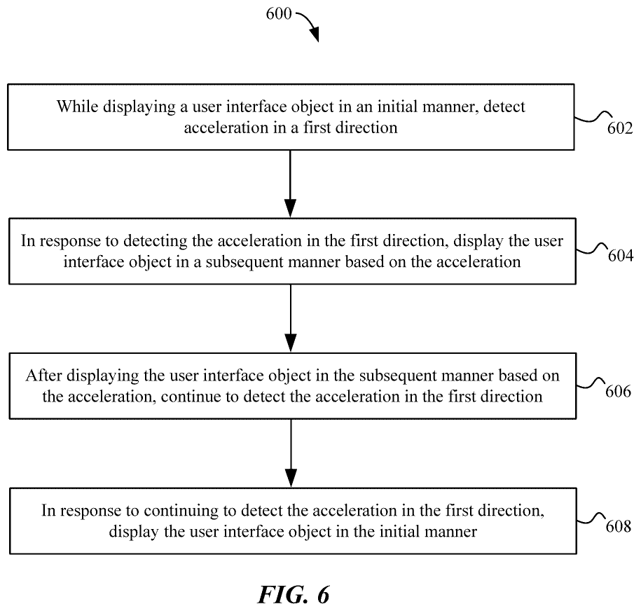

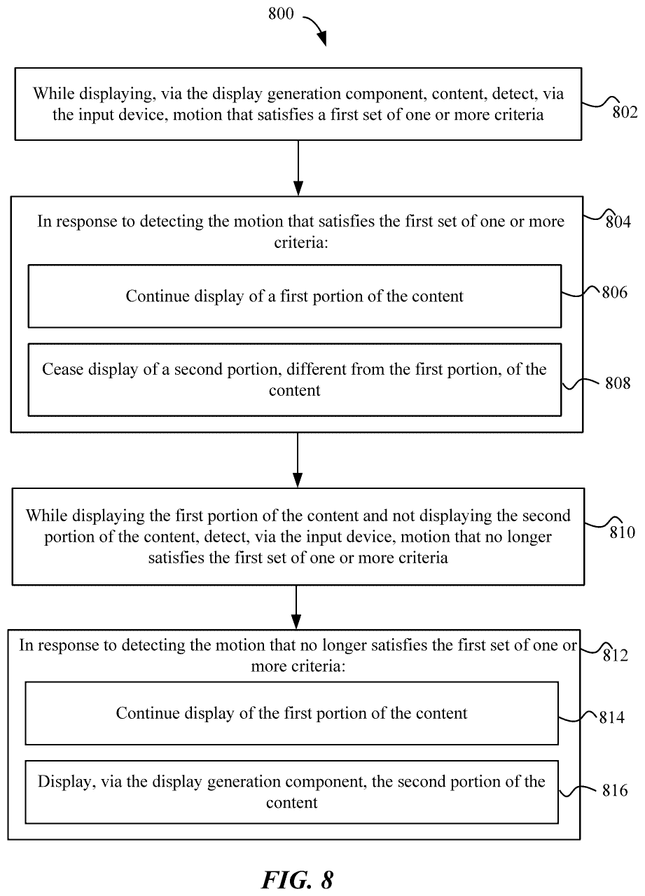

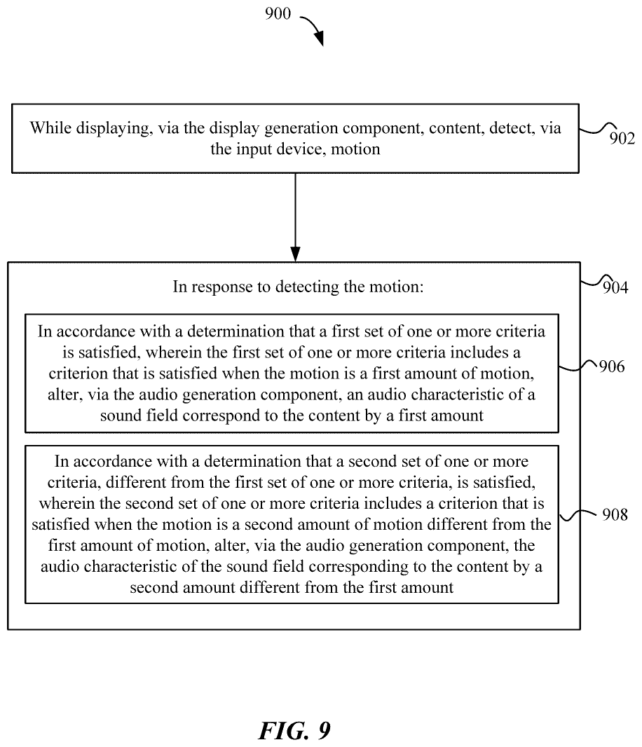

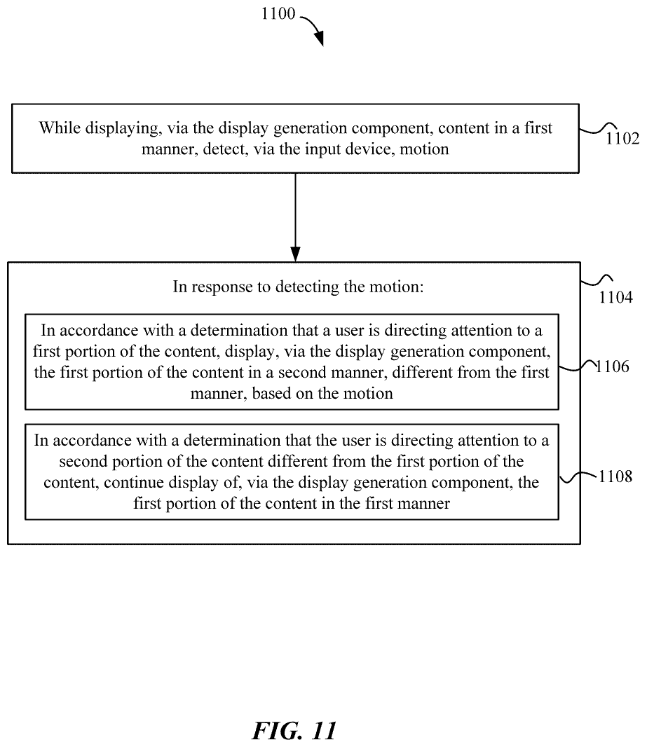

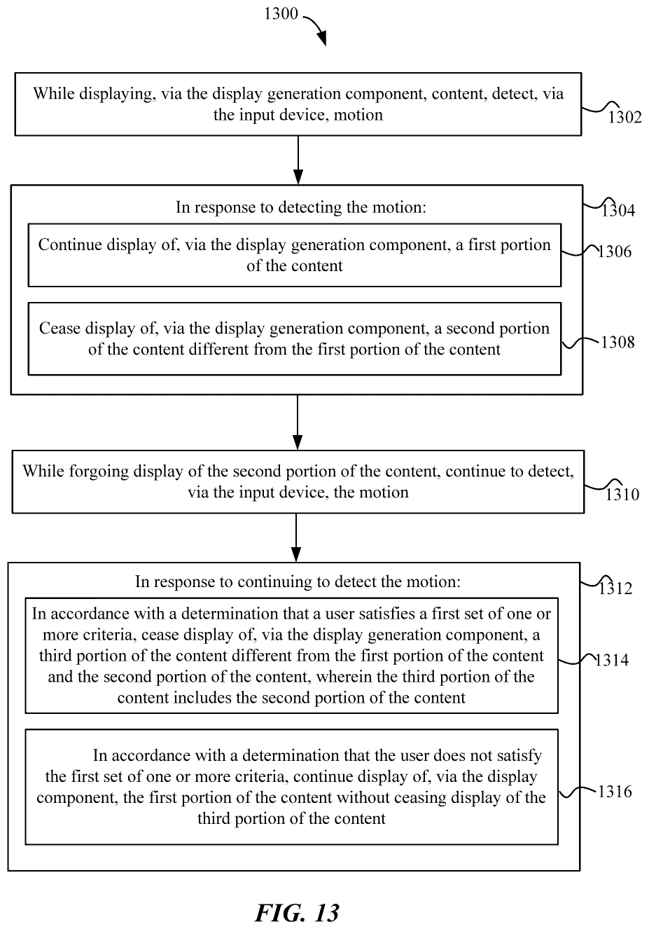

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 300 (FIG. 3), method 600 (FIG. 6), method 800 (FIG. 8), method 900 (FIG. 9), method 1100 (FIG. 11), and/or method 1300 (FIG. 13) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 1190 defines a first API call that can be provided by AP I-calling module 1180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1150) that runs the application. In some embodiments, the implementation module is included in an electronic device that is separate from the device that runs the application.

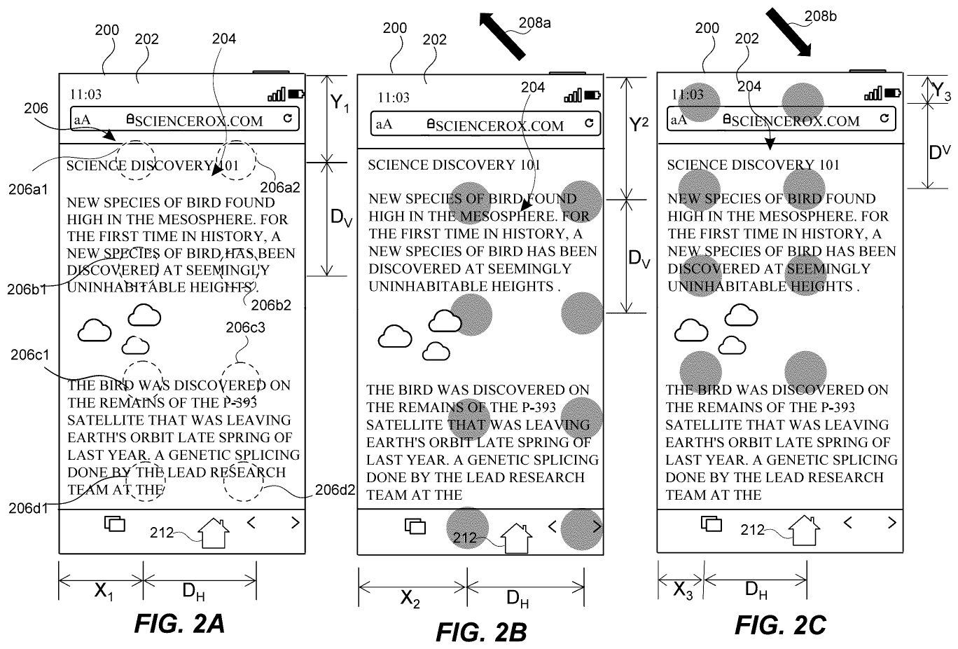

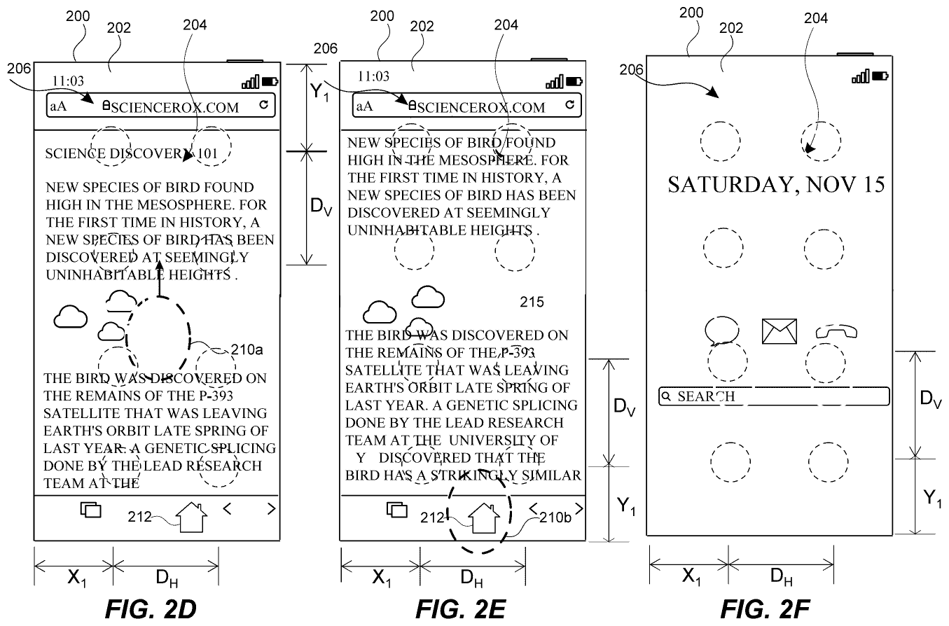

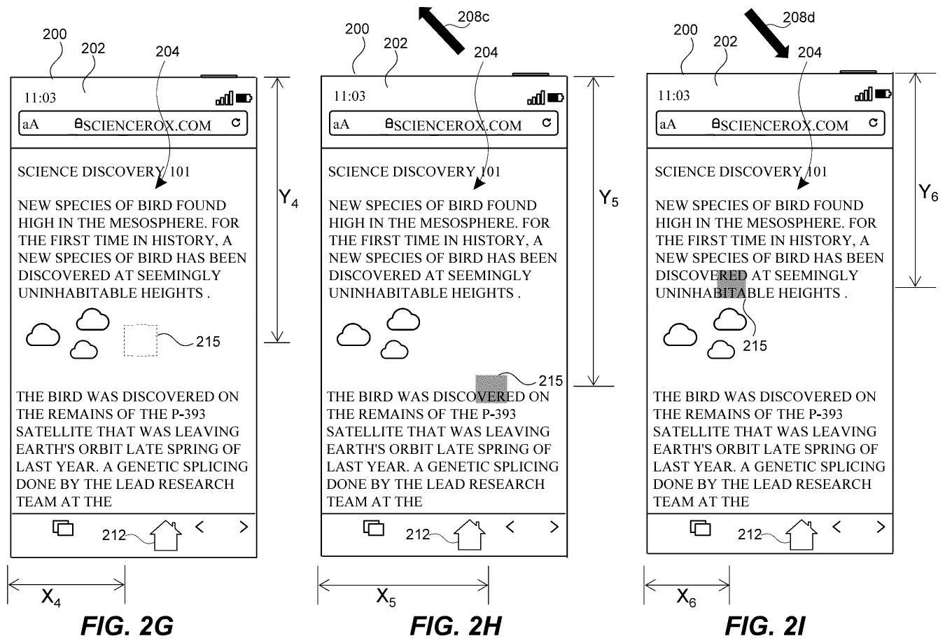

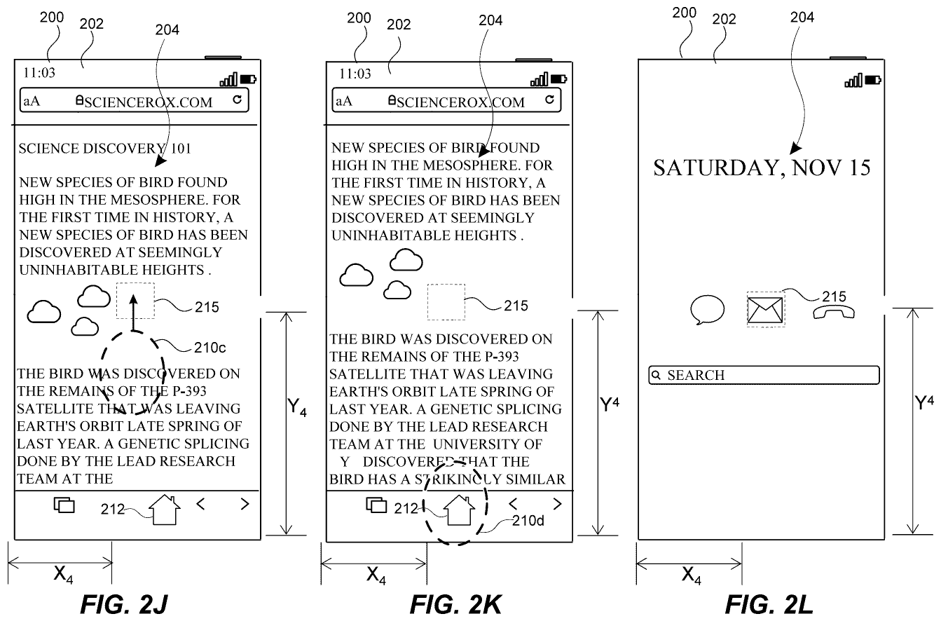

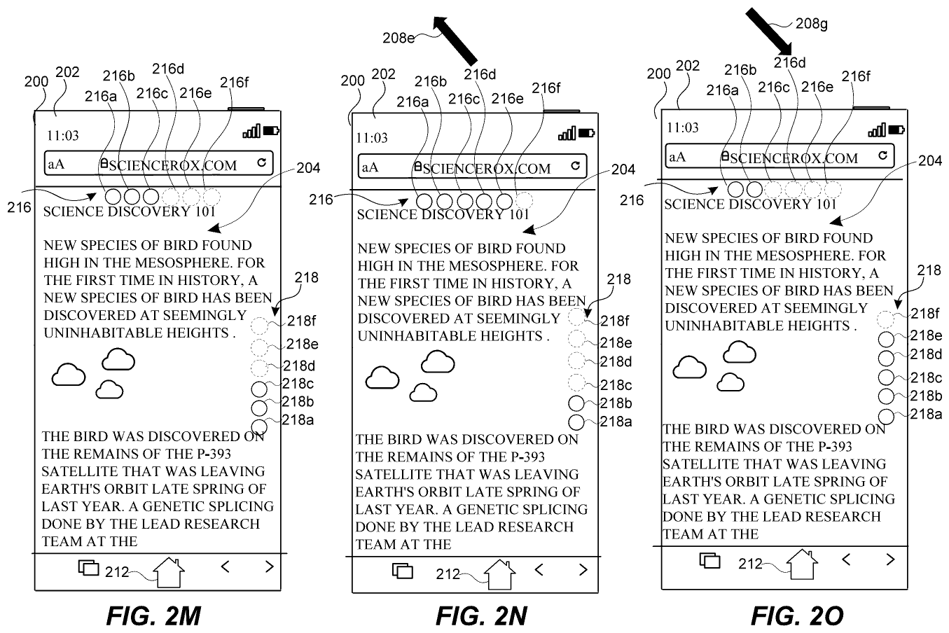

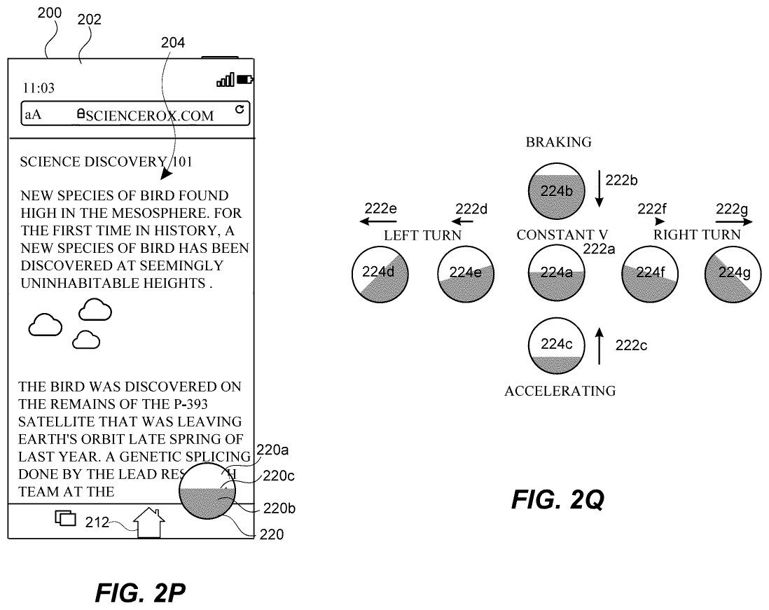

FIGS. 2A-2Q illustrate example techniques for displaying user interfaces based on motion. The techniques can be used to make motion more comfortable for a person. Some people experience discomfort such as motion sickness or simulation sickness when there is a disconnect between the motion that the person is physically experiencing and motion that the person perceives through sight and/or hearing. For example, a person may experience motion sickness when looking at a display and/or using an electronic device such as a smartphone, laptop computer, smartwatch, or tablet computer while riding in a car because the person feels the motion of the car but is not looking at the movement of the surrounding environment. As another example, a person may experience simulation sickness when viewing moving content on a display or content that makes it appear as though the person is moving (e.g., a first-person perspective in a virtual environment) when the person is not physically moving. In some embodiments, the techniques described can help with motion comfort while a user is viewing and/or interacting with content displayed on an electronic device.

FIG. 2A illustrates computer system 200 with display 202. In FIG. 2A, content 204 and dynamic element 206 are displayed. In the embodiment illustrated in FIG. 2A, content 204 includes system status indicators (such as an indication of time, a cellular status indicator, a Wi-Fi status indicator, and a battery status indicator) and a user interface of a web browser application. The user interface of the web browser application includes content of a web page, controls for navigating and sharing a web page, and a text field for entering a web address and/or performing a search function. In some embodiments, the system status indicators are part of the user interface of the web browser application. In some embodiments, content 204 includes a user interface of a different application, a watch face user interface (e.g., on a smartwatch), and/or a system user interface (e.g., a desktop user interface, a home screen, a settings user interface, and/or an application springboard that includes application icons for launching and/or opening applications).

In the embodiment illustrated in FIG. 2A, dynamic element 206 includes a set of graphical elements 206a1, 206a2, 206b1, 206b2, 206c1, 206c2, 206d1, and 206d2 (collectively referred to as graphical elements 206a1-206d2 or dynamic element 206). In some embodiments, dynamic element 206 is a graphical layer (e.g., that is displayed in front of or behind content 204). Graphical elements 206a1-206d2 are arranged in a rectangular array or grid of horizontal rows and vertical columns. The vertical spacing or distance between rows (e.g., between a center of graphical element 206a1 and a center of graphical element 206b1) is distance DV. In the embodiment illustrated in FIG. 2A, the spacing between rows is consistent, with each graphical element being a constant distance from its adjacent graphical elements (e.g., the distance between a center of graphical element 206a1 and a center of graphical element 206b1 is the same as the distance between the center of graphical element 206b1 and a center of graphical element 206c1). In some embodiments, the spacing between rows varies (e.g., the distance between a center of graphical element 206a1 and a center of graphical element 206b1 is different from the distance between the center of graphical element 206b1 and a center of graphical element 206c1).

The horizontal spacing or distance between columns (e.g., between the center of graphical element 206a1 and the center of graphical element 206a2) is distance DH. In some embodiments, the spacing between columns is consistent, with each graphical element being a constant distance from its adjacent graphical elements (e.g., the distance between a center of graphical element 206a1 and a center of graphical element 206a2 is the same as the distance between the center of graphical element 206a2 and a center of an adjacent graphical element in a column to the right of graphical element 206a2). In some embodiments, the spacing between columns varies (e.g., the distance between a center of graphical element 206a1 and a center of graphical element 206a2 is different from the distance between the center of graphical element 206a2 and a center of an adjacent graphical element in a column to the right of graphical element 206a2). In some implementations, the graphical elements are not in columns or rows, but are variably spaced or patterned across the user interface (e.g., in a diagonal pattern or in a random pattern).

Dynamic element 206 is affected by detected motion such that dynamic element 206 is displayed (e.g., appears), moves, and/or changes appearance on display 202 in response to and/or in accordance with detected motion. In some embodiments, dynamic element 206 moves based on motion of a vehicle (e.g., a vehicle in which (or on which) computer system 200 or a user of computer system 200 is located), motion of a user of computer system 200, motion of computer system 200 itself, and/or virtual or simulated motion (e.g., motion that the user is intended to perceive, but does not physically experience). In some embodiments, computer system 200 is in or on a vehicle such as, for example, a car, bus, truck, train, bike, motorcycle, boat, plane, golf cart, and/or all-terrain vehicle (ATV). In some embodiments, computer system 200 displays dynamic element 206 in accordance with a determination that computer system 200 is in a vehicle (e.g., computer system 200 does not display dynamic element 206 when computer system 200 is not in a vehicle).

In some embodiments, various characteristics of dynamic element 206 are variable and/or configurable. For example, in some embodiments, the brightness, size, transparency, number, pattern, spacing, and/or shape of the graphical elements of dynamic element 206 change based on detected motion. For example, the size, brightness, and/or opacity of the graphical elements of dynamic element 206 vary (e.g., increase or decrease) with the magnitude of motion (e.g., velocity and/or acceleration). In some embodiments, the brightness, size, transparency, number, pattern, spacing, and/or shape of the graphical elements are user configurable (e.g., are displayed and/or can be changed based on user-selectable settings).

In FIG. 2A, dynamic element 206 is in a neutral state because there is no motion affecting dynamic element 206. In FIG. 2A (e.g., in the neutral state), dynamic element 206 is offset horizontally from the left side of display 202 by distance X1 and offset vertically from the top of display 202 by distance Y1. In some embodiments, computer system 200 does not display dynamic element 206 when there is no motion, and displays dynamic element 206 and/or increases an opacity of dynamic element 206 in response to detecting motion.

In FIG. 2B, motion represented by arrow 208a (also referred to as motion 208a) is detected. In some embodiments, computer system 200 detects motion 208a. In some embodiments, a computer system and/or one or more sensors that are external to and/or separate from computer system 200 detect motion 208a and transmit data and/or information associated with motion 208a to computer system 200. In some embodiments, the computer system and/or one or more sensors that detect motion 208a transmit the data and/or information associated with motion 208a to a server, which transmits the data and/or information to computer system 200.

As shown in FIG. 2B, dynamic element 206 increases in opacity (e.g., becomes darker and/or more opaque) and moves (e.g., changes location on display 202) based on motion 208a (e.g., in response to detecting motion 208a or in response to receiving data representing motion 208a). In FIG. 2B, motion 208a includes a change in direction (e.g., acceleration) forward (or upward) and to the left relative to the position and/or orientation of computer system 200. Based on motion 208a, dynamic element 206 moves in a direction opposite of the direction of motion 208a. Accordingly, compared to the position of dynamic element 206 in FIG. 2A, dynamic element 206 moves down due to the forward component of motion 208a and to the right due to the leftward component of motion 208a. In particular, because of the forward (upward) component of motion 208a, the vertical offset of dynamic element 206 from the top side of display 202 has increased from distance Y1 in FIG. 2A to distance Y2 in FIG. 2B (where Y2 is greater than Y1). Similarly, because of the leftward component of motion 208a, the horizontal offset of dynamic element 206 from the left side of display 202 has increased from distance X1 in FIG. 2A to distance X2 in FIG. 2B (where X2 is greater than X1). In this way, dynamic element 206 simulates the perceived force on a user due to motion 208a. For example, when a platform on which a user is located accelerates forward and to the left, the user feels as though they are being pushed backward and to the right.

In FIG. 2C, motion represented by arrow 208b (also referred to as motion 208b) is detected. Motion 208b can be detected in the same manner as motion 208a described above with reference to FIG. 2B, and data representing or associated with motion 20b can be transmitted and/or received in the same manner as data representing or associated with motion 208a described with reference to FIG. 2B. As shown in FIG. 2C, dynamic element 206 becomes opaquer (e.g., compared to FIG. 2A) and moves (e.g., changes location on display 202) based on motion 208b (e.g., in response to detecting motion 208b or in response to receiving data representing motion 208b).

In FIG. 2C, motion 208b includes a change in direction (e.g., acceleration) backward (or downward) and to the right relative to the position and/or orientation of computer system 200 (e.g., in the opposite direction of motion 208a). Based on motion 208b, dynamic element 206 moves in a direction opposite of the direction of motion 208b. Accordingly, compared to the position of dynamic element 206 in FIG. 2A, dynamic element 206 moves up due to the backward (downward) component of motion 208b and to the left due to the rightward component of motion 208b. In particular, because of the backward component of motion 208b, the vertical offset of dynamic element 206 from the top side of display 202 has decreased from distance Y1 in FIG. 2A to distance Y3 in FIG. 2C (where Y3 is less than Y1). Similarly, because of the rightward component of motion 208b, the horizontal offset of dynamic element 206 from the left side of display 202 has decreased from distance X1 in FIG. 2A to distance X3 in FIG. 2C (where X3 is less than X1). In this way, dynamic element 206 simulates the perceived force on a user due to motion 208b. For example, when a platform on which a user is located accelerates backward and to the right, the user feels as though they are being pushed forward and to the left.

In some embodiments, the magnitude of the change dynamic element 206 (e.g., the change in position, opaqueness, brightness, and/or size) of dynamic element 206 is proportional to the magnitude of the motion. For example, in response to motion in the direction of motion 208a, but with greater magnitude, dynamic element 206 becomes opaquer and moves in the same direction, but by a greater amount, than as shown in FIG. 2B (e.g., X2 and Y2 are greater than as shown in FIG. 2B).

In some embodiments, the position and/or movement of dynamic element 206 is independent from the display of content 204. For example, in FIGS. 2B and 2C, dynamic element 206 moves based on motion 208a and motion 208b without affecting content 204 (e.g., content 204 does not change or move in FIGS. 2B and 2C based on motion 208a, motion 208b, or the movement of dynamic element 206).

Conversely, a user can change and/or navigate content 204 without affecting the position and/or movement of dynamic element 206. FIG. 2D illustrates content 204 and dynamic element 206 in the same state as in FIG. 2A. In FIG. 2D, computer system 200 detects input 210a corresponding to a request to navigate (e.g., scroll) content 204. In response to detecting input 210a, computer system 200 scrolls content 204 and maintains the position of dynamic element 206, as shown in FIG. 2E (e.g., dynamic element 206 has the same position in FIG. 2E as in FIG. 2D). In this way, dynamic element 206 is independent from content 204.

In FIG. 2E, computer system 200 detects input 210b (e.g., selection of home button 212) corresponding to a request to navigate to a home screen (e.g., to close (or move to the background) the web browsing application displayed in FIG. 2E). In response to detecting input 210b, computer system 200 displays home screen 214 and maintains the position of dynamic element 206, as shown in FIG. 2F (e.g., dynamic element 206 has the same position in FIG. 2F as in FIG. 2E). In this way, dynamic element 206 is independent from the content displayed on display 202 (e.g., graphical objects and features other than dynamic element 206).

FIGS. 2G-2L illustrate example techniques for making motion more comfortable. The techniques described can make a user more comfortable while the user is viewing and/or interacting with content displayed on an electronic device. In FIG. 2G, computer system 200 displays content 204 (e.g., as in FIGS. 2A-2E) and dynamic element 215. In some embodiments, dynamic element 215 moves in a manner analogous to dynamic element 206 described with reference to FIGS. 2A-2F. In some embodiments, the movement of dynamic element 215 simulates the movement of a mass on a spring. Dynamic element 215 includes a single graphical element (e.g., a square). In some embodiments, dynamic element 215 is a circle, triangle, star, cube, pyramid, or sphere.

Dynamic element 215 is affected by detected motion such that dynamic element 215 moves on display 202 in response to and/or in accordance with detected motion. In some embodiments, dynamic element 215 moves based on motion of a vehicle (e.g., a vehicle in which (or on which) computer system 200 or a user of computer system 200 is located), motion of a user of computer system 200, motion of computer system 200 itself, and/or virtual or simulated motion (e.g., motion that the user is intended to perceive, but does not physically experience).

In FIG. 2G, dynamic element 215 is in a neutral state because there is no motion affecting the element. In FIG. 2G (e.g., in the neutral state), dynamic element 215 is offset horizontally from the left side of display 202 by distance X4 (e.g., half of the length of display 202 in the horizontal direction) and offset vertically from the top of display 202 by distance Y4 (e.g., half of the length of display 202 in the vertical direction).

In FIG. 2H, motion represented by arrow 208c (also referred to as motion 208c) is detected. Motion 208c can be detected in the same manner as motion 208a and/or motion 208b described above with reference to FIGS. 2B and 2C, and data representing or associated with motion 20c can be transmitted and/or received in the same manner as data representing or associated with motion 208a and/or motion 208b described with reference to FIGS. 2B and 2C.

As shown in FIG. 2H, dynamic element 215 moves (e.g., changes location on display 202) based on motion 208c (e.g., in response to detecting motion 208c or in response to receiving data representing motion 208c). In FIG. 2H, motion 208c includes a change in direction (e.g., acceleration) forward (or upward) and to the left relative to the position and/or orientation of computer system 200. Based on motion 208c, dynamic element 215 moves in a direction opposite of the direction of motion 208c. Accordingly, compared to the position of dynamic element 215 in FIG. 2G, dynamic element 215 moves down due to the forward component of motion 208c and to the right due to the leftward component of motion 208c. In particular, because of the forward (upward) component of motion 208c, the vertical offset of dynamic element 215 from the top side of display 202 has increased from distance Y4 in FIG. 2G to distance Y5 in FIG. 2H (where Y5 is greater than Y4). Similarly, because of the leftward component of motion 208c, the horizontal offset of dynamic element 215 from the left side of display 202 has increased from distance X4 in FIG. 2G to distance X5 in FIG. 2H (where X5 is greater than X4). In this way, dynamic element 215 simulates the perceived force on a user due to motion 208c. For example, when a platform on which a user is located accelerates forward and to the left, the user feels as though they are being pushed backward and to the right.

In FIG. 2I, motion represented by arrow 208d (also referred to as motion 208d) is detected. Motion 208d can be detected in the same manner as motion 208a, motion 208b, and/or motion 208c described above, and data representing or associated with motion 20d can be transmitted and/or received in the same manner as data representing or associated with motion 208a, motion 208b, and/or motion 208c described above.

As shown in FIG. 2I, dynamic element 215 moves (e.g., changes location on display 202) based on motion 208d (e.g., in response to detecting motion 208d or in response to receiving data representing motion 208d). In FIG. 2I, motion 208d includes a change in direction (e.g., acceleration) backward (or downward) and to the right relative to the position and/or orientation of computer system 200 (e.g., in the opposite direction of motion 208c). Based on motion 208d, dynamic element 215 moves in a direction opposite of the direction of motion 208c. Accordingly, compared to the position of dynamic element 215 in FIG. 2G, dynamic element 215 moves up due to the backward (downward) component of motion 208d and to the left due to the rightward component of motion 208d. In particular, because of the backward component of motion 208d, the vertical offset of dynamic element 215 from the top side of display 202 has decreased from distance Y4 in FIG. 2G to distance Y6 in FIG. 2I (where Y6 is less than Y4). Similarly, because of the rightward component of motion 208d, the horizontal offset of dynamic element 215 from the left side of display 202 has decreased from distance X4 in FIG. 2G to distance X6 in FIG. 2I (where X6 is less than X4). In this way, dynamic element 215 simulates the perceived force on a user due to motion 208d. For example, when a platform on which a user is located accelerates backward and to the right, the user feels as though they are being pushed forward and to the left.

In some embodiments, the magnitude of the change in position of dynamic element 215 is proportional to the magnitude of the motion. For example, in response to motion in the direction of motion 208c, but with greater magnitude, dynamic element 215 moves in the same direction, but by a greater amount, than as shown in FIG. 2H (e.g., X5 is greater than as shown in FIG. 2H and Y5 is less than as shown in FIG. 2H).

In some embodiments, the position and/or movement of dynamic element 215 is independent from the display of content 204. For example, in FIGS. 2H and 2I, dynamic element 215 moves based on motion 208c and motion 208d without affecting content 204 (e.g., content 204 does not change or move in FIGS. 2H and 2I based on motion 208c, motion 208d, or the movement of dynamic element 215).

Conversely, a user can change and/or navigate content 204 without affecting the position and/or movement of dynamic element 215. FIG. 2J illustrates content 204 and dynamic element 215 in the same state as in FIG. 2G. In FIG. 2J, computer system 200 detects input 210c corresponding to a request to navigate (e.g., scroll) content 204. In response to detecting input 210c, computer system 200 scrolls content 204 and maintains the position of dynamic element 215, as shown in FIG. 2K (e.g., dynamic element 215 has the same position in FIG. 2K as in FIG. 2J). In this way, dynamic element 215 is independent from content 204.

In FIG. 2K, computer system 200 detects input 210d (e.g., selection of home button 212) corresponding to a request to navigate to a home screen (e.g., to close (or move to the background) the web browsing application displayed in FIG. 2K). In response to detecting input 210d, computer system 200 displays home screen 214 and maintains the position of dynamic element 215, as shown in FIG. 2L (e.g., dynamic element 215 has the same position in FIG. 2L as in FIG. 2K). In this way, dynamic element 215 is independent from the content displayed on display 202 (e.g., graphical objects and features other than dynamic element 215).

FIGS. 2M-2O illustrate example techniques for mitigating discomfort caused by motion. The techniques described can help a user feel comfortable while viewing and/or interacting with content displayed on an electronic device.

In FIG. 2M, content 204 (e.g., the content shown in FIGS. 2A-2L), dynamic element 216, and dynamic element 218 are displayed. Dynamic element 216 includes a set of six graphical elements 216a, 216b, 216c, 216d, 216e, and 216f (collectively referred to as graphical elements 216a-216f or dynamic element 216). Graphical elements 216a-216f are arranged horizontally (e.g., along a horizontal line). In some embodiments, dynamic element 216 includes fewer than six graphical elements (e.g., 3, 4, or 5 graphical elements) arranged horizontally. In some embodiments, dynamic element 216 includes more than six graphical elements (e.g., 7, 8, 9, 10, 11, or 12 graphical elements) arranged horizontally.

Graphical elements 216a-216f can have a first visual state (e.g., filled in, highlighted, a first color, solid outline, and/or a first pattern) or a second visual state (e.g., not filled in, not highlighted, a second color (different from the first color), dashed outline, a second pattern (different from the first pattern), and/or not displayed), where the first visual state is different from (e.g., visually distinguishable from) the second visual state. For example, in FIG. 2M, graphical element 216a, graphical element 216b, and graphical element 216c have a first visual state (e.g., filled in and/or solid outline), while graphical element 216d, graphical element 216e, and graphical element 216f have a second visual state (e.g., not filled in, dashed outline, and/or not displayed). In some embodiments, graphical elements 216a-216f can have more than two different visual states (e.g., a third visual state or a transitional visual state when changing from the first visual state to the second visual state).

Dynamic element 216 is affected by detected motion (e.g., motion along the horizontal direction) such that the visual state of dynamic element 216 changes (e.g., by changing the visual state of one or more of graphical elements 216a-216f) in response to and/or in accordance with detected motion. In some embodiments, dynamic element 216 changes visual states based on motion of a vehicle (e.g., a vehicle in which (or on which) computer system 200 or a user of computer system 200 is located), motion of a user of computer system 200, motion of computer system 200 itself, and/or virtual or simulated motion (e.g., motion that the user is intended to perceive, but does not physically experience).

In FIG. 2M, dynamic element 216 is in a neutral state because there is no motion affecting dynamic element 216. In FIG. 2M (e.g., in the neutral state), the graphical elements on the left side (e.g., left half) of dynamic element 216 (e.g., graphical elements 216a-216c) have a first visual state, and the graphical elements on the right side (e.g., right half) of dynamic element 216 (e.g., graphical elements 216d-216f) have a second visual state.

Dynamic element 218 includes a set of six graphical elements 218a, 218b, 218c, 218d, 218e, and 218f (collectively referred to as graphical elements 218a-218f or dynamic element 218). Graphical elements 218a-218f are arranged vertically (e.g., along a vertical line). In some embodiments, dynamic element 218 includes fewer than six graphical elements (e.g., 3, 4, or 5 graphical elements) arranged vertically. In some embodiments, dynamic element 218 includes more than six graphical elements (e.g., 7, 8, 9, 10, 11, or 12 graphical elements) arranged vertically.

Graphical elements 218a-218f can have a first visual state (e.g., filled in, highlighted, a first color, solid outline, and/or a first pattern) or a second visual state (e.g., not filled in, highlighted, a second color (different from the first color), dashed outline, a second pattern (different from the first pattern), and/or not displayed), where the first visual state is different from (e.g., visually distinguishable from) the second visual state. For example, in FIG. 2M, graphical element 218a, graphical element 218b, and graphical element 218c have a first visual state, while graphical element 218d, graphical element 218e, and graphical element 218f have a second visual state. In some embodiments, graphical elements 218a-218f can have more than two different visual states (e.g., a third visual state or a transitional visual state when changing from the first visual state to the second visual state).

Dynamic element 218 is affected by detected motion (e.g., motion along the forward-backward direction) such that the visual state of dynamic element 218 changes (e.g., by changing the visual state of one or more of graphical elements 218a-218f) in response to and/or in accordance with detected motion. In some embodiments, dynamic element 218 changes visual states based on motion of a vehicle (e.g., a vehicle in which (or on which) computer system 200 or a user of computer system 200 is located), motion of a user of computer system 200, motion of computer system 200 itself, and/or virtual or simulated motion (e.g., motion that the user is intended to perceive, but does not physically experience).

In FIG. 2M, dynamic element 218 is in a neutral state because there is no motion affecting dynamic element 218. In FIG. 2M (e.g., in the neutral state), the graphical elements on the lower side (e.g., lower half) of dynamic element 216 (e.g., graphical elements 216a-216c) have a first visual state (e.g., filled in and/or solid outline), and the graphical elements on the upper side (e.g., upper half) of dynamic element 218 (e.g., graphical elements 218d-218f) have a second visual state (e.g., not filled in, dashed outline, and/or not displayed).

In FIG. 2N, motion represented by arrow 208e (also referred to as motion 208e) is detected. Motion 208e can be detected in the same manner as motion 208a, motion 208b, motion 208c, and/or motion 208d described above, and data representing or associated with motion 208e can be transmitted and/or received in the same manner as data representing or associated with motion 208a, motion 208b, motion 208c, and/or motion 208d described above. As shown in FIG. 2N, dynamic element 216 and dynamic element 218 are displayed in a state (e.g., changed state) based on motion 208e (e.g., in response to detecting motion 208e or in response to receiving data representing motion 208e). In FIG. 2N, motion 208e includes a change in direction (e.g., acceleration) forward (or upward) and to the left relative to the position and/or orientation of computer system 200.

Based on motion 208e, graphical elements 216a-216e are displayed with the first visual state, and graphical element 216f is displayed with the second visual state. Accordingly, due to motion 208e, graphical elements 216d and 216e have changed from the second visual state to the first visual state (e.g., the first visual state has “moved” to the right, in the opposite direction of the lateral component of motion 208e), compared to FIG. 2M. Accordingly, compared to the state of dynamic element 216 in FIG. 2M, the right side of dynamic element 216 includes a graphical element (e.g., graphical element 216d) that has the first visual state due to the leftward component of motion 208e. In particular, because of the leftward component of motion 208e, the majority of dynamic element 216 (e.g., the entire left half and a left portion of the right half of dynamic element 216) has the first visual state. In this way, dynamic element 216 simulates the perceived force on a user due to motion 208e. For example, when a platform on which a user is located accelerates at least partially to the left, the user feels as though they are being pushed to the right.

Based on motion 208e, graphical elements 218a-218b are displayed with the first visual state (e.g., filled in and/or solid outline), and graphical elements 218c-218f are displayed with the second visual state (e.g., not filled in, dashed outline, and/or not displayed). Accordingly, due to motion 208e, graphical element 218c has changed from the first visual state to the second visual state (e.g., the first visual state has “moved” down, in the opposite direction of the vertical component of motion 208e), compared to FIG. 2M. Accordingly, compared to the state of dynamic element 218 in FIG. 2M, the lower side of dynamic element 218 includes a graphical element (e.g., graphical element 218c) that has the second visual state due to the forward component of motion 208e. In particular, because of the forward component of motion 208e, the majority of dynamic element 218 (e.g., the entire upper half and a upper-most portion of the lower half of dynamic element 218) has the second visual state. In this way, dynamic element 218 simulates the perceived force on a user due to motion 208e. For example, when a platform on which a user is located accelerates at least partially forward (or upward), the user feels as though they are being pushed back (or down).

In FIG. 2O, motion represented by arrow 208f (also referred to as motion 208f) is detected. Motion 208f can be detected in the same manner as motion 208a, motion 208b, motion 208c, motion 208d, and/or motion 208e described above, and data representing or associated with motion 208f can be transmitted and/or received in the same manner as data representing or associated with motion 208a, motion 208b, motion 208c, motion 208d, and/or motion 208e described above.

As shown in FIG. 2O, dynamic element 216 and dynamic element 218 are displayed in a state (e.g., changed state) based on motion 208f (e.g., in response to detecting motion 208f or in response to receiving data representing motion 208f). In FIG. 2O, motion 208f includes a change in direction (e.g., acceleration) backward (or downward) and to the right relative to the position and/or orientation of computer system 200.

Based on motion 208f, graphical elements 216a-216b are displayed with the first visual state, and graphical elements 216c-216f are displayed with the second visual state. Accordingly, due to motion 208f, graphical element 216c has changed from the first visual state to the second visual state (e.g., the first visual state has “moved” to the left, in the opposite direction of the lateral component of motion 208f), compared to FIG. 2M. Accordingly, compared to the state of dynamic element 216 in FIG. 2M, the left side of dynamic element 216 includes a graphical element (e.g., graphical element 216c) that has the second visual state due to the rightward component of motion 208f. In particular, because of the rightward component of motion 208f, the minority of dynamic element 216 (e.g., only a portion of the left half of dynamic element 216) has the first visual state. In this way, dynamic element 216 simulates the perceived force on a user due to motion 208f. For example, when a platform on which a user is located accelerates at least partially to the right, the user feels as though they are being pushed to the left.

Based on motion 208f, graphical elements 218a-218e are displayed with the first visual state, and graphical element 218f is displayed with the second visual state. Accordingly, due to motion 208f, graphical elements 218d-218e have changed from the second visual state to the first visual state (e.g., the first visual state has “moved” up, in the opposite direction of the vertical component of motion 208f), compared to FIG. 2M. Accordingly, compared to the state of dynamic element 218 in FIG. 2M, the upper side of dynamic element 218 includes a graphical element (e.g., graphical elements 218d-218e) that has the first visual state due to the backward component of motion 208f. In particular, because of the backward component of motion 208f, the majority of dynamic element 218 (e.g., the entire lower half and a lower-most portion of the upper half of dynamic element 218) has the first visual state. In this way, dynamic element 218 simulates the perceived force on a user due to motion 208f. For example, when a platform on which a user is located accelerates at least partially backward (or downward), the user feels as though they are being pushed forward (or up).

In some embodiments, the magnitude of the change in state of dynamic element 216 and/or dynamic element 218 is proportional to the magnitude of the motion. For example, in response to motion in the direction of motion 208e, but with greater magnitude, the state of dynamic element 216 and/or dynamic element 218 changes in the same direction, but by a greater amount, than as shown in FIG. 2N (e.g., the fill state is changed for graphical elements 216d, 216e, 216f, 218a, 218b, and 218c).

Similar to dynamic element 206 described with reference to FIGS. 2D-2F, in some embodiments, dynamic element 216 and/or dynamic element 218 is independent from other displayed content, such as content 204. For example, content 204 can be navigated, modified, scrolled, and/or changed (e.g., as shown in FIGS. 2D-2F) independently of (e.g., without affecting) dynamic element 216 and/or dynamic element 218.

In some embodiments, the state of dynamic element 216 is independent from the display of content 204. For example, in FIGS. 2N and 2O, dynamic element 216 changes state based on motion 208e and motion 208f without affecting content 204 (e.g., content 204 does not change or move in FIGS. 2N and 2O based on motion 208e, motion 208f, or the change in state of dynamic element 216). Similarly, the state of dynamic element 218 is independent from the display of content 204. For example, in FIGS. 2N and 2O, dynamic element 218 changes state based on motion 208e and motion 208f without affecting content 204 (e.g., content 204 does not change or move in FIGS. 2N and 2O based on motion 208e, motion 208f, or the change in state of dynamic element 218).

Conversely, a user can change and/or navigate content 204 without affecting the state of dynamic element 216 and/or dynamic element 218. For example, in response to detecting a request (e.g., input 210a shown in FIG. 2D) to navigate content 204, computer system 200 scrolls content 204 (e.g., as described with reference to FIGS. 2D and 2E) and maintains the state of dynamic element 216 and/or dynamic element 218. As another example, in response to detecting a request (e.g., selection of home button 212) to navigate to a different user interface (e.g., home screen 214, a user interface of a different application, a system user interface, and/or a watch face user interface), computer system displays a different user interface (e.g., as described with reference to FIGS. 2E and 2F) without changing the state of the dynamic element 216 and/or dynamic element 218. In this way, dynamic element 216 and/or dynamic element 218 are independent from the content displayed on display 202 (e.g., graphical objects and features other than dynamic element 216 and/or dynamic element 218).

In some embodiments, characteristics of dynamic elements 216 and/or 218 are configurable. These characteristics can include such as the size, shape, spacing, and/or color of the individual elements of dynamic elements 216 and/or 218.

FIGS. 2P-2Q illustrate example techniques for mitigating discomfort caused by motion. The techniques described can help with motion comfort while a user is viewing and/or interacting with content displayed on an electronic device.

In FIG. 2P, content 204 (e.g., the content shown in FIGS. 2A-2O) and dynamic element 220 are displayed. Dynamic element 220 includes first portion 220a (e.g., an upper portion), second portion 220b (e.g., a lower portion), and boundary 220c (e.g., a line) between first portion 220a and second portion 220b. In some embodiments, first portion 220a, second portion 220b, and boundary 220c are included in a circular region (e.g., as shown in FIGS. 2P and 2Q) or a region that has another shape (e.g., rectangular, square, or triangular). In some embodiments, dynamic element 220 is overlaid on content 204 (e.g., as shown in FIG. 2P). In some embodiments, dynamic element 220 is displayed behind content 204 (e.g., content 204 is overlaid on dynamic element 220 and/or dynamic element 220 is displayed in a background and/or as a background element).

In some embodiments, dynamic element 220 is displayed at or near the bottom of display 202 (e.g., as shown in FIG. 2P). In some embodiments, dynamic element 220 is displayed at or near the top of display 202. In some embodiments, dynamic element 220 is displayed at or near the middle of display 202 (e.g., relative to the top and bottom of display 202). In some embodiments, dynamic element 220 is displayed at or near the left side of display 202. In some embodiments, dynamic element 220 is displayed at or near the right side of display 202 e.g., as shown in FIG. 2P). In some embodiments, dynamic element 220 is displayed at or near the middle of display 202 (e.g., relative to the left side and right side of display 202).

Dynamic element 220 is affected by detected motion such that the position and/or orientation of boundary 220c changes in response to and/or in accordance with detected motion. In some embodiments, dynamic element 220 according to a physical model that simulates the motion of water in a container as the container is moved. The water can “slosh” around according to the motion.

In some embodiments, dynamic element 220 changes based on motion of a vehicle (e.g., a vehicle in which (or on which) computer system 200 or a user of computer system 200 is located), motion of a user of computer system 200, motion of computer system 200 itself, and/or virtual or simulated motion (e.g., motion that the user is intended to perceive, but does not physically experience). In FIG. 2P, dynamic element 220 is in a neutral state because there is no motion affecting dynamic element 220. In FIG. 2P (e.g., in the neutral state), boundary 220c is horizontal and in the middle of dynamic element 220 (from top to bottom).

FIG. 2Q illustrates example motions 222a-222g and corresponding states 224a-224g of dynamic element 220. Motion 222a corresponds to motion with constant velocity (e.g., no acceleration). In response to motion 222a, dynamic element 220 has state 224a (e.g., the neutral state) described with reference to FIG. 2P. Motion 222b corresponds to breaking (e.g., slowing down) motion with decreasing velocity (e.g., deceleration or backward acceleration solely in the backward or longitudinal direction). In response to motion 222b, dynamic element 220 has state 224b in which boundary 220c is higher (e.g., boundary 220c is more towards the top of dynamic element 220; first portion 220a is smaller; second portion 220b is larger) compared to state 224a (e.g., the “water” has sloshed forward due to the deceleration). Because there is no lateral motion, boundary 220c is horizontal in state 224b.

Motion 222c corresponds to forward, upward, or longitudinal acceleration (e.g., speeding up solely in the longitudinal direction). In response to motion 222c, dynamic element 220 has state 224c in which boundary 220c is lower (e.g., boundary 220c is more towards the bottom of dynamic element 220; first portion 220a is larger; second portion 220b is smaller) compared to state 224a (e.g., the “water” has sloshed backward due to the forward acceleration). Because there is no lateral motion, boundary 220c is horizontal in state 224c.

Motion 222d corresponds to a first amount of lateral acceleration to the left (e.g., a slight left turn; acceleration solely in the leftward direction; no longitudinal acceleration). In response to motion 222d, dynamic element 220 has state 224d in which boundary 220c is oriented counterclockwise (e.g., boundary 220c is tilted or rotated counterclockwise; first portion 220a is the same size; second portion 220b is the same size) compared to state 224a (e.g., the “water” has sloshed upward on the right side of dynamic element 220 and downward on the left side of dynamic element 220, in the opposite direction or away from the direction of acceleration). Because there is no longitudinal acceleration, the size of first portion 220a and the size of second portion 220b are the same as in state 224a (e.g., first portion 220a and second portion 220b are the same size as one another).

Motion 222e corresponds to a second amount of lateral acceleration to the left (e.g., a greater amount of lateral acceleration to the left compared to motion 222d; a tighter or harder left turn compared to motion 222d; acceleration solely in the leftward direction; no longitudinal acceleration). In response to motion 222e, dynamic element 220 has state 224e in which boundary 220c is oriented further counterclockwise (e.g., boundary 220c is tilted or rotated further counterclockwise; first portion 220a is the same size; second portion 220b is the same size) compared to state 224e (e.g., the “water” has sloshed further upward on the right side of dynamic element 220 and further downward on the left side of dynamic element 220, in the opposite direction or away from the direction of acceleration). Because there is no longitudinal acceleration, the size of first portion 220a and the size of second portion 220b are the same as in state 224a (e.g., first portion 220a and second portion 220b are the same size as one another).

Motion 222f corresponds to a first amount of lateral acceleration to the right (e.g., a slight right turn; acceleration solely in the rightward direction; no longitudinal acceleration). In response to motion 222f, dynamic element 220 has state 224f in which boundary 220c is oriented clockwise (e.g., boundary 220c is tilted or rotated clockwise; first portion 220a is the same size; second portion 220b is the same size) compared to state 224a (e.g., the “water” has sloshed upward on the left side of dynamic element 220 and downward on the right side of dynamic element 220, in the opposite direction or away from the direction of acceleration). Because there is no longitudinal acceleration, the size of first portion 220a and the size of second portion 220b are the same as in state 224a (e.g., first portion 220a and second portion 220b are the same size as one another).

Motion 222g corresponds to a second amount of lateral acceleration to the right (e.g., a greater amount of lateral acceleration to the right compared to motion 222f; a tighter or harder right turn compared to motion 222f; acceleration solely in the leftward direction; no longitudinal acceleration). In response to motion 222g, dynamic element 220 has state 224g in which boundary 220c is oriented further clockwise (e.g., boundary 220c is tilted or rotated further clockwise; first portion 220a is the same size; second portion 220b is the same size) compared to state 224f (e.g., the “water” has sloshed further upward on the left side of dynamic element 220 and further downward on the right side of dynamic element 220, in the opposite direction or away from the direction of acceleration). Because there is no longitudinal acceleration, the size of first portion 220a and the size of second portion 220b are the same as in state 224a (e.g., first portion 220a and second portion 220b are the same size as one another).

Similar to dynamic element 206 described with reference to FIGS. 2D-2F, in some embodiments, dynamic element 220 is independent from other displayed content, such as content 204. For example, content 204 can be navigated, modified, scrolled, and/or changed (e.g., as shown in FIGS. 2D-2F) independently of (e.g., without affecting) dynamic element 220. In some embodiments, the dynamic element (e.g., dynamic element 206, 215, 216, 218, and/or 220) can update concurrently with (but independently) from displayed content. For example, the dynamic element can update in response to motion concurrently while navigating content.

In some embodiments, the dynamic element (e.g., dynamic element 206, 215, 216, 218, and/or 220) is displayed behind other content (e.g., as a background element). For example, in FIGS. 2A-2L, dynamic elements 206 and 215 are displayed behind content 204. In some embodiments, the dynamic element (e.g., dynamic element 206, 215, 216, 218, and/or 220) is displayed in front of other content (e.g., as a foreground element). For example, in FIGS. 2M-2P, dynamic elements 2216, 218, and 220 are displayed in front of content 204.

The user interfaces in FIGS. 2A-2Q are used to illustrate the methods described below, including the methods in FIG. 3. FIG. 3 is a flow diagram that illustrates method 300 for displaying user interfaces based on detected motion according to some embodiments. In some embodiments, method 300 is performed at a computer system (e.g., a desktop computer, a laptop computer, a tablet computer, a smartphone, a smartwatch, a television, a monitor, a head-mounted display system) that is in communication with a display (e.g., a monitor, a touch-sensitive display, a head-mounted display, a three-dimensional display, and/or a projector). Some operations in method 300 are, optionally, combined, the orders of some operations are, optionally, changed, and some operations are, optionally, omitted.

At block 302, a dynamic graphical element (e.g., 206, 215, 216, 218, and/or 220) and graphical content (e.g., 204 and/or 214) are displayed (e.g., concurrently displayed; via a monitor, a touch-screen, a holographic display, and/or a head-mounted display). The dynamic graphical element is displayed in a first state (e.g., the state of 206 in FIG. 2A; the state of 215 in FIG. 2G; the state of 216 and/or 218 in FIG. 2M; and/or the state of 220 in FIG. 2P) (e.g., a static state, a dynamic state, a first position, a first orientation, a first size, a first color, a first shape, a first motion, and/or a first configuration). The graphical content is displayed in a second state (e.g., the state of 204 in FIG. 2A). In some embodiments, the graphical content includes, e.g., a home screen, a messaging application, an email application, a web browser, a word processing application, a presentation application, an audio application, a video application, and/or content thereof). In some embodiments, the second state includes, e.g., a static state, a dynamic state (such as displaying video or scrolling), a second position, a second orientation, a second size, a second color, a second shape, a second motion, and/or a second configuration). In some embodiments, the graphical content is separate and distinct from the dynamic graphical element (e.g., the graphical content does not include the dynamic graphical element, and the dynamic graphical element does not include the graphical content). In some embodiments, manipulating (e.g., scrolling, zooming, panning, closing, and/or navigating) the graphical content does not affect the dynamic graphical element (e.g., does not affect the state of the dynamic graphical element and/or does not cause the dynamic graphical element (or the state of the dynamic graphical element) to change).

At block 304, while displaying the graphical content in the second state, the graphical content is displayed in the second state (e.g., the state of 204 in FIG. 2B) (e.g., maintaining the state of the graphical content, maintaining the position, orientation, size, color, shape, motion, and/or configuration of the graphical content) and the dynamic graphical element is displayed (e.g., concurrently with the graphical content in the second state) in a third state (e.g., the state of 204 in FIG. 2B or 2C; the state of 215 in FIG. 2H or 2I; the state of 216 and/or 218 in FIG. 2N or 2O; and/or the state of 220 in FIG. 2Q) (e.g., a static state, a dynamic state, a third position, a third orientation, a third size, a third color, a third shape, a third motion, and/or a third configuration). In some embodiments, the third state is different from the first state (e.g., the position, orientation, size, color, shape, motion, and/or configuration of the dynamic graphical element is changed; the state of the dynamic graphical element is changed). In some embodiments, the third state (or a difference between the third state and the first state) is based on detected motion (e.g., 208a, 208b, 208c, 208d, 208e, 208f, 222a, 222b, 222c, 222d, 222e, 222f, 222g, 404a, 404b, 404c1, 404d, 404e, 406a, 406b, 406c, 612, 616, 618, 620, 812, 814, 816, 818, 820, and/or 822) (e.g., speed, velocity, acceleration, rotation, and/or vibration; motion of a vehicle) (e.g., the state of the dynamic graphical element is independent from the state of the graphical content; the state of the graphical content is not (e.g., does not change) based on the movement of the vehicle).

In some embodiments, in accordance with (or in response to) a determination that the detected motion includes first motion, the third state has a first set of parameters; and in accordance with a determination that the detected motion includes second motion that is different from the first motion, the third state has a second set of parameters that is different from the first set of parameters. In some embodiments, data associated with detected motion is received, and the dynamic graphical element is displayed in the third state (e.g., the state of the dynamic graphical element is changed) in response to receiving the data associated with detected motion. In some embodiments, the method is performed at a computer system such as, e.g., a desktop computer, a laptop computer, a tablet computer, a smartphone, a smartwatch, and/or a headset (e.g., a headset that includes a display and/or speakers; a virtual reality or augmented reality headset).

In some embodiments, the dynamic graphical element includes a plurality of graphical objects (e.g., 206) (e.g., blurry circles) that move concurrently with one another. In some embodiments, the plurality of graphical objects are arranged in a two-dimensional array. In some embodiments, the plurality of graphical objects are periodically spaced. In some embodiments, the plurality of graphical objects maintain their positions relative to each other as they change state (e.g., as they move, as they change from the first state to the third state, and/or the entire grid moves together). In some embodiments, the plurality of graphical objects are in an infinite grid (e.g., the plurality of graphical objects do not appear to have a beginning/end in horizontal or vertical direction). In some embodiments, the dynamic graphical element includes a single graphical element (e.g., 215) (e.g., a circular element and/or a representation of a sphere). In some embodiments, the dynamic graphical element simulates a mass on a spring that is subject to the detected motion. In some embodiments, the dynamic graphical element moves according to a physical model of a mass on a spring.

In some embodiments, the dynamic graphical element includes a first element (e.g., 216) (e.g., a set of sub-elements, a set of dots, and/or a bar) that is aligned along a first display dimension (e.g., a first dimension relative to a display; horizontally on display 202 as oriented in FIG. 2M), and wherein the first element has a first visual state (e.g., color or fill state; the state of 216 in FIG. 2M, 2N, or 2O) along the first display dimension that is based on a component of the detected motion in a first physical dimension. In some embodiments, the dynamic graphical element includes a second element (e.g., 218) (e.g., a set of sub-elements, a set of dots, and/or a bar) that is aligned along a second display dimension (e.g., a second dimension relative to a display; vertically on display 202 as oriented in FIG. 2M) that is different from (e.g., perpendicular to) the first display dimension, and wherein the second element has a second visual state (e.g., color or fill state) along the second display dimension that is based on a component of the detected motion in a second physical dimension that is different from (e.g., perpendicular to) the first physical dimension.

In some embodiments, the dynamic graphical element (e.g., 220) includes a boundary (e.g., 220c), wherein a position (e.g., spatial location and/or angular orientation) of the boundary is based on the detected motion. In some embodiments, the boundary is between a first portion of the dynamic graphical element and a second portion of the dynamic graphical element. In some embodiments, the boundary is a straight line. In some embodiments, a spatial position (e.g., height) of the boundary is based on a component of the detected motion in a first dimension, and an angular orientation of the boundary is based on a component of the detected motion in a second dimension (e.g., perpendicular to the first dimension). In some embodiments, the boundary simulates a water line (e.g., a surface of water in a bucket that is subject to the detected motion).

In some embodiments, while displaying the dynamic graphical element in the third state, a request (e.g., 210a, 210b, 210c, and/or 210d) (e.g., an input corresponding to a request) to change the graphical content (e.g., move the graphical content, scroll the graphical content, and/or display different graphical content such as a different user interface) is detected. In some embodiments, in response to detecting the request to change the graphical content, the graphical content is displayed in a fourth state (e.g., the state of 204 in FIG. 2E or 2K; 214 in FIG. 2F or 2L) that is different from the second state, and the dynamic graphical element is displayed in the third state (e.g., the state of 206 in FIG. 2A or 2D) (e.g., concurrently with the graphical content in the fourth state).

In some embodiments, the detected motion includes an acceleration (e.g., a change in velocity, a linear acceleration, and/or an angular acceleration). In some embodiments, the detected motion includes a change in location (e.g., spatial location). In some embodiments, the third state of the dynamic graphical element is in a direction relative to the first state of the dynamic graphical element that is based on a direction of the detected motion. In some embodiments, the direction of the third state relative to the first state is the same as the direction of the detected motion. In some embodiments, the direction of the third state relative to the first state is opposite of the direction of the detected motion. In some embodiments, in accordance with a first direction of detected motion, the third state is in a first direction relative to the first state; and in accordance with a second direction of detected motion that is different from the first direction of detected motion, the third state is in a second direction relative to the first state that is different from the first direction relative to the first state.

In some embodiments, the third state of the dynamic graphical element is different from the first state of the dynamic graphical element by an amount (e.g., a distance) that is based on a magnitude of the detected motion. In some embodiments, the amount is directly proportional to the magnitude of the detected motion. In some embodiments, in accordance with a first magnitude of detected motion, the amount is a first amount; and in accordance with a second magnitude of detected motion that is different from the first magnitude of detected motion, the amount is a second amount that is different from the first amount (e.g., if the second magnitude is greater than the first magnitude, then the second amount is greater than the first amount; if the second magnitude is less than the first magnitude, then the second amount is less than the first amount). In some embodiments, the detected motion is motion of an external object (e.g., 400, 401, 600, 800) (e.g., an object external to a device that displays the graphical content and the dynamic graphical element). In some embodiments, the external object is a platform, vehicle, car, bus, train, plane, or boat.

In some embodiments, the dynamic graphical element is displayed in a foreground (e.g., 216 and/or 218 in FIG. 2M-2O; 220 in FIG. 2P) (e.g., of a user interface, in front of the graphical content; the dynamic graphical content is overlaid on the graphical content). In some embodiments, the dynamic graphical element is displayed in a background (e.g., 206 in FIGS. 2A-2F; 215 in FIGS. 2G-2L) (e.g., of a user interface; behind the graphical content; the graphical content is overlaid on or in front of the dynamic graphical element).

Details of the features described above with respect to method 300 (e.g., FIG. 3) are also applicable in an analogous manner to the methods described below. For example, method 600 optionally includes one or more of the characteristics of the various methods described above with reference to method 300.

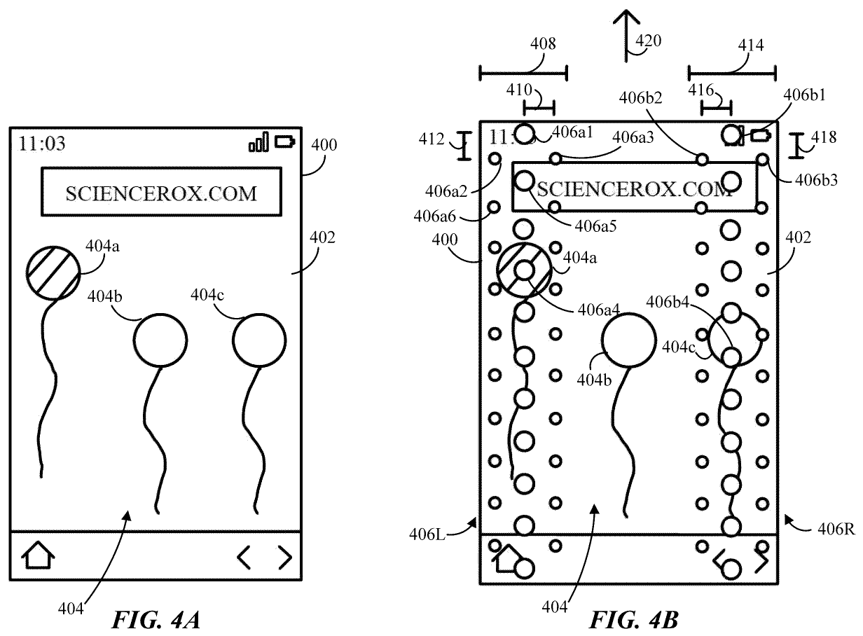

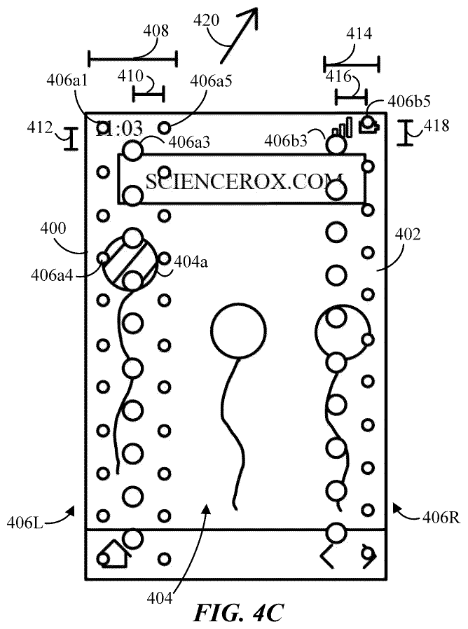

FIGS. 4A-4C illustrate example techniques for displaying user interface elements based on motion in accordance with some embodiments. The techniques can be used to make motion more comfortable for a person. Some people experience discomfort such as motion sickness or simulation sickness when there is a disconnect between the motion that the person is physically experiencing and motion that the person senses or when there is a conflict between how different systems of the person (e.g., the ocular system of the person and/or the vestibular system of the person) sense motion. For example, a person may experience motion sickness when looking at a display and/or using an electronic device such as a smartphone, laptop computer, smartwatch, or tablet computer while riding in a car because the person feels the motion of the car but the motion that the person sees on the screen does not correlate with the motion of the car. As another example, a person may experience simulator sickness when viewing moving content on a display or content that makes it appear as though the person is moving (e.g., a first-person perspective in a virtual environment) when the person is not physically moving. In some embodiments, the techniques described can help with motion comfort while a user is viewing and/or interacting with content displayed on an electronic device.

FIG. 4A illustrates computer system 400 with display 402. It should be recognized that computer system 400 can be various types of computer systems, such as a tablet, a smart watch, a laptop, a personal gaming system, a desktop computer, a fitness tracking device, a display in a vehicle, and/or head-mounted display (HMD) device. At FIG. 4A, computer system 400 displays content 404. In the embodiment illustrated in FIG. 4A, content 404 includes system status indicators (such as an indication of time, a Wi-Fi status indicator, and a battery status indicator) and a user interface of a web browser application. The user interface of the web browser application includes content of a web page (e.g., left balloon 404a, middle balloon 404b, and right balloon 404c), controls for navigating a web page, and a text field for entering a web address and/or performing a search function. In some embodiments, the system status indicators are part of the user interface of the web browser application. In some embodiments, content 404 includes a user interface of a different application, a watch face user interface (e.g., on a smartwatch), and/or a system user interface (e.g., a desktop user interface, a home screen, a settings user interface, and/or an application springboard that includes application icons for launching and/or opening applications).

Notably, FIG. 4A does not include display of a user interface element responsive to motion (e.g., as described further below with respect to FIGS. 4B-4C). In some embodiments, computer system 400 does not display a user interface element responsive to motion when computer system 400 is not moving, not in a vehicle, and/or not detecting motion (e.g., velocity and/or acceleration) via a sensor included and/or in communication with computer system 400. In other embodiments, computer system 400 does not display a user interface element responsive to motion when computer system 400 has not detected an input (e.g., user input, such as a tap on a user interface element, a press on a physical button, and/or a verbal request) corresponding to a request to display a user interface element responsive to motion.

At FIG. 4B, computer system 400 displays content 404 (e.g., continues to display content 404), dynamic element 406L, and dynamic element 406R (e.g., initially displays dynamic element 406L and dynamic element 406R). In the embodiment illustrated in FIG. 4B, dynamic element 406L includes a set of graphical elements 406a1, 406a2, 406a3, 406a4, 406a5, and 406a6, and dynamic element 406L includes a set of graphical elements 406b1, 406b2, 406b3, and 406b4 (collectively referred to as graphical elements 406a1-406b4 or dynamic element 406). It should be recognized that while, dynamic element 406 is illustrated as including a left side (e.g., dynamic element 406L) and a right side (e.g., dynamic element 406R), dynamic element 406 can also and/or instead include a top side (e.g., starting at a top edge of content 404 and extending down for a particular amount) (e.g., that responds similar to as described for dynamic element 406L and dynamic element 406R) a bottom side (e.g., starting at a bottom edge of content 404 and extending up for a particular amount) (e.g., that responds similar to as described for dynamic element 406L and dynamic element 406R), a center portion the extends radially from the center of display 402 and/or other configurations. In some embodiments, dynamic element 406 is system wide such that dynamic element 406 is displayed with content from different applications including other user applications and/or operating system applications. In some embodiments, dynamic element 406 is a graphical layer that is displayed in front of, overlaid on, and/or behind content 404. One or more graphical elements of dynamic element 406 can be displayed on top of or behind a portion of content 404 while another portion of content 404 does not include a graphical element of dynamic element 406 on top or behind (e.g., as illustrated by left balloon 404a having graphical element 406a4 on top and middle balloon 404b not having a graphical element of dynamic element 406 on top). In some embodiments, graphical elements included in dynamic element 406L and/or dynamic element 406R are a set of one or more images.

In some embodiments, a color of a graphical element of dynamic element 406 is based on a color of content behind or in front of the graphical element. For example, the color of graphical element 406a4 with left balloon 404a behind graphical element 406a4 can be a different color than the color of graphical element 406b4 with right balloon 404c behind graphical element 406c. In such an example, the different color can be an inverse (e.g., an inverted color) of a color behind or in front of a graphical element (e.g., left balloon 404a is a different color than right balloon 404c, as illustrated by diagonal lines in left balloon 404a) and/or a blur of the inverse of the color. Alternatively, the different color can be a subset of colors (e.g., black or white) that is furthest and/or most different from a color behind or in front of a graphical element.

As illustrated in FIG. 4B, graphical elements in dynamic element 406L are arranged in a hexagonal array or grid of horizontal rows and vertical columns, and graphical elements in dynamic element 406R are arranged in a separate hexagonal array or grid of horizontal rows and vertical columns. The vertical spacing or distance between rows in dynamic element 406L (e.g., between a center of graphical element 406a1 and a center of graphical element 406a2) is distance 412. In some embodiments, the vertical spacing or distance between rows with the same size of dynamic elements in dynamic element 406L (e.g., between a center of graphical element 406a1 and a center of graphical element 406a5) is twice of distance 412. The vertical spacing or distance between rows in dynamic element 406R (e.g., between a center of graphical element 406b1 and a center of graphical element 406b2) is distance 418 (e.g., the same as or different from distance 412). In some embodiments, the spacing between rows varies in dynamic element 406L and/or dynamic element 406R (e.g., the distance between a center of graphical element 406a1 and a center of graphical element 406a2 is different from the distance between the center of graphical element 406a2 and a center of graphical element 406a5). It should be recognized that the vertical spacing or distance between rows in dynamic element 406L (e.g., either between rows with dynamic elements of the same size or different) can be different in some embodiments. The horizontal spacing or distance between columns (e.g., between the center of graphical element 406a1 and the center of graphical element 406a3) is distance 410 (e.g., the same as or different from distance 412 and/or 418). In some embodiments, the spacing between columns is consistent, with each graphical element being a constant distance from its adjacent graphical elements (e.g., the distance between the center of graphical element 406a1 and the center of graphical element 406a2 is the same as the distance between the center of graphical element 406a1 and the center of graphical element 406a3). In some embodiments, the spacing between columns varies (e.g., the distance between the center of graphical element 406a1 and the center of graphical element 406a2 is different from the distance between the center of graphical element 406a1 and the center of graphical element 406a3). It should be recognized that the horizontal spacing or distance between columns in dynamic element 406L (e.g., either between columns with dynamic elements of the same size or different) can be different in some embodiments. In some embodiments, the graphical elements are not in columns or rows, but are variably spaced or patterned across the user interface (e.g., in a grid pattern or in a random pattern). In some embodiments, when the graphical elements are variably spaced across the user interface, the graphical elements are dynamically variably spaced (e.g., the variability of the spacing of the graphical elements is constantly changing). In some embodiments, the graphical elements have a random size, random color, random shape, and/or random motion (e.g., the motion follows a random logic). In some embodiments, such a quasi-random implementation results in a three-dimensional effect that leverages the parallax effect (e.g., computer system 400 moves the graphical elements that are smaller in size at a slower rate and computer system 400 moves the graphical elements that are larger in size at a faster rate).

As illustrated in FIG. 4B, dynamic element 406L is within area 408 and dynamic element 406R is within area 414 (e.g., same size or different size as area 408). In some embodiments, graphical elements of dynamic element 406L are not visible outside (e.g., to the left and/or the right) of area 408 and graphical elements of dynamic element 406R are not visible outside (e.g., to the left and/or the right) of area 414. It should be recognized that area 408 and/or area 414 can be smaller, larger, a different shape than illustrated in FIG. 4B.

As illustrated in FIG. 4B, graphical elements in different rows in dynamic element 406L (e.g., (1) graphical element 406a1 and (2) graphical element 406a2 or graphical element 406a3) are different sizes. In some embodiments, a graphical element in dynamic element 406 changes a visual characteristic (e.g., size, color, shape, and/or opacity) as the graphical element moves from left to right or right to left (e.g., based on motion, as described further below). For example, graphical element 406a1 and graphical element 406a2 are different sizes while they are at different horizontal positions within area 408. Further, graphical element 406a1 and graphical element 406a6 are the same size in FIG. 4B as a result of them being at the same horizontal position within area 408. It should be recognized that, in some embodiments, graphical elements in different rows within dynamic element 406L and/or 406R have a different visual characteristic (e.g., size, color, shape, and/or opacity) at the same horizontal position within area 408. It should also be recognized that such changes in a visual characteristic of a graphical element can equally apply to vertical positions instead of and/or in addition to horizontal positions.

Dynamic element 406 is affected by detected motion such that dynamic element 406 is displayed (e.g., appears), moves, and/or changes appearance on display 402 in response to and/or in accordance with detected motion (e.g., as illustrated by arrow 420 indicating that computer system 400 detects (e.g., via one or more sensors in communication with and/or included in computer system 400) forward motion (e.g., position, velocity and/or acceleration)). In some embodiments, dynamic element 406 is displayed in response to and/or based on a determination that a magnitude of the detected motion (e.g., velocity and/or acceleration) is greater than a predetermined motion threshold. In some embodiments, computer system 400 displays dynamic element 406 based on a determination that a magnitude of the detected motion (e.g., velocity and/or acceleration) is greater than a predetermined motion threshold for at least a predetermined amount of time. In some embodiments, the movement of dynamic element 406 is based on a hysteresis function. For example, based on a determination that detected motion transitions having a leftward directionality to having a rightward directionality, dynamic element 406 deaccelerates in the rightward manner until dynamic element 406 comes to a rest, after dynamic element 406 has come to a rest, dynamic element 406 begins to move in the leftward manner, In some embodiments, dynamic element 406 moves based on motion of a vehicle (e.g., a vehicle in which (or on which) computer system 400 or a user of computer system 400 is located), motion of a user of computer system 400, motion of computer system 400 itself, motion of another computer system in communication with computer system 400, and/or virtual or simulated motion (e.g., motion that the user is intended to perceive, but does not physically experience). In some embodiments, computer system 400 is in or on a vehicle such as, for example, a car, bus, truck, train, bike, motorcycle, boat, plane, golf cart, all-terrain vehicle (ATV), and/or mobility devices (e.g., electric wheelchairs and/or scooters). In such embodiments, computer system 400 displays dynamic element 406 in accordance with a determination that computer system 400 is in the vehicle (e.g., computer system 400 does not display dynamic element 406 when computer system 400 is not in the vehicle).

In some embodiments, the appearance of dynamic element 406 and the manner in which dynamic element 406 moves is dependent on the type of vehicle that computer system 400 is within. For example, computer system 400 moves dynamic element 406 differently when computer system 400 is positioned within a plane versus when computer system 400 is positioned within a boat. In some embodiments, computer system 400 adjusts the size, color and or pattern (e.g., how many cues and/or shape) of dynamic element 406 in response to detecting a user input. That is, one or more visible characteristics of dynamic element 406 is customizable by the user. In some embodiments, one or more characteristics of the movement and/or appearance of dynamic element 406 is dependent on the context of computer system 400. For example, computer system 400 sets the maximum frame rate of display 402 to a first value (e.g., 60 frames per second or 120 frames per second) when computer system 400 displays text for a user to read and computer system 400 sets the maximum frame rate of display 402 to a second value (e.g., 60 frames per second or 120 frames per second) different from the first value when computer system 400 displays video media. As another example, computer system 400 decreases the brightness of dynamic element 406 while a brightness setting of computer system 400 is set to a low value in contrast to when the brightness setting of computer system 400 is set to a high value. As another example, computer system 400 moves dynamic element 406 slower when computer system 400 is mounted to (e.g., magnetically mounted and/or fixed to) hardware in contrast to when a user holds computer system 400. In some embodiments, computer system 400 moves dynamic element 406 based on the battery power of computer system 400. For example, computer system 400 moves dynamic element 406 at a slower rate when the battery power of computer system 400 is at 10% in contrast to when the battery power of computer system 400 is at 85%. In some embodiments, computer system 400 moves dynamic element 406 slower (e.g., or faster) when a setting (e.g., a power saving setting, a brightness setting, a refresh rate setting, and/or a display resolution setting) of computer system 400 is active in contrast to when the setting of computer system is not active. In some embodiments, as a part of displaying dynamic content 406, computer system 400 performs additional operations to increase the accessibility of display content. For example, as a part of displaying dynamic content 406, computer system 400 increases the size of displayed text to help decrease the amount of discomfort a passenger experiences as a result of the motion. In some embodiments, computer system 400 adjusts the refresh rate of the display of dynamic element 406 in response to detecting a user input that corresponds to the adjustment of a refresh rate setting of computer system 400. For example, in response to detecting a user input that corresponds to the adjustment of the refresh rate setting of computer system 400, computer system 400 sets the maximum frame rate of display 402 to 60 frames per second.

In some embodiments, as a part of displaying dynamic element and to assist in mitigating any discomfort a user experiences as a result of motion, computer system 400 transmits instructions to a computer system of a vehicle that causes the adjustment of one or more settings of the vehicle. For example, as a part of displaying dynamic element 406, computer system 400 transmits instructions to the computer system of the vehicle that adjust the temperature, amount of airflow and/or position of one or more seats of the vehicle. In some embodiments, as part of displaying dynamic element 406, computer system 400 causes an external display (e.g., an external display of the vehicle) to display a user interface that includes content describing additional measures passengers of the vehicle can take to help mitigate discomfort the passengers are experiencing as a result of the motion.

In some embodiments, computer system 400 does not display dynamic element 406 based on a determination that computer system 400 will be in motion for less than a threshold amount of time. For example, computer system 400 does not display dynamic element 406 when it is determined that computer system 400 will be in motion for 25 seconds or less. In some embodiments, computer system 400 proactively displays dynamic element 406 based on a predicted path of computer system 400. For example, computer system 400 proactively displays dynamic element 406 if the predicted path of computer system 400 includes frequent turns and/or a high magnitude of motion and/or acceleration. In some embodiments, the predicted path of computer system 400 is determined by analyzing a future path of a vehicle that computer system 400 is positioned within. In some embodiments, computer system 400 proactively displays dynamic element 406 based on a context of the user. For example, based on a determination that the user is reading, computer system 400 proactively displays dynamic element 406. In some embodiments, computer system 400 displays dynamic element 406 based on a lower magnitude of motion when the user is engaged in a first activity (e.g., reading) than when the user is determined to be engaged in a second activity (e.g., watching a movie). In some embodiments, computer system 400 proactively displays dynamic element 406 based on the receipt of information from the vehicle that computer system 400 is positioned within. For example, computer system 400 proactively displays dynamic element 406 in response to receiving information from the vehicle that the vehicle will make a sharp turn in the next five seconds. In some embodiments, while computer system 400 is not configured to display dynamic element 406, computer system 400 displays an option that, when selected, configures computer system 400 to display left visual elements 406L and/or right visual elements 406R when a determination is made that the magnitude of the motion of computer system 400 is greater than a threshold.

At FIG. 4C, computer system 400 continues to detect forward motion (e.g., velocity and/or acceleration). However, at FIG. 4C, the forward motion is to the right. That is, at FIG. 4C, one or more characteristics of the motion (e.g., direction and/or magnitude) change as computer system 400 continues to detect the forward motion. At FIG. 4C, computer system 400 continues displaying content 404, dynamic element 406L, and dynamic element 406R while detecting (e.g., via one or more sensors in communication with and/or included in computer system 400) motion (e.g., velocity and/or acceleration) to the right (e.g., as illustrated by arrow 420).

As illustrated in FIG. 4C, dynamic element 406 moves in response to detecting the motion to the right. For example, each row of graphic elements (e.g., the row including graphic element 406a1 and the row including graphic element 406a2 and graphic element 406a3) moves as a response to the motion. As illustrated in FIG. 4C, each row moves according to the horizontal component of the motion, such as in an opposite direction of the horizontal component. For example, graphical element 406a1 and graphical element 406a3 moves to the left in response to the motion to the right. In some embodiments, computer system 400 ceases to display a respective graphical element as the respective graphical element moves towards the center of display 402. For example, computer system 400 ceases to display graphical element 406b5 once graphical element 406b5 reaches the leftmost boundary of area 414. In some embodiments, computer system 400 redisplays respective graphical elements on an opposite side of a centerline of display 402 in response to computer system 400 continuing to detect motion. For example, computer system 400 redisplays graphical element 406b5 at the rightmost boundary of area 408 in response to computer system 400 continuing to detect the motion to the right. In some embodiments, a speed of movement of a graphical element of dynamic element 406 is consistent, based on, and/or the same speed as the horizontal component of the motion. For example, in response to a detected motion accelerating at a first rate to the right, graphical elements are displayed as moving at a corresponding rate from the right of display 402 to the left of display 402. It should be recognized that graphical elements of dynamic element 406 can move differently than described above, such as in the same direction as the motion or at an angle opposite of or matching the motion (e.g., the horizontal and vertical component of the motion). In some embodiments, each column of graphical elements moves synchronously. In some embodiments, each row of graphical elements (e.g., the row including graphical element 406a2 and graphical element 406a3) moves synchronously. In some embodiments, rows of graphical elements and columns of graphical elements move differently. For example, in some embodiments, as computer system 400 moves dynamic element 406L and dynamic element 406R across display 412, computer system 400 ceases to display graphical elements included in different rows of dynamic element 406L and dynamic element 406R at different locations on display 412.

As also illustrated in FIG. 4C, dynamic element 406 changes appearance in response to detecting the motion to the right. For example, each graphical element of graphic elements changes appearance as a response to the motion. As illustrated in FIG. 4C, each graphical element changes size according to the horizontal component of the motion (and/or according to movement of each graphical element). For example, graphical element 406a1 becomes smaller as graphical element 406a1 moves to the left and graphical element 406a3 becomes larger as graphical element 406a3 moves to the left. It should be recognized that graphical elements of dynamic element 406 can change appearance differently than described above, such as changing color, shape, and/or opacity.

As also illustrated in FIG. 4C, a size of dynamic element 406R changes in response to detecting the motion to the right. For example, the size of dynamic element 406R changes from area 414 as illustrated in FIG. 4B to area 422 as illustrated in FIG. 4C, reducing the number of columns of graphical elements within dynamic element 406R from 3 to 2. In some embodiments, reducing the number of columns of graphical elements within dynamic element 406R causes a maximum size to be smaller and/or a distance for which a graphical element increases from zero to a maximum size, decreases from a maximum size to zero, and/or maintains a maximum size to be smaller and/or moved to the right relative to width of content 404. Notably, the side of dynamic element 406 that is reduced is in the direction of the motion and the other size (e.g., dynamic element 406L) is not reduced. It should be recognized that, in some embodiments, the other size of dynamic element 406 (e.g., dynamic element 406L) can become larger or also be reduced. It should also be recognized that FIG. 4C illustrates one example of a change in size and that other changes of size can be performed, including a change in size that is proximate to magnitude of the motion (e.g., greater magnitude of motion to the right causes dynamic element 406L to become smaller and/or dynamic element 406R to become larger).

In some embodiments, computer system 400 does not display, ceases displaying, and/or fades out display of dynamic element 406 when computer system 400 is not moving, not in a vehicle, and/or not detecting motion (e.g., velocity and/or acceleration) via a sensor included and/or in communication with computer system 400. In some embodiments, computer system 400 does not display, ceases displaying, and/or fades out display of dynamic element 406 when the acceleration rate of computer system 400 is below a threshold and/or when a determination is made that a magnitude (e.g., speed and/or acceleration) of the detected motion is below a threshold.

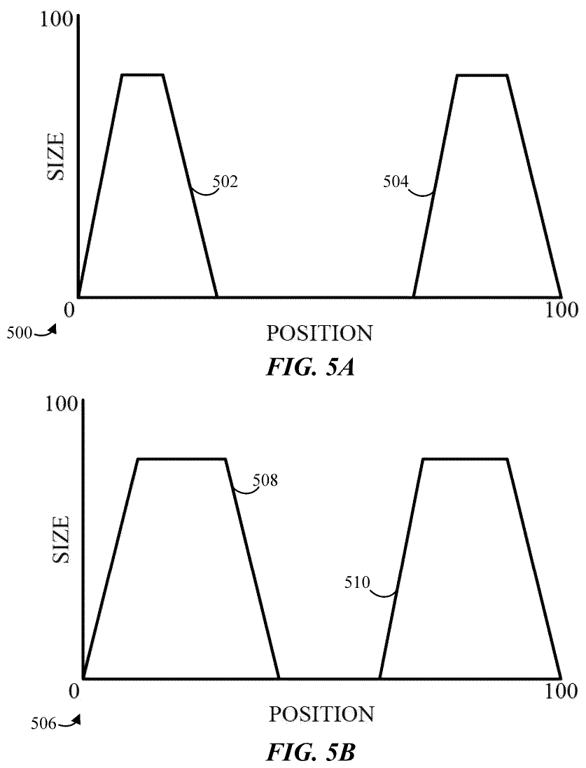

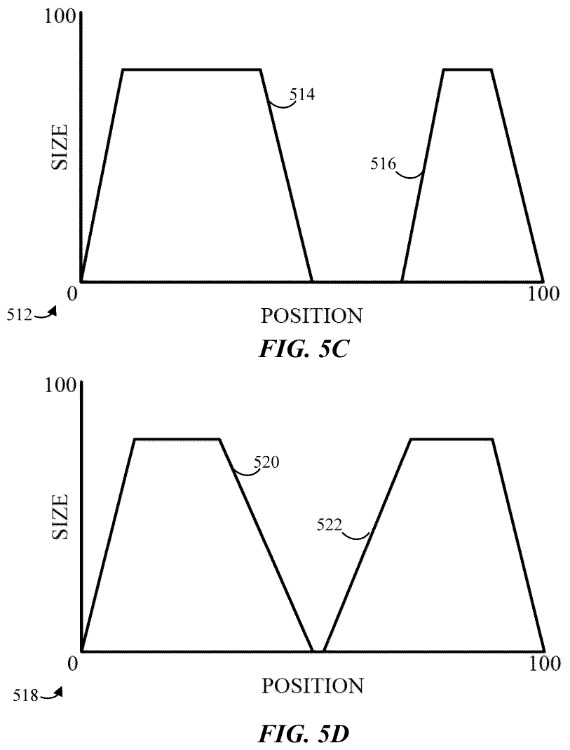

FIGS. 5A-5D illustrate example graphs for how a graphical element can change as the graphical element changes position in accordance with some embodiments. The graphs include position on the x-axis and size on the y-axis. Accordingly, as you move from the origin of a graph to the right, the position of a graphical element is moving across a user interface from a left side of the user interface to a right side of the user interface (e.g., as a result of a computer system detecting motion (e.g., to the left) as described above with respect to FIGS. 4A-4C). It should be recognized that the left side and/or the right side of the user interface can be different for different graphical elements and/or start at a location other than a left edge and/or a right edge of the user interface. In addition, as you move from the origin of a graph up, the size of a graphical element is increasing. It should be recognized that size is only one example of how a graphical element can change appearance and that other changes in addition to or instead of size are within the scope of this disclosure, including color, opacity, and/or shape.

At FIG. 5A, graph 500 includes line 502 and line 504. In some embodiments, line 502 corresponds to a graphical element within dynamic element 406L and line 504 corresponds to a graphical element within dynamic element 406R. As illustrated in FIG. 5A, line 502 and line 504 are mirrors of each other (e.g., the same) except that they are located at different positions (e.g., as illustrated in FIG. 4B by dynamic element 406L and dynamic element 406R). It should be recognized that line 502 can be different than line 504 in some embodiments, as further discussed below. In some embodiments, graph 500 illustrates size changes of a graphical element as the graphical element changes position while a computer system is detecting little or less motion (e.g., velocity and/or acceleration, such as in a forward direction) as compared to, for example, FIG. 5B. In such embodiments, an area that a graphical element is visible and/or a number of graphical elements visible is less than as compared to FIG. 5B. In some embodiments, line 502 and/or line 504 begin at a position on the y-axis that is greater than a value of zero (e.g., the display of the graphical elements is maintained as the graphical elements move across the display of the computer system). In some embodiments, the rate of change in the size of the graphical elements (e.g., shape of line 502 and/or line 504) is dependent on the acceleration and/or velocity of a computer system (e.g., computer system 400). In some embodiments, change in the size of the graphical elements (e.g., the shape of line 502 and/or line 504) is dependent on one or more user defined settings (e.g., one or more user customizations). In some embodiments, line 502 represents an opacity of a graphical element within dynamic element 406L and line 504 corresponds to an opacity of a graphical element within dynamic element 406R. That is, the opacity of graphical elements within dynamic element 406L and dynamic element 406R change as the graphical elements move across a display of a computer system (e.g., computer system 400). In some embodiments, computer system 400 performs post processing on line 502 and/or line 504 that changes an appearance of the graphical element included within dynamic element 406R and/or dynamic element 406L such that high frequency changes are filtered out and/or the rate of change of dynamic element 406L and/or dynamic element 406R is limited.

As illustrated in FIG. 5A, a graphical element following line 502 would start not visible at size 0 when at position 0, increase size as the position increases until reaching a maximum size, maintain the maximum size for a distance, and then decrease size until the graphical element is no longer visible. For example, graphical element 406a2 in FIG. 4B can be an example of a graphical element that is somewhere between not being visible and a maximum size while graphical element 406a1 in FIG. 4B can be an example of a graphical element that is at the maximum size. As also illustrated in FIG. 5A, a graphical element following line 504 after line 502 would start not visible at size 0, increase size as the position increases until reaching a maximum size, maintain the maximum size for a distance, and then decrease size until the graphical element is no longer visible at position 100. In some embodiments, the distance to increase from or to size 0 and/or the distance to maintain the maximum size can be increased or decreased depending on a size of a window (e.g., content 404). For example, when content being displayed is larger and/or takes up more area, the distance to increase from or to size 0 and/or the distance to maintain the maximum size can be larger than when content being displayed is smaller and/or takes up less area.

In some embodiments, the same or different graphical element can follow line 502 and line 504 such that when motion is detected to the left, a graphical element follows line 502 starting at position 0 and then follows line 504 until position 100. Similarly, the same or different graphical element can follow line 502 and line 504 such that when motion is detected to the right, a graphical element follows line 504 starting at position 100 and then follows line 502 until position 0. It should be recognized that a graphical element can start at any point in graph 500 and that motion causing the graphical element to move to the right would follow graph 500 to the right while motion causing the graphical element to move to the left would following graph 500 to the left.

At FIG. 5B, graph 506 includes line 508 and line 510. In some embodiments, line 508 corresponds to a graphical element within dynamic element 406L and line 510 corresponds to a graphical element within dynamic element 406R. As illustrated in FIG. 5B, line 508 and line 510 are mirrors of each other (e.g., the same) except that they are located at different positions (e.g., as illustrated in FIG. 4B by dynamic element 406L and dynamic element 406R). It should be recognized that line 508 can be different than line 510 in some embodiments, as further discussed below. In some embodiments, graph 506 illustrates size changes of a graphical element as the graphical element changes position while a computer system is detecting more motion (e.g., velocity and/or acceleration, such as in a forward direction) as compared to, for example, FIG. 5A. In such embodiments, an area that a graphical element is visible and/or a number of graphical elements visible (e.g., while, in some embodiments, maintaining a distance between each graphical element in a row and/or a column) is more than as compared to FIG. 5A.

As illustrated in FIG. 5B, a graphical element following line 508 would start not visible at size 0 when at position 0, increase size as the position increases until reaching a maximum size, maintain the maximum size for a distance, and then decrease size until the graphical element is no longer visible. As also illustrated in FIG. 5B, a graphical element following line 510 after line 508 would start not visible at size 0, increase size as the position increases until reaching a maximum size, maintain the maximum size for a distance, and then decrease size until the graphical element is no longer visible at position 100. Notably, the distance to increase from or to size 0 and/or the distance to maintain the maximum size can be increased with respect to FIG. 5B relative to FIG. 5A (e.g., as a result of increased motion).

At FIG. 5C, graph 512 includes line 514 and line 516. In some embodiments, line 514 corresponds to a graphical element within dynamic element 406L and line 516 corresponds to a graphical element within dynamic element 406R. As illustrated in FIG. 5C, line 514 and line 516 do not mirror each other (e.g., instead, are different) and are located at different positions (e.g., as illustrated in FIG. 4C by dynamic element 406L and dynamic element 406R). In some embodiments, graph 512 illustrates size changes of a graphical element as the graphical element changes position while a computer system is detecting motion to the right (e.g., as illustrated in FIG. 4C). In such embodiments, one side (e.g., dynamic element 406L or dynamic element 406R) can shrink and/or reduce number of graphical elements (e.g., by reducing a column, a row, and/or individual graphical elements) (e.g., while, in some embodiments, maintaining a distance between each graphical element in a row and/or a column) as illustrated by line 516 relative to FIG. 5B while another side can enlarge and/or increase number of graphical elements (e.g., by adding a column, a row, and/or individual graphical elements) (e.g., while, in some embodiments, maintaining a distance between each graphical element in a row and/or a column) as illustrated by line 514 relative to FIG. 5B. It should it recognized that, in some embodiments, one side can shrink and/or reduce number of graphical elements while the other side maintains its size or one side can enlarge and/or increase number of graphical elements while the other side maintains its size.

As illustrated in FIG. 5C, a graphical element following line 514 would start not visible at size 0 when at position 0, increase size as the position increases until reaching a maximum size, maintain the maximum size for a distance, and then decrease size until the graphical element is no longer visible. As also illustrated in FIG. 5C, a graphical element following line 516 after line 514 would start not visible at size 0, increase size as the position increases until reaching a maximum size, maintain the maximum size for a distance, and then decrease size until the graphical element is no longer visible at position 100.

At FIG. 5D, graph 518 includes line 520 and line 522. In some embodiments, line 520 corresponds to a graphical element within dynamic element 406L and line 522 corresponds to a graphical element within dynamic element 406R. As illustrated in FIG. 5D, line 514 and line 516 are mirrors of each other (e.g., the same) except that they are located at different positions. In some embodiments, graph 518 illustrates size changes of a graphical element as the graphical element changes position while a computer system is detecting more motion as compared to, for example, FIG. 5B (e.g., motion that exceeds a threshold, that would cause a graphical element to increase and/or reduce size too quickly for a speed that the graphical element is moving). In such embodiments, an area that a graphical element is visible, a distance for which a graphical element reduces to size 0, a distance for which a graphical element increases to a maximum size, and/or a number of graphical elements visible (e.g., while, in some embodiments, maintaining a distance between each graphical element in a row and/or a column) is more than as compared to FIG. 5B. In some embodiments, graph 518 is produced by applying a lowpass filter to each point in graph 506 (e.g., each point while decreasing to zero while increasing position in line 508 and each point while increasing to a maximum size while increasing position in line 510). It should be recognized that graph 518 is just one example of how line 520 and line 522 can be when detecting more motion and that the left side in addition to or instead of the right side of line 520 can be elongated and/or a number of graphical elements visible (e.g., while, in some embodiments, maintaining a distance between each graphical element in a row and/or a column) can be increased and/or that the right side in addition to or instead of the left side of line 522 can be elongated and/or a number of graphical elements visible (e.g., while, in some embodiments, maintaining a distance between each graphical element in a row and/or a column) can be increased. It should also be recognized that, while graph 518 illustrates extending one side of each line (e.g., line 520 and line 522) relative to graph 506, an area in which a graphical element is displayed can be the maintained such that a distance that the graphical element is at a maximum size is reduced to make more distance to increase and/or reduce the size of the graphical element.

As illustrated in FIG. 5D, a graphical element following line 520 would start not visible at size 0 when at position 0, increase size as the position increases until reaching a maximum size, maintain the maximum size for a distance, and then decrease size over a larger distance than when increasing size until the graphical element is no longer visible. As also illustrated in FIG. 5C, a graphical element following line 516 after line 514 would start not visible at size 0, increase size as the position increases until reaching a maximum size, maintain the maximum size for a distance, and then decrease size over a shorter distance than when increasing size until the graphical element is no longer visible at position 100.

The user interfaces in FIGS. 4A-4C and graphs in FIGS. 5A-5D are used to illustrate the methods described below, including the methods in FIG. 6. FIG. 6 is a flow diagram that illustrates method 600 for displaying user interfaces based on detected motion according to some embodiments. In some embodiments, method 600 is performed at a computer system (e.g., a desktop computer, a laptop computer, a tablet computer, a smartphone, a smartwatch, a television, a monitor, a head-mounted display system) that is in communication with and/or includes a display (e.g., a monitor, a touch-sensitive display, a head-mounted display, a three-dimensional display, and/or a projector) and one or more input devices (e.g., a physical input mechanism (e.g., a hardware input mechanism, a rotatable input mechanism, a crown, a knob, a dial, a physical slider, and/or a hardware button), a camera, a touch-sensitive display, a microphone, an accelerometer, and/or a button). Some operations in method 600 are, optionally, combined, the orders of some operations are, optionally, changed, and some operations are, optionally, omitted.

While displaying, via the display, a user interface object (e.g., a textual user interface object and/or a graphical user interface object) in an initial (e.g., neutral, first, particular, and/or starting) manner, the computer system detects (e.g., 602), via the one or more input devices, acceleration in a first direction (e.g., of the computer system and/or a sensor (e.g., a sensor of the computer system and/or a sensor of an external structure)) (e.g., translational acceleration and/or rotational acceleration) (e.g., the computer system is accelerating, de-accelerating, moving to the left, moving to the right, and/or moving in a forward direction) (e.g., a forward direction, a side direction, and/or a backward direction). In some embodiments, the computer system is accelerated via a moveable component. In some embodiments, the computer system is accelerated via a user. In some embodiments, the acceleration of the external structure (e.g., an automobile, boat, or airplane) that is accelerating) causes the computer system to accelerate.

In response to (and/or in conjunction with, after, and/or while) detecting the acceleration in the first direction, the computer system displays (e.g., 604), via the display, the user interface object in a subsequent (e.g., second) manner different than the initial manner based on the acceleration (e.g., the user interface object is displayed with a different color, opacity, and/or size while displayed in the subsequent manner in contrast to when the user interface object is displayed in the initial manner).

After (e.g., and/or while) displaying the user interface object in the subsequent manner based on the acceleration (e.g., and/or while displaying the user interface object in another manner different from the subsequent manner and/or the initial manner), the computer system continues (e.g., 606) to detect, via the one or more input devices, the acceleration in the first direction. In some embodiments, continuing to detect the acceleration in the first direction includes detecting a change in the acceleration rate, velocity, and/or direction of the computer system.

In response to continuing to detect the acceleration in the first direction, the computer system displays, via the display, the user interface object in the initial manner (e.g., and not the subsequent manner). In some embodiments, the computer system displays the user interface object in the subsequent manner in accordance with a determination that the acceleration rate of the acceleration is greater than an acceleration threshold. In some embodiments, the computer system ceases displaying the user interface object in the subsequent manner in response to ceasing to detect the acceleration (e.g., the computer system displays the user interface object in the initial manner or ceases to display the user interface object). In some embodiments, the subsequent manner is user selected. In some embodiments, the computer system does not display the user interface object in the subsequent manner in response to continuing to detect the acceleration in the first direction (e.g., the computer system continues to display the user interface object in the initial manner). In some embodiments, the one or more input devices are included in an external computer system. In some embodiments, the user interface object is a set of one or more user interface objects.

Transitioning from displaying the user interface object in the initial manner, to the subsequent manner, and back to the initial manner in response to continuing to detect the acceleration in the first direction allows the computer system to provide a dynamic user interface object that changes between appearances during motion so that, in some embodiments, to reduce and/or stop motion discomfort, thereby performing an operation when a set of conditions has been met without requiring further user input.

In some embodiments, the acceleration in the first direction is a first acceleration. In some embodiments, before (e.g., immediately before or within a predetermined period of time (e.g., 1-20 seconds) before) detecting the first acceleration, the computer system detects, via the one or more input devices, a second acceleration (e.g., of the computer system and/or a sensor (e.g., a sensor of the computer system and/or a sensor of an external structure)) (e.g., translational acceleration and/or rotational acceleration) (e.g., the computer system is accelerating, de-accelerating, moving to the left, moving to the right, and/or moving in a forward direction). In some embodiments, the computer system is accelerated via a moveable component. In some embodiments, the computer system is accelerated by a user. In some embodiments, the computer system is positioned within an external structure that is accelerating. In some embodiments, in response to detecting the second acceleration, the computer system displays, via the display, the user interface object (e.g., with (e.g., in) the initial manner or in a manner that is different from the initial manner) (e.g., the user interface object was not displayed before detecting the second acceleration). In some embodiments, the computer system ceases to display the user interface object before detecting the first acceleration. In some embodiments, the computer system displays the user interface object in response to detecting a respective acceleration that has an acceleration rate that is greater than a threshold. Displaying the user interface object in response to detecting the second acceleration allows the computer system to provide an indication of the state of the computer system and/or a state of an external structure (e.g., that the computer system and/or the external structure is accelerating), thereby providing improved visual feedback and providing additional control options without cluttering the user interface with additional displayed controls.

In some embodiments, displaying the user interface object in the subsequent manner includes displaying the user interface object with (e.g., in and/or at) a particular size (e.g., length, width, and/or diameter), opacity, shape, color (e.g., a color included in the gray scale or a color not included in the gray scale), or any combination thereof.

In some embodiments, displaying the user interface object in the subsequent manner includes changing a first visual characteristic (e.g., opacity, size, and/or color) of the user interface object at a first point in time (e.g., after detecting the acceleration in the first direction), and changing a second visual characteristic (e.g., opacity, size, and/or color) of the user interface object, different from the first visual characteristic of the user interface object, at the first point in time. In some embodiments, displaying the user interface object in the subsequent manner includes changing the first visual characteristic of the user interface object before or after changing the second visual characteristic of the user interface object. Concurrently changing the first visual characteristic and the second visual characteristic allows the computer system to perform a display operation that indicates how quickly the computer system is accelerating and/or deaccelerating, thereby providing additional control options without cluttering the user interface with additional displayed controls.

In some embodiments, while displaying the user interface object, the computer system ceases to detect the acceleration in the first direction. In some embodiments, in response to ceasing to detect the acceleration in the first direction, the computer system ceases to display the user interface object. In some embodiments, the computer system redisplays the user interface object in response to detecting a subsequent acceleration. In some embodiments, the computer system ceases to display the user interface in response to detecting that the acceleration is below an acceleration threshold. Ceasing to display the user interface object in response to ceasing to detect the acceleration in the first direction allows the computer system to control the display of the user interface object based on the acceleration of the computer system and/or the acceleration of an external structure, thereby providing additional control options without cluttering the user interface with additional displayed controls.

In some embodiments, in response to (e.g., in conjunction with or while) detecting the acceleration in the first direction and in accordance with a determination that the first direction is in a first orientation (e.g., heading and/or bearing) (e.g., a forward direction, a side direction, a left turn, and/or a right turn), the computer system moves, via the display, the user interface object in a first manner (e.g., the user interface object is moved in a lateral direction and/or a rotational direction). In some embodiments, in response to (e.g., in conjunction with or while) detecting the acceleration in the first direction and in accordance with a determination that the first direction is in a second orientation (e.g., heading and/or bearing) different from the first orientation, the computer system moves, via the display, the user interface object in a second manner different from the first manner. In some embodiments, the computer system moves the user interface object in a direction that is opposite the detected direction of the acceleration. In some embodiments, computer system moves the user interface object in the same direction as the detected direction of the acceleration. In some embodiments, the speed at which the user interface object moves is based on the rate of the acceleration. In some embodiments, the user interface object does not move in response to detecting the acceleration. Moving the user interface object in different orientation when a set of conditions is met automatically allows the computer system to provide an indication of the direction of acceleration of the computer system and/or a direction of acceleration an external structure, thereby performing an operation when a set of conditions has been met without requiring further user input. In some embodiments, the computer system (e.g., 400) displays (e.g., before displaying the user interface object, while displaying the user interface object, and/or after displaying the user interface object), via the display generation component, content (e.g., 404) (e.g., a user interface, a user interface object, and/or media (e.g., video and/or photo)), wherein displaying the user interface object (e.g., 406) includes overlaying the user interface object on (e.g., on top of, covering and/or over) the content. In some embodiments, the user interface object obstructs the view of the content. In some embodiments, the user interface object does not obstruct the view of the content (e.g., the user interface object is translucent). In some embodiments, the user interface object covers a majority or a minority of the content. In some embodiments, the content includes a single continuous portion of content. In some embodiments, the content is displayed in response to detecting motion. In some embodiments, the content is displayed in response to detecting an input. Displaying the user interface object as overlaid on top of the content allows the computer system to concurrently display both the content and the user interface object such that both the user interface object and the content are simultaneously visible to a user, thereby providing improved feedback.

In some embodiments, the acceleration in the first direction is a first acceleration. In some embodiments, after detecting the first acceleration, the computer system (e.g., 400) detects, via one or more input devices, a second acceleration in the first direction. In some embodiments, the second acceleration is a continuation of and/or same as the first acceleration. In some embodiments, the second acceleration is different from the first acceleration. In some embodiments, the second acceleration is detected in a direction that is different from the first direction. In some embodiments, in response to detecting the second acceleration, the computer system ceases to display, via the display generation component, the user interface object (e.g., 406L and/or 406R). In some embodiments, the computer system applies a visual effect (e.g., a blur effect, decrease in opacity, and/or fading out) as a part of ceasing to display the user interface object. In some embodiments, the computer system does not cease to display the user interface object in response to detecting the second acceleration in the first direction. In some embodiments, the manner in which the computer system ceases to display the user interface object is dependent on the second acceleration (e.g., the direction of the second acceleration and/or the magnitude of the second acceleration). In some embodiments, the manner in which the computer system ceases to display the user interface object is user dependent (e.g., the computer system gradually ceases to display the user interface object for a first user and abruptly ceases to display the user interface object for a second user different from the first user). Ceasing to display the user interface object in response to detecting the second acceleration allows the computer system to provide an indication with respect to the state of the computer system, thereby providing improved feedback and/or providing additional control options without cluttering the user interface with additional displayed controls.

In some embodiments, after ceasing display of the user interface object (and/or while no longer displaying the user interface object), the computer system (e.g., 400) detects, via the one or more input devices, a third acceleration (e.g., 420 at FIGS. 4B and/or 4C)) in the first direction; and In some embodiments, the third acceleration is detected in a direction that is different from the first direction. In some embodiments, the third acceleration is different from the first acceleration and/or the second acceleration. In some embodiments, the third acceleration is the same as the first acceleration and/or the second acceleration. In some embodiments, in response to detecting the third acceleration, the computer system displays, via the display generation component, the user interface object (e.g., 406L and/or 406R) in the initial manner. In some embodiments, the computer system displays the user interface object in a manner different from the initial manner. In some embodiments, displaying the user interface object in the initial manner includes displaying the user interface object with the size, opacity, and/or color as the user interface object was initially displayed with but displaying the user interface object at a different location of the display generation component. In some embodiments, the amount of time it takes for the computer system to redisplay the user interface object depends on the speed (e.g., the computer system gradually displays the user interface object when the speed is low or the computer system abruptly displays the user interface object when the speed is high). Displaying the user interface object in the initial manner in response to detecting the third acceleration allows the computer system to provide an indication with respect to the state of the computer system, thereby providing improved feedback and/or providing additional control options without cluttering the user interface with additional displayed controls.

In some embodiments, displaying the user interface object (e.g., 406L and/or 406R) includes moving the user interface object. In some embodiments, in accordance with a determination that the acceleration has a first magnitude (e.g., instantaneous magnitudes, average magnitude, and/or median magnitude) (e.g., rate and/or change in speed), the user interface object is moved at a first rate (e.g., speed, pace, and/or tempo). In some embodiments, in accordance with a determination that the acceleration has a second magnitude (e.g., instantaneous magnitudes, average magnitude, and/or media magnitude) (e.g., rate and/or change in speed), different from the first magnitude, the user interface object is moved at a second rate (e.g., speed, pace, and/or tempo) different from the first rate. In some embodiments, the magnitude of the acceleration and the rate at which the user interface object is moved has a direct correlation. In some embodiments, the magnitude of the acceleration and the rate at which the user interface object is moved has an inverse correlation. In some embodiments, the rate at which the user interface object is moved is based on the direction of the acceleration. In some embodiments, the direction in which the user interface object is moved is based on the acceleration. In some embodiments, the speed at which the user interface object is moved is based on the acceleration (e.g., the speed of the movement of the user interface object is directly correlated to the speed and/or direction of the acceleration and/or the speed of the movement of the user interface object is inversely correlated to the speed and/or direction of the acceleration). Moving the user interface object at a particular rate when a set of prescribed conditions is met (e.g., the acceleration has a first magnitude or a second magnitude) automatically allows the computer system to tailor the performance of a motion mitigation technique to the detected motion, thereby performing an operation when a set of conditions has been met without requiring further user input and/or providing improved feedback.

In some embodiments, while displaying the user interface object (e.g., in the initial manner, in the subsequent manner, or in a respective manner that is different than the initial manner and/or the subsequent manner), the computer system detects, via the input device, that a magnitude (e.g., instantaneous magnitudes, average magnitude, and/or median magnitude) (e.g., rate and/or change in speed) of the acceleration is less than an acceleration threshold (e.g., a default threshold, a user specific threshold, and/or a context specific threshold). In some embodiments, in response to detecting that the magnitude of the acceleration is less than the acceleration threshold, the computer system ceases to display, via the display generation component, the user interface object (e.g., as discussed above at FIG. 4C). In some embodiments, the computer system continues to display the user interface object in response to detecting that the magnitude of the acceleration is less than the acceleration threshold. In some embodiments, the computer system redisplays the user interface object in response to detecting that the magnitude of the acceleration transitions from being less than the acceleration threshold to being greater than the acceleration threshold. Ceasing to display the user interface object in response to detecting that the magnitude of the acceleration is less than the acceleration threshold allows the computer system to cease display of the user interface object at a point in time when the display of the user interface object is no long necessary (e.g., the computer system and/or an external structure is slowing down), thereby providing improved feedback and/or providing additional control options without cluttering the user interface with additional displayed controls.

In some embodiments, continuing to detect the acceleration includes detecting, via the input device, a change in one or more attributes (e.g., direction of acceleration, magnitude of acceleration, and/or acceleration force (e.g., exerted on the computer system and/or on the user)) of the acceleration (e.g., as discussed above at FIG. 4C). In some embodiments, continuing to detect the acceleration does not include detecting a change in one or more attributes of the acceleration. In some embodiments, a first attribute of the acceleration changes by a different amount than a second attribute of the acceleration. In some embodiments, the one or more attribute of the acceleration change by the same amount.

In some embodiments, while displaying the user interface object (e.g., 406L and/or 406R) (e.g., in the initial manner or in the subsequent manner), the computer system (e.g., 400) ceases to detect, via the input device, the acceleration in the first direction (e.g., or any acceleration). In some embodiments, in response to ceasing to detect the acceleration in the first direction, the computer system ceases to display, via the display generation component, the user interface object. In some embodiments, the computer system redisplays, via the display generation component, the user interface object in response to detecting initiation of the acceleration. In some embodiments, the computer system ceases to display the user interface object in response to detecting an input. In some embodiments, the computer system ceases to display the user interface object while the acceleration is detected. In some embodiments, the computer system continues to display the user interface object in response to ceasing to detect the acceleration. In some embodiments, the computer system applies a visual effect (e.g., blurring, fading out, reducing the opacity) to the user interface object as a part of ceasing to display the user interface object. In some embodiments, the computer system gradually ceases to display the user interface object as the acceleration gradually decreases. Ceasing to display the user interface object in response to ceasing to detect the acceleration in the first direction allows the computer system to cease display of the user interface object at a point in time when the display of the user interface object is no long necessary, thereby providing improved feedback and/or providing additional control options without cluttering the user interface with additional displayed controls.

In some embodiments, a magnitude (e.g., instantaneous magnitudes, average magnitude, and/or median magnitude) (e.g., rate and/or change in speed) of the acceleration in the first direction (e.g., 420 at FIGS. 4B and/or 4C) is greater than an acceleration threshold (e.g., as discussed above at FIG. 4B). In some embodiments, the acceleration threshold is a default acceleration threshold. In some embodiments, the acceleration threshold is a user specific acceleration threshold. In some embodiments, the acceleration threshold is a context specific threshold. Displaying the user interface object in response to detecting that a magnitude of the acceleration in the first direction is greater than a threshold allows the computer system to avoid displaying the user interface object in response to detecting insignificant acceleration rates, thereby providing improved feedback and/or providing additional control options without cluttering the user interface with additional displayed controls.

In some embodiments, the acceleration (e.g., 420 at FIGS. 4B and or 4C) in the first direction corresponds to an external structure (e.g., as discussed above at FIG. 4B) (e.g., an automobile, a plane, a train, and/or a boat). In some embodiments, the acceleration in the first direction corresponds to the computer system. In some embodiments, the acceleration in the first direction corresponds to a body portion (e.g., head, arms, torso, and/or legs) of a user. In some embodiments, the computer system is positioned within the external structure. In some embodiments, the computer system is coupled to the external structure. In some embodiments, the computer system is not within the structure and/or coupled to the external structure.

In some embodiments, the user interface object is a first user interface object (e.g., 406a1, 406a2, 406a3, 406a4, 406a5, 406a6, 406b1, 406b2, 406b3, 406b4, 406b5, and/or 406b6), wherein the first user interface object is displayed at a first location while detecting the acceleration in the first direction (e.g., when the user interface object is displayed in the initial manner), wherein the first user interface object is displayed at a second location, different from the first location, in response to detecting the acceleration in the first direction (e.g., when the user interface object is displayed in the subsequent manner). In some embodiments, while displaying the first user interface object in the initial manner (e.g., while detecting the acceleration in the first direction), the computer system (e.g., 400) displays, via the display generation component, a second user interface object (e.g., 406a1, 406a2, 406a3, 406a4, 406a5, 406a6, 406b1, 406b2, 406b3, 406b4, 406b5, and/or 406b6), different from the first user interface object, at a third location different from the first location (and/or the second location), wherein the first location is in a first direction from the second location (e.g., the first user interface object and the second user interface object are within a row of user interface objects). In some embodiments, in response to (and/or in conjunction with, after, and/or while) detecting the acceleration (e.g., 420 at FIGS. 4B and/4C) in the first direction, the computer system displays, via the display generation component (e.g., 402), the second user interface object at a fourth location different from the second location and the third location (and/or the first location), wherein the fourth location is in the first direction from the third location, wherein a distance between the second location and the first location is a first distance, wherein a distance between the fourth location and the third location is a second distance, and wherein the second distance is the same as the first distance (e.g., as discussed above at FIG. 4C). In some embodiments, in response to (and/or in conjunction with, after, and/or while) detecting the acceleration in the first direction, the computer system moves the second user interface object in a synchronized manner with the first user interface object (e.g., the second user interface object moves in the same direction, speed, and/or manner as the first user interface object) based on the acceleration in the first direction. In some embodiments, the first user interface object and the second user interface object have the same appearance but are located at different locations. In some embodiments, the first user interface object and the second user interface object have different appearances and are located at different locations. Moving the second user interface object in a synchronized manner with the first user interface object allows the computer system to perform a motion mitigation technique that aids in alleviating discomfort a user is experiencing as a result of the motion, thereby providing additional control options without cluttering the user interface with additional displayed controls and/or providing improved feedback.

In some embodiments, while displaying the first user interface object (e.g., 406a1, 406a2, 406a3, 406a4, 406a5, 406a6, 406b1, 406b2, 406b3, 406b4, 406b5, and/or 406b6) at the first location and the second user interface object (e.g., 406a1, 406a2, 406a3, 406a4, 406a5, 406a6, 406b1, 406b2, 406b3, 406b4, 406b5, and/or 406b6) at the third location, the computer system (e.g., 400) displays, via the display generation component (e.g., 402), a third user interface object (e.g., 406a1, 406a2, 406a3, 406a4, 406a5, 406a6, 406b1, 406b2, 406b3, 406b4, 406b5, and/or 406b6), different from the first user interface object and the second user interface object, at a fifth location different from the first location and the third location (and/or the second location and/or the fourth location), wherein the first location is in a second direction, different from (e.g., perpendicular and/or tangential to) the first direction, from the fourth location (e.g., the first user interface object and the third user interface object are within a column of user interface objects). In some embodiments, in response to (and/or in conjunction with, after, and/or while) detecting the acceleration (e.g., 420 at FIG. 4B and/or FIG. 4C) in the first direction, the computer system displays, via the display generation component, the third user interface object at a sixth location different from the second location and the fourth location (and/or the first location and/or the third location), wherein the fourth location is in the second direction from the third location, wherein a distance between the sixth location and the fifth location is a third distance, and wherein the third distance is the same as the first distance and the second distance (e.g., as discussed above at FIG. 4C). In some embodiments, in response to (and/or in conjunction with, after, and/or while) detecting the acceleration in the first direction, the computer system moves the third user interface object in a synchronized manner with the first user interface object (e.g., the third user interface object move in the same direction, speed, and/or manner as the first user interface object) based on the acceleration in the first direction. In some embodiments, the first user interface object, the second user interface object, and/or the third user interface object have the same appearance but are located at different locations. In some embodiments, the first user interface object, the second user interface object, and/or the third user interface object have different appearances and are located at different locations. Moving the third user interface object in a synchronized manner with the first user interface object allows the computer system to perform a motion mitigation technique that aids in alleviating discomfort a user is experiencing as a result of the motion, thereby providing additional control options without cluttering the user interface with additional displayed controls and/or providing improved feedback.

In some embodiments, the first user interface object (e.g., 406a1, 406a2, 406a3, 406a4, 406a5, 406a6, 406b1, 406b2, 406b3, 406b4, 406b5, and/or 406b6) is displayed in the initial manner at the same location as the second user interface object (e.g., 406a1, 406a2, 406a3, 406a4, 406a5, 406a6, 406b1, 406b2, 406b3, 406b4, 406b5, and/or 406b6), wherein the third user interface object (e.g., 406a1, 406a2, 406a3, 406a4, 406a5, 406a6, 406b1, 406b2, 406b3, 406b4, 406b5, and/or 406b6) is displayed in the initial manner at a different horizontal location than the first user interface object, and wherein the third user interface object is not displayed in the initial manner at the same location as the first user interface object and the second user interface object. In some embodiments, the computer system ceases displaying the first user interface object and the second user interface object at the same location (e.g., the same vertical location). In some embodiments, the computer system ceases displaying the third user interface object at a different vertical location than the first user interface object. Displaying the first user interface object and the second user interface object in the initial manner at the same location while not displaying the third user interface object in the initial manner at the same location allows the computer system to perform a motion mitigation technique that aids in alleviating discomfort a user is experiencing as a result of the motion, thereby providing additional control options without cluttering the user interface with additional displayed controls and/or providing improved feedback.

Note that details of the processes described above with respect to method 600 (e.g., FIG. 6) are also applicable in an analogous manner to other methods described herein. For example, method 1300 optionally includes one or more of the characteristics of the various methods described above with reference to method 600. For example, the display of content can be shifted using one or more techniques described herein in relation to method 600, where the content is shifted based on a state of a user described herein in relation to method 1300. For brevity, these details are not repeated herein.

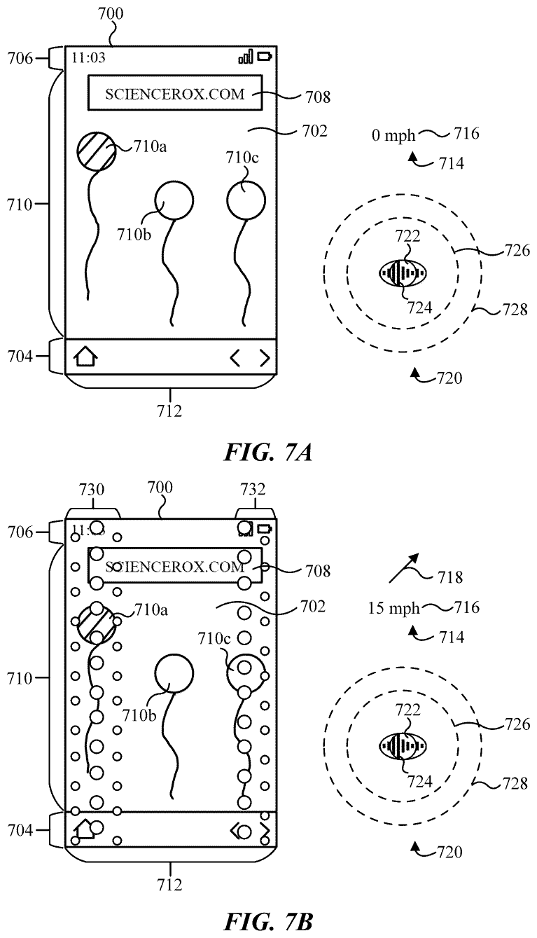

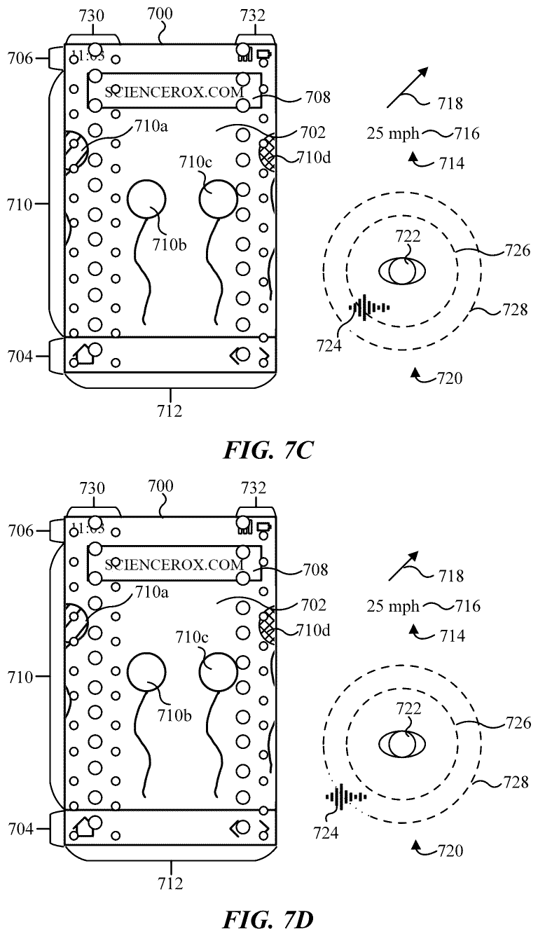

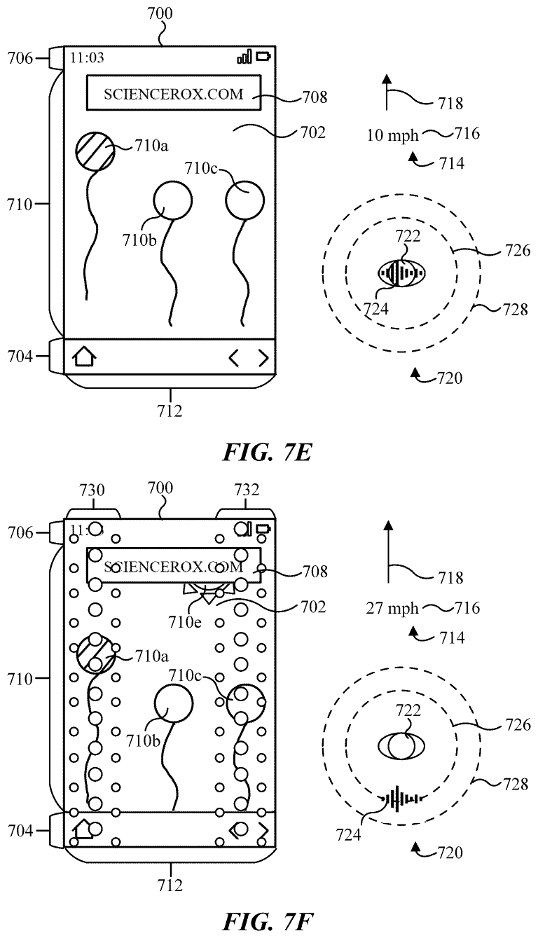

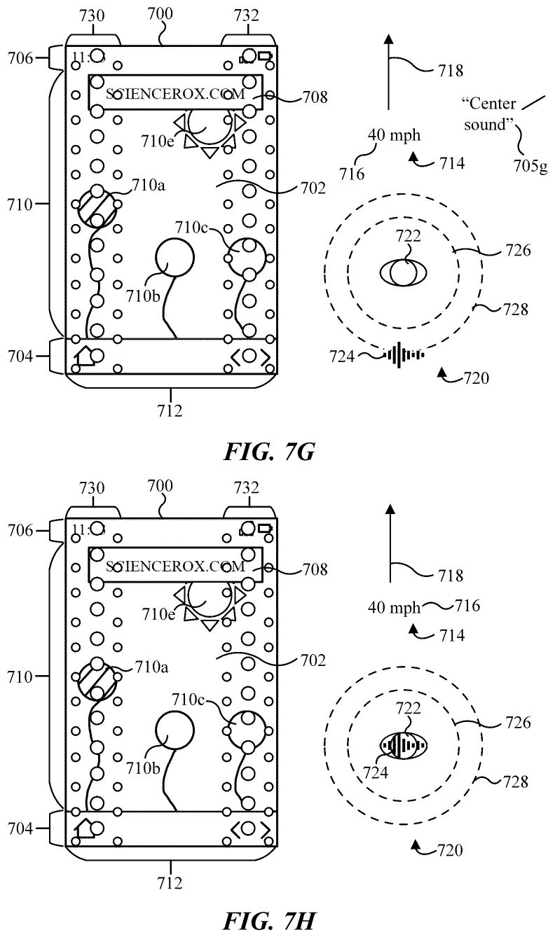

FIGS. 7A-7H illustrate exemplary user interfaces for mitigating the effects of motion in accordance with some embodiments. The user interfaces in these figures are used to illustrate the processes described below, including the processes in FIGS. 8-9.

The left sides of FIGS. 7A-7H illustrate computer system 700 as a smart phone displaying different user interface objects. It should be recognized that computer system 700 can be other types of computer systems, such as a tablet, a smart watch, a laptop, a personal gaming system, a desktop computer, a fitness tracking device, a head-mounted display (HMD) device. In some embodiments, computer system 700 includes and/or is in communication with one or more input devices and/or sensors (e.g., a camera, a LiDAR sensor, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being gaze inputs, other types of inputs can be used with techniques described herein, such as touch inputs that are detected via a touch-sensitive surface and/or air gestures detected via a camera (e.g., a camera that is in communication (e.g., wireless and/or wired communication) with computer system 700. In some embodiments, computer system 700 includes and/or is in communication with one or more audio output devices (e.g., speakers, headphones, earbuds, and/or hearing aids). In some embodiments, computer system 700 is in communication with one or more devices capable of measuring and/or detecting physiological metrics (e.g., heart rate, skin temperature, body temperature, face temperature and/or respiratory rate) of the user, such as a health tracking device and/or smart watch. In some embodiments, computer system 700 determines vitals of the user based on information collected via one or more cameras connected to and/or in communication with computer system 700. In some embodiments, computer system 700 includes one or more components and/or features described above in relation to computer system 100 and/or electronic device 200.

FIGS. 7A-7H illustrate computer system 700 performing various display operations in response to motion being detected. Computer system 700 performs the various display operations to alleviate user discomfort that stems from the detected motion. In some embodiments, computer system 700 performs the various display operations based on a determination that a speed of computer system 700 is greater than a speed threshold. In some embodiments, computer system 700 performs the various display operations based on a determination that an acceleration rate of computer system 700 is greater than an acceleration threshold.

The right sides of FIGS. 7A-7H include motion diagram 714 and sound diagram 720. Motion diagram 714 is indicative of the speed and/or direction of the detected motion of computer system 700. Speed representation 716 indicates the speed of the detected motion as measured in miles-per-hour (MPH). In the examples described in FIGS. 7A-7H, motion diagram 714 represents an absolute motion of computer system 700. In some embodiments, speed representation 716 indicates the acceleration of computer system 700. In some embodiments, speed representation 716 indicates a rotational rate of computer system 700. In some embodiments, motion diagram 714 represents a relative motion. For example, in some embodiments, motion diagram 714 is representative of how computer system 700 is moving relative to another object (e.g., such as computer system 700 moving in a different orientation than a vehicle that computer system 700 is within). In some embodiments, the detected motion of computer system 700 is detected via one or more inertial measurement units (IMUs) of computer system 700 and/or one or more IMUs of an external device that is in communication with computer system 700. In some embodiments, the motion of computer system 700 is detected via one or more camera sensors connected to and/or in communication with computer system 700. For example, the motion of computer system 700 is determined via an analysis of media data that includes objects moving (e.g., moving relative to computer system 700). In some embodiments, the detected motion of computer system 700 is detected via a combination of methods mentioned above (e.g., IMU and/or camera sensor). In some embodiments, the detected motion is motion of a head of the user. In some embodiments, the motion of the head of the user is detected via one or more camera sensors connected to and/or in communication with computer system 700. For example, in some embodiments, computer system 700 detects the motion of the head of the user via comparing the motion of the head of the user to the motion of other objects. In some embodiments, the motion of the head of the user is detected via one or more sensors embedded in one or more audio output devices that move with the user's head such as earbuds and/or headphones. In some embodiments, the detected motion is of a vehicle such as a car, bus, train, and/or plane that computer system 700 is within. In some embodiments, the detected motion of the vehicle is detected via GPS connected to and/or included in the vehicle and in communication with computer system 700.

The discussion of FIGS. 7A-7H describes how computer system 700 performs various display operations and sound operations based on a determination that a detected motion is greater than a motion threshold. However, it should be noted that, computer system 700 performs the various display operations and sound operations described in FIGS. 7A-H, when a determination is made that an acceleration value, rotational rates (rad/s), and/or rotational positions (rad) of the detected motion is greater than a threshold.

As illustrated in FIGS. 7A-7H, computer system 700 outputs sound content via one or more speakers of the computer system 700 and/or speakers external to computer system 700 such as headphones and/or earbuds that form a sound field (e.g., a perceived (e.g., perceived by the user) location of propagation of sound). As illustrated in FIGS. 7A-7H, sound diagram 720 is a visual aid representing the location of the sound field relative to the user. Sound diagram 720 includes user representation 722 that is representative of the position of the user and sound field representation 724 that is representative of the position of the sound field. The positioning of sound field representation 724 and user representation 722 within sound diagram 720 is representative of the real-world positioning of the sound field with respect to the user. Sound diagram 720 also includes inner distance 726 and outer distance 728 which represent distances from the user. In some embodiments, computer system 700 outputs sound content that forms a sound field via two or more (e.g., a pair) of external speakers. For example, in some embodiments when computer system 700 is in communication with a car audio system consisting of a seven-speaker system, computer system 700 uses all seven speakers of the speaker system to create the sound field.

As illustrated in FIG. 7A, computer system 700 displays, via display 712, user interface 702, navigation controls section 704, and status indicator section 706. Navigation controls section 704 contains controls for navigating to various user interfaces. Status indicator section contains indicators with respect the status of computer system 700 such as battery life, signal type, signal strength, and an indicator for the current time. As illustrated in FIG. 7A, user interface 702 includes address bar 708 and main body 710. As illustrated in FIG. 7A, main body 710 includes first object 710a, second object 710b, and third object 710c below address bar 708. As illustrated in FIG. 7A, computer system 700 displays first object 710a, second object 710b, and third object 710c from left to right across user interface 702 with first object 710a displayed at a leftmost position of user interface 702 and third object 710c displayed at a rightmost position of user interface 702. In some embodiments, computer system 700 displays more or less than three objects within main body 710. In some embodiments, main body 710 includes address bar 708.

At FIG. 7A, as indicated by speed representation 716, no motion is detected. At FIG. 7A, as indicated by the positioning sound field representation 724 as centered over user representation 722, computer system 700 is directing the sound field at a location that is centered with respect to the user. In some embodiments, computer system 700 directs the sound field at a default location with respect to the user (e.g., to the right of the user, to the left of the user, behind the user, and/or in front of the user). In some embodiments, computer system 700 directs the sound field towards a location that is set by the user. At FIG. 7A, motion (e.g., and/or acceleration) begins to be detected via one or more of the methods discussed above.

At FIG. 7B, as indicated by motion diagram 714, the detected motion is a right-hand turn at fifteen miles-per-hour. At FIG. 7B, because motion is detected, motion diagram 714 includes direction representation 718. Direction representation 718 is an arrow that points in the direction of the detected motion. At FIG. 7B, a determination is made that a magnitude of the detected motion (e.g., and/or acceleration) is greater than a motion speed threshold and/or in the right direction. At FIG. 7B, because the determination is made that the magnitude of the detected motions is greater than the first motion threshold and/or in the right direction, computer system 700 displays left visual elements 730 and right visual elements 732 as overlayed on at least a portion of the content (e.g., user interface 702, navigation controls section 704, and/or status indicator section 706) that computer system 700 displays. In some embodiments, the detected motion is determined by fusing motion data from various sensors. For example, the detected motion is determined using a combination of data that is measured by an inertial measurement unit housed within headphones of the user and an accelerometer sensor that is housed within a smartphone of the user. In some embodiments, computer system 700 creates a motion discomfort index based on the detected motion and/or a user's personal susceptibility to motion discomfort. In some embodiments, a user's personal susceptibility to motion discomfort is determined by surveying the user, observing the user perform a task, sensor readings, the present and/or historical activity of the user and/or observing whether the user has symptoms (e.g., discolored skin, excessive breathing, sweating, and/or increased heartrate) of motion discomfort. For example, a determination is made that the user's susceptibility to motion discomfort has decreased if six months ago the user could read for thirty minutes of a sixty-minute car trip without experiencing discomfort, but presently the user can read for fifty minutes of the sixty-minute car trip without experiencing discomfort. In some embodiments, computer system 700 displays and/or ceases display of left visual elements 730 and/or right visual elements 732 based on a user's susceptibility of experiencing discomfort as a result of motion. In some embodiments, detected motion is a motion of computer system 700 relative to a vehicle that computer system 700 is in and/or on.

At FIG. 7B, because a determination is made that the detected motion (e.g., and/or acceleration) is in a rightward direction, computer system 700 displays left visual elements 730 and right visual elements 732 as moving from the right to the left. That is, computer system 700 displays left visual elements 730 and right visual elements 732 as moving in a direction that is opposite the direction of the detected motion. Computer system 700 displays left visual elements 730 and right visual elements 732 as moving in a direction that is opposite the direction of the detected motion to help alleviate discomfort a user may experience as a result of the detected motion. More specifically, computer system 700 displays left visual elements 730 and right visual elements 732 as moving in a direction that is opposite the direction of the detected motion such that the forces that the user experiences as a result of the detected motion align with what the user views. In some embodiments, computer system 700 displays left visual elements 730 and right visual elements 732 as moving in a direction that is the same as the direction of the detected motion. In some embodiments, based on a determination that the magnitude of the detected motion is greater than the first motion threshold and that the detected motion is in a leftward direction, computer system 700 displays left visual elements 730 and right visual elements as moving from the left to the right. In some embodiments, left visual elements 730 and right visual elements 732 are some other form of visual elements, such as a different shape, amount of visual elements, and/or a blurring effect. The above description of dynamic element 406, as described above in FIGS. 4A-4C and 5A-5D, are hereby incorporated into left visual elements 730 and right visual elements 732. In some embodiments, the orientation of computer system 700 is tracked relative to the vehicle. In some embodiments, when the orientation of computer system 700 is tracked relative to the vehicle, computer system 700 displays left visual elements 730 and right visual elements 732 based on the orientation of computer system 700 relative to the vehicle. In some embodiments, in addition to displaying left visual elements 730 and right visual elements 732, computer system 700 proactively causes the output of audio alerts that indicate the upcoming direction of motion of computer system 700. For example, when it is determined that computer system 700 will move in a leftward manner within a predetermined amount of time, computer system 700 causes speakers on the lefthand side of the vehicle to output an audible alert.

At FIG. 7B, a determination is made that the magnitude of the detected motion is not greater than a second motion threshold (e.g., twenty miles-per-hour). Because the determination is made that the magnitude of the detected motion is not greater than the second motion threshold, computer system 700 does not modify the display of first object 710a, second object 710b, and/or third object 710c. Also, at FIG. 7B, because the determination is made that that the magnitude of the detected motion is not greater than the second motion threshold, computer system 700 does not modify the output of the sound field. As described in greater detail below, when the magnitude of the detected motion is greater than the second motion threshold, computer system 700 modifies the display of first object 710a, second object 710b, and/or third object 710c and/or modifies the positioning of the sound field. At FIG. 7B, the speed (e.g., and/or acceleration) of the detected motion is detected as increasing via one or more of the methods mentioned above.

At FIG. 7C, as indicated by motion diagram 714, the detected motion (e.g., and/or acceleration) is a right-hand turn at twenty-five miles-per-hour. At FIG. 7C, a determination is made that the magnitude of the detected motion is greater than the second motion threshold. At FIG. 7C, based on the determination that the magnitude of the detected motion is greater than the second motion threshold, computer system 700 moves main body 710 (e.g., including first object 710a, second object 710b, and third object 710c) to the left within user interface 702 by an amount that correlates to the magnitude of the detected motion. In some embodiments, based on the determination that the magnitude of the detected motions is greater than the second motion threshold, computer system 700 outputs cues such as visual cues, haptic cues, and/or audible cues. For example, based on the determination that the magnitude of the detected motion is greater than the second motion threshold, computer system 700 outputs a bell noise to indicate that the magnitude of the detected motion is greater than the second motion threshold and/or that computer system 700 is altering the content of user interface 702.

As illustrated in FIG. 7C, as a result of computer system moving main body 710, computer system 700 continues to display a right portion of first object 710a while ceasing to display a left portion of first object 710a. As illustrated in FIG. 7C, as a result of computer system moving main body 710, computer system 700 displays a left portion of fourth object 710d and computer system 700 does not display a right portion of fourth object 710d. In some embodiments, computer system 700 moving main body 710 to the left by an amount that corresponds to the magnitude of the detected motion does not result in computer system 700 showing any part of fourth object 710d because there is no content included within user interface 702 to the right of third object 710c. In some embodiments, based on the determination that the magnitude of the detected motion is greater than the second motion threshold, computer system 700 changes the display of both main body 710 and address bar 708. For example, in some embodiments, based on the determination that the detected motion satisfies the second criteria and/or based on a determination that the detected motion is in the rightward direction, computer system 700 moves both main body 710 and address bar 708 to the left within user interface 702.

At FIG. 7C, as indicated by sound diagram 720, sound field representation 724 is behind and to the left of user representation 722 in line with inner distance 726 (e.g., different from the location of sound field representation 724 within sound diagram 720 in FIG. 7B). At FIG. 7C, based on the determination that the magnitude of the detected motion is greater than the second motion threshold and based on the determination that the detected motion is in the rightward direction, computer system 700 moves the sound field to the rear and to the left of the user to a location the correlates to the right-hand turn at twenty-five miles-per-hour. That is, to help alleviate discomfort the user experiences as a result of the detected motion, computer system 700 shifts the positioning of the sound field in an opposite direction than the direction of the detected motion. In some embodiments, the movement of the sound field is a gradual change. In some embodiments, the rate at which computer system 700 moves the sound field is based on the magnitude of the detected motion.

Satisfaction of the second motion threshold requires that the magnitude of the detected motion be greater than the requisite magnitude for the satisfaction of the first motion threshold. Accordingly, when the second motion threshold is satisfied, the first motion threshold is also satisfied. Accordingly, at FIG. 7C, a determination is made that the magnitude of the detected motions satisfies the first motion threshold. At FIG. 7C, because the determination is made that the magnitude of the detected motion satisfies the first motion threshold, computer system 700 maintains display of left visual elements 730 and right visual elements 732.

At FIG. 7C, because the determination is made that the detected motion is in the rightward direction, as computer system 700 displays left visual elements 730 and right visual elements 732 as moving from the right to the left. In some embodiments, in response to detecting the motion of the right-hand turn at twenty-five miles-per-hour, computer system 700 changes how left visual elements 730 and right visual elements 732 are displayed. For example, in some embodiments, computer system 700 changes the shape and/or size of left visual elements and/or right visual elements. In some embodiments, based on the determination that the magnitude of the detected motion is greater than the second motion threshold, computer system 700 alters right visual elements 732 to include fewer vertical columns of circle elements. In some embodiments, based on the determination that the magnitude of the detected motion is greater than the second motion threshold, computer system 700 ceases to display left visual elements 730 and right visual elements 732. At FIG. 7C, computer system 700 detects elevated user vitals via a wearable health monitoring device, such as a smart watch and/or a fitness tracking device. In some embodiments, elevated vitals of the user include heart rate and/or respiratory rate that are above normal for the user. At FIG. 7C, a change in the motion (e.g., and/or acceleration) is not detected.

At FIG. 7D, in response to detecting the elevated vitals of the user, computer system 700 changes the location of the sound field to be a greater distance from the user. As illustrated in sound diagram 720 within FIG. 7D, sound field representation 724 is in line with outer distance 728, which is farther away from user representation 722 than sound field representation 724 is in sound diagram 720 at FIG. 7C. Computer system 700 further shifts the location of the sound field because, based on the elevated vitals of the user, the user is still experiencing discomfort from the detected motion. Accordingly, the additional shift of the sound field is an additional motion mitigation technique that computer system 700 performs.

At FIG. 7D, because there is no detected change in the detected motion (e.g., and/or acceleration), computer system 700 continues to display user interface 702, left visual elements 730, right visual elements 732, first object 710a, second object 710b, and third object 710c as computer system 700 previously displayed user interface 702, left visual elements 730, right visual elements 732, first object 710a, second object 710b, and third object 710c at FIG. 7C. At FIG. 7D, a decrease in the speed of the detected motion is detected.

At FIG. 7E, as indicated by motion diagram 714, the speed of the detected motion is ten miles-per-hour in a straightforward direction. At FIG. 7E, a determination is made that the magnitude of the detected motion (e.g., and/or acceleration) is not greater than the first motion threshold and/or the second motion threshold. At FIG. 7E, based on the determination that the magnitude of the detected motion is not greater than the first motion threshold, computer system 700 ceases displaying left visual elements 730 and right visual elements 732. At FIG. 7E, because a determination is made that the magnitude of the detected motion is not greater than the second motion threshold, computer system 700 ceases shifting the display of main body 710 (e.g., first object 710a, second object 710b, and third object 710c). That is, at FIG. 7E, based on the determination that the magnitude of detected motion is not greater than the second motion threshold, computer system 700 moves main body 710 to the right within user interface 702 until main body 710 is displayed at its original position as illustrated in FIG. 7A. At FIG. 7E, as a part of computer system 700 moving main body 710 back to its original position, computer system 700 ceases to display fourth object 710d.

As illustrated in FIG. 7E, sound field representation 724 is centered on user representation 722 within sound diagram 720. At FIG. 7E, because the determination is made that the magnitude of the detected motion is less than the second motion threshold, computer system 700 moves the sound field back to the default sound field location as centered with respect to the user. In some embodiments, based on a determination that there is no detected motion, computer system 700 moves the position of the sound field back to its initial position as centered with respect to the user. At FIG. 7E, an increase in the speed of the motion is detected via one of the methods discussed above.

At FIG. 7F, as indicated in motion diagram 714, the speed of the detected motion is at twenty-seven miles-per-hour in a straightforward direction. At FIG. 7F, a determination is made that the magnitude (e.g., and/or acceleration) of the detected motion is greater than the first motion threshold and a determination is made that the detected motion is in the straightforward path. Because a determination is made that the magnitude of the detected motion is greater than the first motion threshold, computer system 700 displays left visual elements 730 and right visual elements 732. At FIG. 7F, computer system 700, because the determination is made that detected motion is along the straightforward path, computer system 700 displays left visual elements 730 and right visual elements 732 as moving from the top of display 712 towards the bottom of display 712. As explained above, computer system 700 displays left visual elements 730 and right visual elements 732 as moving in a direction that is opposite the direction of the detected motion to alleviate discomfort the user is experiencing as a result of the detected motion. In some embodiments, the speed at which computer system 700 display left visual elements 730 and right visual elements 732 as moving depends on the speed and/or acceleration of the detected motion. In some embodiments, computer system 700 changes one or more characteristics (e.g., size, shape, and/or color) of right visual elements 732 and left visual elements 730 as a part of moving right visual elements 732 and left visual elements 730 from the top of display 712 to the bottom of display 712.

At FIG. 7F, a determination is made that the magnitude (e.g., and/or acceleration) of the detected motion is greater than the second motion threshold. At FIG. 7F, because the determination is made that the magnitude of the detected motion is greater than the second motion threshold and the detected motion is in the straightforward path, computer system 700 shifts the display of main body 710 (e.g., first object 710a, second object 710b, and third object 710c) downward by an amount that correlates to the magnitude of the detected motion.

At FIG. 7F, as indicated by the positioning of sound field representation 724, the sound field is positioned behind the user. At FIG. 7F, because the determination is made that the magnitude (e.g., and/or acceleration) of the detected motion is greater than the second motion threshold and the detected motion is in the straightforward path, computer system 700 shifts the position of the sound field to the rear of the user by an amount that correlates to the magnitude of the detected motion.

As explained above, computer system 700 shifts the display of main body 710 (e.g., first object 710a, second object 710b, third object 710c) and the sound field in a direction that is opposite the direction of the detected motion to alleviate discomfort the user is experiencing as a result of the motion. As illustrated in FIG. 7F, computer system 700 continues to display first object 710a, second object 710b and third object 710c while main body 710 is shifted downwards. As illustrated in FIG. 7F, as a part of computer system 700 shifting main body 710 downward, computer system 700 displays a bottom portion of fifth object 710e below address bar 708 within user interface 702. At FIG. 7F, computer system 700 an increase in the speed of the motion is detected via one or more of the methods discussed above.

At FIG. 7G, as indicated by motion diagram 714, the speed of the detected motion increases to forty miles-per-hour and the motion is in a straightforward direction. At FIG. 7G, a determination is made that the magnitude (e.g., and/or acceleration) of the detected motion increases. Based on the determination that the magnitude of the detected motion increases, computer system 700 further shifts the sound field to the rear of the user and computer system 700 further shifts main body 710 (e.g., first object 710a, second object 710b, third object 710c, and fifth object 710e) in contrast to the positioning of the sound field and main body 710 at FIG. 7F. That is, the amount of shift of the sound field and main body 710 is directly correlated to the magnitude of the detected motion. The greater the magnitude of the detected motion, the greater the amount of the shift of main body 710 and the sound field. In some embodiments, the amount of shift of the sound field and main body 710 is inversely correlated to the magnitude of the detected motion.

As illustrated in FIG. 7G, computer system 700 displays less of first object 710a, second object 710b, and third object 710c, as compared to the amount of first object 710a, second object 710b and third object 710c computer system 700 displays at FIG. 7F (e.g., correlated to the speed of the detected motion of twenty-seven miles-per-hour). At FIG. 7G, computer system 700 displays more of fifth object 710e than computer system 700 displayed at FIG. 7F (e.g., as a result of more of fifth object 710e being shifted below address bar 708).

At FIG. 7G, computer system 700 detects verbal input 705g corresponding to the user requesting that computer system 700 return the sound field to a centered position with respect to the user (e.g., centered with respect to the user), such as “center sound.” At FIG. 7G, a change in the motion is not detected.

At FIG. 7H, as indicated by sound diagram 720, the sound field is centered with respect to the user. At FIG. 7H, in response to detecting verbal input 705g, computer system 700 changes the location of the sound field to be centered with respect to the user. At FIG. 7H, a determination is made that the magnitude of the detected motion is unchanged and in the straightforward direction. As illustrated in FIG. 7H, based on the determination that the magnitude of the detected motion is unchanged, computer system 700 maintains the shift of main body 710 (e.g., first object 710a, second object 710b, third object 710c, and fifth object 710e). In some embodiments, computer system 700 detects a user input corresponding to a request for computer system 700 to return the display of main body 710 back to its original position (e.g., as shown in FIG. 7A). In such embodiments, in response to detecting the user input, computer system 700 ceases shifting main body 710 and computer system 700 returns to displaying main body 710 in its original position as show in FIG. 7A. For example, in response to detecting a verbal input corresponding to a request for computer system 700 to revert the display of main body 710, computer system 700 reverts the display of main body 710.

In some embodiments, while the motion is detected and while computer system 700 is displaying content, computer system 700 is in communication with an external display component such as a car entertainment system, a television in a ship stateroom, a plane seat entertainment system, and/or train seat entertainment system. In some embodiments, depending on the magnitude of the detected motion, computer system 700 causes the external display component to display content (e.g., first object 710a, second object 710b, third object 710c, third object 710d and/or fifth object 710e). For example, if the magnitude of the detected motion is greater than the first and/or second motion threshold, computer system 700 causes the external display component to display the content. In some embodiments, based on a determination that the magnitude of the motion decreases below the first and/or second motion threshold, computer system 700 ceases causing content to be displayed via the external display component. In some embodiments, based on a determination that the magnitude of the motion transitions from being greater than the first motion threshold to being greater than the second motion threshold, computer system 700 transitions from causing content to be displayed via the external display component to displaying content via display 712. In some embodiments, computer system 700 continues to cause content to be displayed via the external display component after a determination is made that the magnitude of the detected motion decreases below the first motion threshold. In some embodiments, in response to detecting a user input, computer system 700 ceases displaying content on the external display component.

In some embodiments, the motion of computer system 700 and/or the vehicle is determined to have a trajectory within a predetermined period of time (e.g., a projected motion) (e.g., 1-360 seconds). In some embodiments, the motion of computer system 700 and/or the vehicle is determined to have the trajectory within the predetermined period of time due to the vehicle being on a fixed path and having a known schedule, such as a train, trolley, and/or subway train. In some embodiments, the motion of computer system 700 and/or the vehicle is determined to have the trajectory within the predetermined period of time based on historical data of the user, such as the daily commute of the user.

In some embodiments, while computer system 700 is displaying user interface 702, a determination is made that the projected motion of the vehicle satisfies a set of one or more criteria (e.g., the projected motion of computer system 700 and/or the vehicle includes a left turn, a right turn, and/or a straight path). In such embodiments, based on the determination that the projected motion of computer system 700 and/or the vehicle satisfies the set of one or more criteria, computer system 700 performs one or more of the various motion mitigation techniques described above (e.g., shifting the display of content, displaying left visual elements 730 and/or right visual elements 732, and/or shifting the position of the sound field).

In some embodiments, while computer system 700 is displaying user interface 702, a determination is made that the projected motion of computer system 700 and/or the vehicle does not satisfy the set of one or more criteria. In such embodiments, in response to a determination is made that the projected motion of computer system 700 and/or the vehicle does not satisfy the set of one or more criteria, computer system 700 does not perform one or more of the various motion mitigation techniques described above.

FIG. 8 is a flow diagram illustrating a method (e.g., method 800) for shifting the display of content in accordance with some embodiments. Some operations in method 800 are, optionally, combined, the orders of some operations are, optionally, changed, and some operations are, optionally, omitted.

As described below, method 800 provides an intuitive way for shifting the display of content. Method 800 reduces the cognitive burden on a user, thereby creating a more efficient human-machine interface. For battery-operated computing devices, enabling a user to interact with such devices faster and more efficiently conserves power and increases the time between battery charges.

In some embodiments, method 800 is performed at a computer system (e.g., 700) (e.g., a watch, a phone, a tablet, a fitness tracking device, a processor, a head-mounted display (HMD) device, a communal device, a media device, a speaker, a television, and/or a personal computing device) that is in communication with (e.g., and/or includes) an input device (e.g., a motion detection device (e.g., gyroscope, force meter, accelerometer, and/or internal or external component able to detect and/or measure motion), a camera (e.g., one or more cameras with different fields of view in relation to the computer system (e.g., front, back, wide, and/or zoom)), a depth sensor, a microphone, a hardware input mechanism, a rotatable input mechanism, a heart monitor, a temperature sensor, and/or a touch-sensitive surface) and a display generation component (e.g., 712) (e.g., a display screen, a projector, and/or a touch-sensitive display).

While displaying (e.g., 802), via the display generation component, content (e.g., 704, 706, 708, 710a, 710b, and/or 710c) (e.g., one or more user interfaces, one or more user interface objects, one or more images, text, and/or one or more characters), the computer system detects (802), via the input device, motion (e.g., represented by 714, 716, and/or 718) (e.g., motion of the computer system, motion of a user, and/or motion of an external structure) (e.g., relative or absolute motion (e.g., motion of the input device relative to the computer system, motion of the input device relative to a physical environment, or absolute motion detected by the input device)) that satisfies a first set of one or more criteria (e.g., as discussed at FIGS. 7B-7D) (e.g., 714, 716, and/or 718 at FIGS. 7B-7D). In some embodiments, the first set of one or more criteria includes a criterion that is satisfied based on: force against and/or exerted on the input device and/or the computer system, movement of the computer system relative to an object and/or surface (e.g., change as measured from a particular point) or absolute movement of the computer system within an environment (e.g., absolute measurement of displacement of the computer system), direction (e.g., movement in a direction, and/or change in direction), and/or acceleration detected by the input device. In some embodiments, detecting the motion includes detecting relative motion (e.g., difference in motion as compared to another object, plane, and/or point) (e.g., motion of the computer system relative to a position (e.g., object, position within 3D space, and/or plane within an environment), relative to a direction (e.g., in a direction, from a direction, and/or change of direction), and/or relative to previous motion), and/or absolute motion (e.g., motion of the computer system irrespective of external factors and/or motion of the computer system without comparison to an object, position, and/or plane).

In response to (804) detecting the motion that satisfies the first set of one or more criteria, the computer system continues (806) display of a first portion of the content (e.g., remaining portion of 710a, 710b, and/or 710c at FIGS. 7C-7D) (e.g., a subsection of the content, a majority of the content, a minority of the content, less than the entirety of the content, and/or a key portion of the content). In some embodiments, continuing display of, via the display generation component, the first portion of the content includes moving, resizing, and/or altering a visual characteristic of the first portion of the content (e.g., opacity, outline, font, boldness, and/or brightness). In some embodiments, the first portion of the content is a subsection of the content based on relevance (e.g., relevance of the subsection of the content as compared to other portions of the content and/or relevance to current context of the environment (e.g., location, weather, time of day, and/or situation (e.g., the situation that caused the movement))), position (e.g., relative position as compared to the user interface and/or the other portions of the content), size, prominence, and/or type (e.g., text, image, and/or user interface element).

In response to (804) detecting the motion that satisfies the first set of one or more criteria, the computer system ceases (808) display of a second portion (e.g., change of 710a, 710b, and/or 710c from FIGS. 7A-7B to FIGS. 7C-7D), different from the first portion, of the content (e.g., a subsection of the content, a majority of the content, a minority of the content, less than the entirety of the content, and/or a key portion of the content). In some embodiments, ceasing display of the second portion of the content includes moving, resizing, and/or altering a visual characteristic (e.g., opacity, outline, font, boldness, and/or brightness) of the second portion of the content. In some embodiments, ceasing display of the second portion of the content includes altering the second portion of the content until the second portion of the content is no longer displayed. In some embodiments, the second portion of the content is a subsection of the content based on relevance (e.g., relevance of the subsection of the content as compared to other portions of the content and/or relevance to current context of the environment (e.g., location, weather, time of day, and/or situation (e.g., the situation that caused the movement))), position (e.g., relative position as compared to the user interface and/or the other portions of the content), size, prominence, and/or type (e.g., text, image, and/or user interface element). In some embodiments, in response to detecting motion that satisfies a second set of one or more criteria different from the first set of one or more criteria, the computer system continues display of the first portion and the second portion of the content.

While displaying the first portion of the content and not displaying the second portion of the content, the computer system detects (810), via the input device, motion that no longer satisfies the first set of one or more criteria (e.g., as discussed at FIG. 7E) (e.g., represented by 714, 716, and/or 718 at FIG. 7E) (e.g., and/or any motion that satisfies the first set of one or more criteria) (and/or motion that satisfies the second set of one or more criteria).

In response to (812) detecting the motion that no longer satisfies the first set of one or more criteria, the computer system continues (814) display of the first portion of the content. In some embodiments, continuing display of the first portion of the content includes moving, resizing, and/or altering a visual characteristic (e.g., opacity, outline, font, boldness, and/or brightness) of the first portion of the content.

In response to (812) detecting the motion that no longer satisfies the first set of one or more criteria, the computer system displays (816) (and/or redisplays), via the display generation component, the second portion of the content (e.g., change of 710a, 710b, and/or 710c from FIGS. 7C-7D to FIG. 7E). In some embodiments, displaying the second portion of the content includes altering a visual characteristic (e.g., bolding, brightness, clarity, position, resizing, and/or emphasizing) of the second portion of the content until the second portion of the content is fully displayed. In some embodiments, displaying the second portion of the content includes repositioning and/or altering the first portion of the content and/or the second portion of the content to accommodate displaying both portions (e.g., returning to originally displayed size, displaying at a size that allows for the first portion of the content and the second portion of the content to be displayed simultaneously, and/or displaying the first portion of the content and the second portion of the content with consistent visual characteristics). Selectively displaying one or more portions of content based on motion satisfying a first criteria allows the computer system to (1) stop displaying a portion of the content without requiring input from a user directed to the portion and (2) emphasize a remaining portion of the content without requiring user selection of the remaining portion, thereby performing an operation when a set of conditions has been met without requiring additional input.

In some embodiments, the motion that satisfies the first set of one or more criteria (e.g., represented by 714, 716, and/or 718) is a first motion (e.g., 714, 716, 718 at FIG. 7F). In some embodiments, the computer system detects (e.g., before or after detecting the first motion), via the input device, second motion (e.g., 714, 716, 718 at FIG. 7G), different from the first motion (e.g., different in direction, intensity, acceleration, and/or duration), (e.g., motion of the computer system, motion of a user, and/or motion of an external structure) (e.g., relative or absolute motion (e.g., motion of the input device relative to the computer system, motion of the input device relative to a physical environment, or absolute motion detected by the input device)) that satisfies a second set of one or more criteria (e.g., as discussed at FIG. 7G) (e.g., and does not satisfy the first set of one or more criteria). In some embodiments, the second set of one or more criteria includes a criterion that is satisfied based on: an amount of force against and/or exerted on the input device, user, and/or the computer system, movement of the computer system and/or user relative to an object and/or surface (e.g., change as measured from a particular point) or absolute movement of the computer system and/or user within an environment (e.g., absolute measurement of displacement of the computer system), direction (e.g., movement in a direction, and/or change in direction), and/or acceleration detected by the input device. In some embodiments, the second motion is greater than the first motion. In some embodiments, the second set of one or more criteria is different from the first set of one or more criteria. In some embodiments, the second set of one or more criteria and the first set of one or more criteria include one or more similar criterions. In some embodiments, the second set of one or more criteria is a subset of criteria of the first set of one or more criteria. In some embodiments, the first set of one or more criteria is a subset of criteria of the second set of one or more criteria. In some embodiments, the second set of one or more criteria and the first set of one or more criteria include a majority of the same criterions. In some embodiments, the second set of one or more criteria and the first set of one or more criteria have at least one different criterion. In some embodiments, in response to detecting the second motion that satisfies the second set of one or more criteria, the computer system ceases display of a third portion of the content (e.g., 710a, 710b, and/or 710c at FIG. 7G) different from the second portion of the content (e.g., 710a, 710b, and/or 710c at FIGS. 7C-7D) (e.g., while maintaining display of the first portion of the content and/or the second portion of the content). In some embodiments, the third portion of the content includes a portion of the second portion of the content. In some embodiments, the third portion of the content is a subsection of the first portion of the content and/or the second portion of the content. In some embodiments, the third portion of the content is different from the first portion of the content. In some embodiments, after and/or while ceasing display of the third portion of the content, the computer system alters the first portion of the content (e.g., the computer system maximizes the display of the first portion of the content to occupy the space of the third portion, the computer system repositions the first portion of the content (e.g., overlapping and/or taking up the space occupied by the third portion of the content), and/or the computer system increases the amount of content included in the first portion of the content). Selectively displaying another portion of the content based on motion that satisfies another set of one or more criteria allows the computer system to automatically display certain portions of content based on motion satisfying one or more of the sets of criteria without a user selecting the certain portions, thereby performing an operation when a set of conditions has been met without requiring additional input.

In some embodiments, the first motion (e.g., 714, 716, 718 at FIG. 7F) is in a first direction (e.g., 718 at FIGS. 7B-7D). In some embodiments, the second motion (e.g., 714, 716, 718 at FIG. 7G) is in a second direction (e.g., 718 at FIGS. 7E-7F) (e.g., and not the first direction) different from the first direction. In some embodiments, the first set of one or more criteria includes a criterion that is satisfied when the first motion is in a first direction, and the second set of one or more criteria includes a criterion that is satisfied when the second motion is in a second direction, different from the first direction. In some embodiments, the computer system determines direction of the first motion and/or the second motion based on a sensor reading at a particular time, a continuous sensor reading, and/or comparing a series of sensor readings. In some embodiments, the first direction and the second direction are vectors beginning and/or not-beginning at the same location. In some embodiments, the first direction and/or the second direction correspond to an initial direction (e.g., cardinal directions and/or angular direction), change in direction, and/or continued motion in a direction. Selectively displaying portions of content based on motion in a respective direction allows the computer system to automatically adjust content to be displayed based on the direction of the motion without detecting user input, thereby performing an operation when a set of conditions has been met without requiring additional input.

In some embodiments, the first motion is absolute motion (e.g., as discussed at FIGS. 7A-7H). In some embodiments, the second motion is relative motion (e.g., as discussed at FIGS. 7A-7H). In some embodiments, relative motion includes a difference in motion as compared to another object, plane, and/or point, motion of the computer system and/or user relative to a position (e.g., object, position within 3D space, and/or plane within an environment), motion of an object associated with the computer system (e.g., a user's hand, head, and/or body and/or an input device (e.g., a keyboard and/or a mouse)) and another object, plane, and/or position, and/or relative to a direction (e.g., in a direction, from a direction, and/or change of direction, and/or relative to previous motion). In some embodiments, absolute motion is motion of the computer system and/or user irrespective of external factors and/or motion of the computer system and/or user without comparison to an object, position, and/or plane. In some embodiments, absolute motion is motion of the user irrespective of external factors and/or motion of the computer system without comparison to an object, position, and/or plane. Selectively displaying portions of content based on a type of motion allows the computer system to tailor content based on the type of motion without requiring a user to specify the type of motion, thereby performing an operation when a set of conditions has been met without requiring additional input.

In some embodiments, the first motion is relative motion (e.g., as discussed at FIGS. 7A-7H). In some embodiments, the second motion is absolute motion (e.g., as discussed at FIGS. 7A-7H). In some embodiments, relative motion includes the difference in motion as compared to another object, plane, and/or point, motion of the computer system and/or user relative to a position (e.g., object, position within 3D space, and/or plane within an environment), motion of an object associated with the computer system (e.g., a user's hand, head, and/or body and/or an input device (e.g., a keyboard and/or a mouse)) and another object, plane, and/or position, and/or relative to a direction (e.g., in a direction, from a direction, and/or change of direction, and/or relative to previous motion). In some embodiments, absolute motion is motion of the computer system and/or user irrespective of external factors and/or motion of the computer system without comparison to an object, position, and/or plane. In some embodiments, absolute motion is motion of the user irrespective of external factors and/or motion of the computer system without comparison to an object, position, and/or plane. Selectively displaying portions of content based on a type of motion allows the computer system to tailor content based on the type of motion without requiring a user to specify the type of motion, thereby performing an operation when a set of conditions has been met without requiring additional input.

In some embodiments, the motion that satisfies the first set of one or more criteria (e.g., represented by 714, 716, and/or 718) is a first motion (e.g., 714, 716, 718 at FIG. 7F). In some embodiments, the computer system detects (e.g., before or after the first motion is detected), via the input device, third motion first motion (e.g., 714, 716, 718 at FIG. 7E), different from the first motion (e.g., different in direction, intensity, acceleration, and/or duration), (e.g., motion of the computer system, motion of a user, and/or motion of an external structure) (e.g., relative or absolute motion (e.g., motion of the input device relative to the computer system and/or user, motion of the input device relative to a physical environment, or absolute motion detected by the input device)) that satisfies a third set of one or more criteria (e.g., as discussed at FIG. 7E). In some embodiments, the third set of one or more criteria includes a criterion that is satisfied based on: force against and/or exerted on the input device, a user, and/or the computer system, movement of the computer system relative to an object and/or surface (e.g., change as measured from a particular point) or absolute movement of the computer system within an environment (e.g., absolute measurement of displacement of the computer system), direction (e.g., movement in a direction, and/or change in direction), and/or acceleration detected by the input device. In some embodiments, the third set of one or more criteria is different from the first set of one or more criteria. In some embodiments, the third set of one or more criteria and the first set of one or more criteria includes one or more similar criterions. In some embodiments, the third set of one or more criteria is a subset of criteria of the first set of one or more criteria. In some embodiments, the first set of one or more criteria is a subset of criteria of the third set of one or more criteria. In some embodiments, the third set of one or more criteria and the first set of one or more criteria include a majority of the same criterions. In some embodiments, the third set of one or more criteria and the first set of one or more criteria have at least one different criterion. In some embodiments, in response to detecting the third motion that satisfies the third set of one or more criteria, the computer system continues display of, via the display generation component (e.g., 712), the first portion of the content (e.g., 710a, 710b, and/or 710c). In some embodiments, in response to detecting the third motion that satisfies the third set of one or more criteria, the computer system continues display of, via the display generation component, the second portion of the content (e.g., 710a, 710b, and/or 710c). In some embodiments, the computer system alters one or more visual characteristics (e.g., repositioning, blurring, magnifying, shrinking, and/or changing one or more colors) of the first portion of the content and/or the second portion of the content as a part of continuing display of the first portion of the content and/or the second portion of the content. Maintaining display of all portions of the content based on motion satisfying another set of one or more criteria allows the computer system to selectively display the portions of the content based on motion, thereby performing an operation when a set of conditions has been met without requiring additional input.

In some embodiments, the computer system (e.g., 700) is in communication with an audio output device (e.g., as discussed at FIGS. 7A-7H) (e.g., speaker, smart speaker, home theater system, soundbar, headphone, earphone, earbud, television speaker, augmented reality headset speaker, audio jack, optical audio output, Bluetooth audio output, and/or HDMI audio output). In some embodiments, the audio output device includes (e.g., contains, and/or has) the input device (e.g., as discussed at FIGS. 7A-7H) (e.g., a motion detection device (e.g., gyroscope, force meter, accelerometer, and/or internal or external component able to detect and/or measure motion)). In some embodiments, the input device is the audio output device. In some embodiments, the audio output device includes one or more input components (and/or motion detecting components) along with audio components. In some embodiments, the input device is a sensor embedded in the audio output device. Detecting motion through an input device within an audio output device allows (1) the computer system another method of detecting motion without including additional components and/or (2) allows the computer system to selectively use different capabilities of connected components without user selection of the component, thereby performing an operation when a set of conditions has been met without requiring additional input.

In some embodiments, the input device is a set of one or more cameras (e.g., as discussed at FIGS. 7A-7H). In some embodiments, the computer system uses the camera along with one or more other input devices to detect the motion. In some embodiments, detecting motion via the set of one or more cameras includes detecting motion is the field of view of the set of one or more cameras. In some embodiments, detecting motion via the set of one or more cameras includes detecting a difference in position over time of the computer system and/or the user. Detecting motion through a set of one or more cameras allows the computer system to react to inputs and/or events detected through the field of view of one or more of the cameras without requiring a user to select the cameras, thereby performing an operation when a set of conditions has been met without requiring additional input.

In some embodiments, the input device is an inertia measurement unit (e.g., as discussed at FIGS. 7A-7H) (e.g., IMU sensor) (and/or motion sensor, device, and/or component) of (e.g., belonging to and/or embedded within) the computer system (e.g., 700). In some embodiments, an inertial measurement unit (IMU) is an input device that detects force against and/or exerted on, angular rate of, and orientation of the computer system (and/or relative to an object, plane, and/or position), a user, and/or a computer system that is in communication with the computer system. In some embodiments, the inertial measurement unit contains and/or is used in combination with one or more accelerometers, gyroscopes, and magnetometers. Detecting motion through an inertia measurement unit allows (1) the computer system to measure and/or react to motion through internal readings and/or (2) the computer system a modality to detect motion that is irrespective of a user, thereby performing an operation when a set of conditions has been met without requiring additional input.

In some embodiments, the motion that satisfies the first set of one or more criteria (e.g., represented by 714, 716, and/or 718 at FIGS. 7C-7D) (and/or the motion that no longer satisfies the first set of one or more criteria) corresponds to motion of the computer system (e.g., 700). In some embodiments, motion of the computer system includes relative motion (e.g., difference in motion as compared to another object, plane, and/or point) (e.g., motion of the computer system relative to a position (e.g., object, position within 3D space, and/or plane within an environment), motion of an object associated with the computer system (e.g., a user's hand, head, and/or body and/or an input device (e.g., a keyboard and/or a mouse)) and another object, plan, and/or position, relative to a direction (e.g., in a direction, from a direction, and/or change of direction), and/or relative to previous motion), and/or absolute motion (e.g., motion of the computer system irrespective of external factors and/or motion of the computer system without comparison to an object, position, and/or plane). Selectively displaying portions of content based on motion of the computer system allows the computer system to automatically react to the motion by displaying content compatible with the motion of the computer system without requiring a user selection of the portion of the content, thereby performing an operation when a set of conditions has been met without requiring additional input.

In some embodiments, the motion that satisfies the first set of one or more criteria (e.g., represented by 714, 716, and/or 718) (and/or the motion that no longer satisfies the first set of one or more criteria) corresponds to motion of a body portion (e.g., head, arm, torso, leg, and/or hand) of a user (e.g., as discussed at FIGS. 7A-7H) (e.g., a primary user, a non-primary user, a user that is registered with the computer system, and/or a user that is not registered with the computer system). In some embodiments, the motion of the body portion of the user includes relative motion between the body portion of the user and the computer system (e.g., movement of the input device from and/or towards the body portion of the user, repositioning of the device on the body portion of the user), relative motion between the body portion of the user and another object, position, and/or body party (e.g., measuring displacement from, angle in relation to, and/or difference in acceleration), and/or absolute motion of the body portion of the user (e.g., change in position and/or angle as measured based on the body portion of the user). Selectively displaying portions of content based on motion of a body portion of a user allows the computer system to automatically react to the motion by displaying content compatible with the motion of the portion of the user's body without requiring a user selection of the portion of the content, thereby performing an operation when a set of conditions has been met without requiring additional input.

In some embodiments, the motion that satisfies the first set of one or more criteria (e.g., represented by 714, 716, and/or 718) is first motion (e.g., 714, 716, 718 at FIG. 7C) (e.g., motion of the computer system, motion of a user, and/or motion of an external structure) (e.g., relative or absolute motion (e.g., motion of the input device relative to the computer system, motion of the input device relative to a physical environment, or absolute motion detected by the input device)). In some embodiments, in response to detecting the first motion and in accordance with a determination that the first motion satisfies a second set of one or more criteria (e.g., as discussed at FIGS. 7A-7H) different from the first set of criteria, the computer system displays, via the display generation component (e.g., 712), an indication (and/or one or more indications) (e.g., a graphical user interface element, such as on top of other content being displayed via the display generation component) corresponding to (e.g., based on, related to, proportional to, and/or inversely proportional to) the first motion (e.g., 730 and/or 732 at FIGS. 7B-7D). In some embodiments, the second set of one or more criteria includes a criterion that is satisfied based on: force against and/or exerted on the input device and/or the computer system, movement of the computer system relative to an object and/or surface (e.g., change as measured from a particular point) or absolute movement of the computer system within an environment (e.g., absolute measurement of displacement of the computer system), direction (e.g., movement in a direction, and/or change in direction), and/or acceleration detected by the input device. In some embodiments, the second set of one or more criteria and the first set of one or more criteria have at least one different criterion. In some embodiments, the first set of one or more criteria is a subsection of the second set of one or more criteria. In some embodiments, the first motion satisfies the second set of one or more criteria and the first set of one or more criteria. In some embodiments, the computer system displays the indication corresponding to the first motion while the computer system ceases display of the second portion. In some embodiments, in response to detecting the motion that no longer satisfies the first set of one or more criteria and in accordance with a determination that the motion (e.g., the motion that no longer satisfies the first set of one or more criteria) satisfies the second set of one or more criteria, the computer system displays, via the display generation component, the indication corresponding to the motion (e.g., the motion that no longer satisfies the first set of one or more criteria). In some embodiments, the indication corresponding to the motion includes one or more user interface elements that depict the motion. In some embodiments, the indication corresponding to the motion includes one or more user interface elements that are reactive to the motion. In some embodiments, the indication corresponding to the motion includes one or more user interface elements that counteract and/or contradict the motion (e.g., displaying content and/or altering the one or more user interface elements to lesson a user's sensation of motion and/or feeling of motion). Selectively displaying an indication of the motion along with portions of content allows the computer system to automatically display the indication based on motion satisfying a set of one or more criteria without user specifying the display of the indication, thereby performing an operation when a set of conditions has been met without requiring additional input.

In some embodiments, the first set of one or more criteria includes a criterion that is satisfied when the first motion (e.g., a magnitude (e.g., average magnitude, maximum magnitude, minimum magnitude, and/or media magnitude) of the first motion) is greater than a threshold (e.g., represented by 714, 716, and/or 718 at FIGS. 7G-7H) (and/or a predefined threshold and/or value) (e.g., an instance of motion is over the threshold, continuous motion is over the threshold, and/or change in motion crosses the threshold and remains above and/or falls under the threshold), the motion that satisfies the second set of one or more criteria is second motion. In some embodiments, the second set of one or more criteria includes a criterion that is satisfied when the second motion (e.g., a magnitude of the second motion) is less than the threshold (e.g., represented by 714, 716, and/or 718 at FIGS. 7E and/or 7F). In some embodiments, the second set of one or more attributes of the first motion is the same or different than the first set of one or more attributes of the first motion. In some embodiments, the indication corresponding to the first motion is displayed with varying visual characteristics (e.g., size, position, clarity, colors, and/or emphasis) based on the threshold. Selectively displaying portions of content based on motion satisfying threshold value allows the computer system to automatically alter the content display upon meeting and/or exceeding the threshold without requiring user input and/or user defining the threshold, thereby performing an operation when a set of conditions has been met without requiring additional input.

In some embodiments, in response to detecting the motion (e.g., represented by 714, 716, and/or 718) that satisfied the second set of one or more criteria (e.g., as discussed at FIGS. 7A-7H), the computer system continues display of the first portion (e.g., 710a, 710b, and/or 710c). In some embodiments, in response to detecting the motion that satisfied the second set of one or more criteria, the computer system continues display of the second portion (e.g., 710a, 710b, and/or 710c). In some embodiments, the computer system alters one or more visual characteristics (e.g., repositioning, blurring, magnifying, shrinking, and/or changing one or more colors of the first portion content and/or of the second portion of content) as a part of continuing display of the first portion of the content and/or the second portion. In some embodiments, the computer system alters the first portion of the content and/or the second portion of the content to compensate for and/or make room for the indication corresponding to the motion that satisfies the second set of one or more criteria as a part of continuing display of the first portion of the content and/or the second portion of the content. Maintaining display of all portions of the content based on motion satisfying a set of one or more criteria allows the computer system to selectively display the portions of the content based on motion, thereby performing an operation when a set of conditions has been met without requiring additional input.

In some embodiments, in response to detecting the motion that satisfies the first set of one or more criteria (e.g., represented by 714, 716, and/or 718), the computer system displays, via the display generation component (e.g., 712), an indication (e.g., 730 and/or 732) (and/or one or more indications) corresponding to (e.g., based on, related to, proportional to, and/or inversely proportional to) the motion that satisfies the first set of one or more criteria (e.g., as discussed at FIGS. 7A-7H). In some embodiments, the computer system displays the indication corresponding to the motion that satisfies the first set of one or more criteria with varying visual characteristics (e.g., size, position, clarity, colors, and/or emphasis) based on the motion. In some embodiments, while the computer system displays the indication, the computer system displays the first portion of the content and/or the second portion of the content with one or more visual alterations (e.g., repositioning, blurring, magnifying, shrinking, and/or changing one or more colors). In some embodiments, while the computer system displays the indication, the computer system alters the first portion of the content and/or the second portion of the content to compensate for and/or make room for the indication corresponding to the motion that satisfies the fourth criteria. Selectively displaying an indication of the motion along with portions of content allows the computer system to automatically display the indication based on motion satisfying a set of one or more criteria without user specifying the display of the indication, thereby performing an operation when a set of conditions has been met without requiring additional input.

Note that details of the processes described above with respect to method 800 (e.g., FIG. 8) are also applicable in an analogous manner to other methods described herein. For example, method 1300 optionally includes one or more of the characteristics of the various methods described above with reference to method 800. For example, the display of content can be shifted using one or more techniques described herein in relation to method 800, where the content is shifted based on a state of a user described herein in relation to method 1300. For brevity, these details are not repeated herein.

FIG. 9 is a flow diagram illustrating a method (e.g., method 900) for shifting the output of a sound field in accordance with some embodiments. Some operations in method 900 are, optionally, combined, the orders of some operations are, optionally, changed, and some operations are, optionally, omitted.

As described below, method 900 provides an intuitive way for shifting the output of a sound field. Method 900 reduces the cognitive burden on a user, thereby creating a more efficient human-machine interface. For battery-operated computing devices, enabling a user to interact with such devices faster and more efficiently conserves power and increases the time between battery charges.

In some embodiments, method 900 is performed at a computer system (e.g., 700) (e.g., a watch, a phone, a tablet, a fitness tracking device, a processor, a head-mounted display (HMD) device, a communal device, a media device, a speaker, a television, and/or a personal computing device) that is in communication with (e.g., and/or includes) an input device (e.g., a motion detection device (e.g., gyroscope, force meter, accelerometer, and/or internal or external component able to detect and/or measure motion), a camera (e.g., one or more cameras with different fields of view in relation to the computer system (e.g., front, back, wide, and/or zoom)), a depth sensor, a microphone, a hardware input mechanism, a rotatable input mechanism, a heart monitor, a temperature sensor, and/or a touch-sensitive surface), a display generation component (e.g., 712) (e.g., a display screen, a projector, and/or a touch-sensitive display), and an audio generation component (e.g., represented by 724) (e.g., a speaker, smart speaker, home theater system, soundbar, headphone, earphone, earbud, speaker, television speaker, augmented reality headset speaker, audio jack, optical audio output, Bluetooth audio output, and/or HDMI audio output).

While displaying, via the display generation component, content (e.g., 704, 706, 708, 710a, 710b, and/or 710c), the computer system detects (902), via the input device, motion (e.g., represented by 714, 716, and/or 718) (e.g., motion of the computer system, motion of a user, and/or motion of an external structure) (e.g., relative or absolute motion (e.g., motion of the input device relative to the computer system, motion of the input device relative to a physical environment, or absolute motion detected by the input device)). In some embodiments, the content includes a user interface, one or more user interface objects, one or more images, text, and/or one or more characters. In some embodiments, detecting the motion includes detecting: force against and/or exerted on the input device, movement of the computer system relative to an object and/or surface (e.g., change as measured from a particular point) or absolute movement of the computer system within the environment (e.g., absolute measurement of displacement of the computer system), direction (e.g., movement in a direction, and/or change in direction), and/or acceleration detected by the input device. In some embodiments, detecting the motion includes detecting relative motion (e.g., difference in motion as compared to another object, plane, and/or point) (e.g., motion of the computer system relative to a position (e.g., object, position within 3D space, and/or plane within an environment), relative to a direction (e.g., in a direction, from a direction, and/or change of direction), and/or relative to previous motion), and/or absolute motion (e.g., motion of the computer system irrespective of external factors and/or motion of the computer system without comparison to an object, position, and/or plane).

In response to (904) detecting the motion, in accordance with a determination that a first set of one or more criteria is satisfied, wherein the first set of one or more criteria includes a criterion that is satisfied when the motion is a first amount of motion (e.g., 714, 716, and/or 718 at FIG. 7F), the computer system alters (906), via the audio generation component, an audio characteristic of a sound field corresponding to the content by a first amount (e.g., represented by 724 at FIG. 7F). In some embodiments, the first amount of motion is a threshold value including intensity of motion, direction of motion, length of motion, and/or change of motion (e.g., change of intensity and/or direction). In some embodiments, the first amount of motion corresponds to relative or absolute motion (e.g., motion of the input device relative to the computer system, motion of the input device relative to a physical environment, or absolute motion detected by the input device). In some embodiments, the first amount of motion corresponds to a particular period of time (e.g., an amount of motion for a threshold amount of time, change of motion of a period of time, and/or one or more periods of time with varying amounts of motion) and/or a continuous reading by the computer system (e.g., instances of motion, instances of motion as compared to prior instances of motion, and/or a running comparison of motion over time (e.g., as related to an average, median, and/or max or minimum value)). In some embodiments, an audio characteristic includes an audio intensity level, an audio output direction, an audio wave pattern (e.g., amplitude, frequency, and/or wavelength of perceivable and/or non-perceivable sound waves), and/or a desired audio locationality (e.g., desired perceived location of audio object in reference to a user, an environment, and/or the device). In some embodiments, altering the audio characteristic of the sound field corresponding to the content by the first amount includes altering an audio intensity value, changing an audio output direction, altering an amplitude, frequency, and/or wavelength of an audio wave, and/or altering an audio locationality. In some embodiments, altering the audio characteristic of the sound field corresponding to the content by the first amount includes moving the sound field by the first amount. In some embodiments, altering the audio characteristic of the sound field corresponding to the content by the first amount indicates a direction of travel (e.g., by altering the audio characteristic of the sound field by the first amount in the direction of travel or in an opposite direction to the direction of travel). In some embodiments, the audio characteristic of the sound field is altered in the direction of travel (e.g., by altering the audio characteristic of the sound field by the first amount in the direction of travel). In some embodiments, the audio characteristic of the sound field is altered in the direction of travel (e.g., by altering the audio characteristic of the sound field by the first amount in an opposite direction to the direction of travel).

In response to (904) detecting the motion, in accordance with a determination that a second set of one or more criteria, different from the first set of one or more criteria, is satisfied, wherein the second set of one or more criteria includes a criterion that is satisfied when the motion is a second amount of motion (e.g., 714, 716, and/or 718 at FIG. 7G) different from the first amount of motion, the computer system alters (908), via the audio generation component, the audio characteristic of the sound field corresponding to the content by a second amount (e.g., represented by FIG. 7G) different from the first amount. In some embodiments, the second amount of motion is a threshold value including intensity of motion, direction of motion, length of motion, and/or change of motion (e.g., change of intensity and/or direction). In some embodiments, the first amount of motion corresponds to relative or absolute motion (e.g., motion of the input device relative to the computer system, motion of the input device relative to a physical environment, or absolute motion detected by the input device). In some embodiments, the second amount of motion corresponds to a particular period of time (e.g., an amount of motion for a threshold amount of time, change of motion of a period of time, and/or one or more periods of time with varying amounts of motion) and/or a continuous reading by the computer system (e.g., instances of motion, instances of motion as compared to prior instances of motion, and/or a running comparison of motion over time (e.g., as related to an average, median, and/or max or minimum value)). In some embodiments, altering the audio characteristic of the sound field corresponding to the content by the second amount includes altering an audio intensity value, changing an audio output direction, altering an amplitude, frequency, and/or wavelength of an audio wave, and/or altering an audio locationality. In some embodiments, altering the audio characteristic of the sound field corresponding to the content by the second amount includes moving the sound field by the second amount. In some embodiments, altering the audio characteristic of the sound field corresponding to the content by the second amount indicates a direction of travel (e.g., by altering the audio characteristic of the sound field by the second amount in the direction of travel or in an opposite direction to the direction of travel). In some embodiments, the audio characteristic of the sound field is altered in the direction of travel (e.g., by altering the audio characteristic of the sound field by the second amount in the direction of travel). In some embodiments, the audio characteristic of the sound field is altered in the direction of travel (e.g., by altering the audio characteristic of the sound field by the second amount in an opposite direction to the direction of travel). Altering the audio characteristic of the sound field by a particular amount when a set of prescribed conditions is met (e.g., the amount of motion is the first amount of motion or the second amount of motion) automatically allows the computer system to tailor the adjustment of the audio characteristic to the detected motion, thereby performing an operation when a set of conditions has been met without requiring further user input.

In some embodiments, the audio generation component is a set of one or more external playback devices (e.g., as discussed at FIGS. 7A-7H) (e.g., headphones and/or speakers). In some embodiments, the computer system causes (e.g., before and/or while detecting the motion), via the set of one or more external playback devices, the output (e.g., produce, create, and/or generate) of the sound field (e.g., represented by 726 and/or 728 at FIGS. 7A-7H). In some embodiments, the computer system causes the set of one or more external playback devices to output the sound field in response to detecting an input. In some embodiments, the computer system causes the set of one or more external playback devices to output the sound field based on a determination that one or more conditions are satisfied. In some embodiments, altering the audio characteristic of the sound field corresponding to the content by the first amount includes changing, via the set of one or more external playback devices, the audio characteristic of the sound field corresponding to the content by the first amount. In some embodiments, altering the audio characteristic of the sound field corresponding to the content by the second amount includes changing, via the set of one or more external playback devices, the audio characteristic of the sound field corresponding to the content by the second amount.

In some embodiments, the motion is of an external structure (e.g., as discussed at FIGS. 7A-7H) (e.g., automobile, train, boat, and/or airplane) (e.g., external to the computer system). In some embodiments, the external structure is moving in a translational manner and/or a rotational manner. Selectively altering the audio characteristic of the sound field when a set of prescribed conditions of an external structure is met (e.g., the motion of the external structure is the first amount of motion or the second amount of motion) automatically allows the computer system to provide an indication of an absolute motion and/or relative motion of the external structure, thereby performing an operation when a set of conditions has been met without requiring further user input.

In some embodiments, the motion is of a body part (e.g., the head, torso, legs, hands, and/or arms) of a user (e.g., as discussed at FIGS. 7A-7H) (e.g., a user of the computer system, a non-user of the computer system, a primary user, and/or a non-primary user). In some embodiments, the user is registered with the computer system. In some embodiments, the user is not registered with the computer system. Selectively altering the audio characteristic of the sound field when a set of prescribed conditions of the user is met (e.g., the motion of the user is the first amount or the motion of the user is the second amount) automatically allows the computer system to provide an indication of an absolute motion and/or relative motion of the user, thereby performing an operation when a set of conditions has been met without requiring further user input.

In some embodiments, the computer system outputs (e.g., before and/or while detecting the motion), via the audio generation component, the sound field (e.g., represented by 726 and/or 728 at FIGS. 7A-7H). In some embodiments, the computer system outputs the sound field in response to detecting an input. In some embodiments, the computer outputs the sound field in response to detecting that a one or more conditions are met (e.g., environmental conditions, a state of the computer system and/or a state of a user).

In some embodiments, altering the audio characteristic of the sound field (e.g., represented by 726 and/or 728 at FIGS. 7A-7H) includes directing (e.g., moving and/or redirecting), via the audio generation component, the sound field away from an initial position of the sound field (e.g., change of 724 from FIG. 7E to 7F) (e.g., a default position of the sound field, a position of the sound field before the motion is detected, and/or a position that is based on a user). In some embodiments, while directing the sound field away from the initial position of the sound field, the computer system ceases to detect, via the input device, the motion (e.g., and/or any motion). In some embodiments, in response to ceasing to detect the motion, the computer system directs, via the audio generation component, the sound field at the initial position of the sound field (e.g., 724 at FIG. 7E). In some embodiments, before (e.g., and/or while) detecting the motion, the computer system directs, via the audio generation component, the sound field towards the initial position. In some embodiments, the computer system ceases to direct, via the audio generation component, output of the sound field in a particular direction (e.g., towards the initial position of the sound field or away from the initial position of the sound field) in response to ceasing to detect the motion. In some embodiments, the computer system outputs, via the audio generation component, the sound field in response to detecting initiation of the motion. Directing the sound field at the initial position of the sound field in response to ceasing to detect the motion allows the computer system to cease the performance of a motion mitigation techniques at a point in time when the motion mitigation technique is no longer necessary, thereby providing improved feedback and/or providing additional control options without cluttering the user interface with additional displayed controls.

In some embodiments, altering the audio characteristic of the sound field (e.g., represented by 726 and/or 728 at FIGS. 7A-7H) includes directing (e.g., moving and/or redirecting), via the audio generation component, the sound field away from an initial position (e.g., a default position of the sound field, a position of the sound field before the motion is detected, and/or a position that is based on a user) of the sound field (e.g., represented by 724 at FIG. 7F). In some embodiments, while directing the sound field away from the first position, the computer system detects that a magnitude (e.g., average magnitude, media magnitude, and/or absolute magnitude) of one or more attributes (e.g., characteristics, features, elements, and/or traits) (e.g. speed, acceleration, deacceleration, turning force, and/or braking force) of the motion (e.g., and/or any motion) is less than a threshold (e.g., as discussed at FIG. 7E) (e.g., a user defined threshold, a computer defined threshold, a user specific threshold, and/or a motion specific threshold). In some embodiments, in response to detecting that the magnitude of the one or more attributes of the motion is less than the threshold, the computer system directs (e.g., moving and/or redirecting), via the audio generation component, the sound field towards the initial position of the sound field (e.g., represented by 724 at FIG. 7E). In some embodiments, before (e.g., and/or while) detecting the motion, the computer system detects, via the audio generation component, the sound field towards the initial position. In some embodiments, the magnitude is an absolute value of the motion. Directing the sound field at the initial position of the sound field in response to detecting that the magnitude of one or more attributes of the motion is less than the threshold allows the computer system to cease the performance of a motion mitigation techniques at a point in time when the motion mitigation technique is no longer necessary, thereby providing improved feedback and/or providing additional control options without cluttering the user interface with additional displayed controls.

In some embodiments, In response to detecting the motion and in accordance with a determination that a magnitude (e.g., average magnitude, media magnitude, and/or absolute magnitude) of one or more attributes (e.g., characteristics, features, elements, and/or traits) (e.g. speed, acceleration, deacceleration, turning force, and/or braking force) of the motion is less than a threshold (e.g., as discussed at FIG. 7E) (e.g., a user defined threshold, a computer defined threshold, a user specific threshold, and/or a motion specific threshold), the computer system forgoes altering, via the audio generation component, the audio characteristic of the sound field (e.g., represented by 726 and/or 728 at FIGS. 7A-7H) corresponding to the content (e.g., represented by 724 at FIG. 7E). In some embodiments, after forgoing altering the audio characteristic of the sound field, the computer system alters the audio characteristic of the sound field in accordance with a determination that the magnitude of the one or more characteristics of the motion is above the threshold. In some embodiments, the computer system alters the audio characteristic of the sound field corresponding to the content in response to detecting the motion and in accordance with a determination that the magnitude of the one or more characteristics of the motion is less than the threshold. In some embodiments, the magnitude is an absolute value of the motion. Forgoing altering the audio characteristic of the sound when the magnitude of one or more attributes of the motion is less than the threshold allows the computer system to forgo disrupting a media experience of a user for insignificant amounts of motion, thereby providing improved feedback and/or forgo performing an operation when a set of conditions has been met without requiring further user input.

In some embodiments, In accordance with a determination that that the motion is in a first direction (e.g., represented by 718 at FIG. 7C) (e.g., forwards, backwards, to the left, and/or to the right), altering the audio characteristic of the sound field (e.g., represented by 726 and/or 728 at FIGS. 7A-7H) corresponding to the content includes moving the sound field in a second direction (e.g., 724 at FIG. 7C) (e.g., to the left to the right, backwards and/or forwards). In some embodiments, in accordance with a determination that the motion is in a third direction (e.g., 718 at FIG. 7E) (e.g., forwards, backwards, to the left, and/or to the right) different from the first direction, altering the audio characteristic of the sound field corresponding to the content includes moving the sound field in a fourth direction (e.g., 724 at FIG. 7E) (e.g., forwards, backwards, to the left, and/or to the right) different from the second direction. In some embodiments, the direction that the sound field is moved has a direct correlation or inverse correlation with the direction of the motion. In some embodiments, the magnitude of the of the movement of the sound field is directly correlated with the magnitude of the motion. Moving the sound field in a particular direction based on the direction of the motion automatically allows the computer system to perform an operation that provides an indication of the present direction of the motion and/or a future direction of the motion, thereby performing an operation when a set of conditions has been met without requiring further user input.

In some embodiments, altering the audio characteristic of the sound field (e.g., represented by 726 and/or 728 at FIGS. 7A-7H) corresponding to the content includes moving, via the audio generation component, the sound field in a first direction (e.g., forwards, backwards, to the left, and/or to the right) to a first position (e.g., 724 at FIG. 7F) (e.g., a position relative to the user and/or a position relative to the user and the computer system). In some embodiments, while the sound field is positioned at the first position (e.g., and/or while continuing to detect the motion) and in accordance with a determination that a user satisfies a first set of one or more criteria (e.g., as discussed at FIGS. 7F-7G) (e.g., one or more vital signs (e.g., the heart rate, respiratory rate, stress levels, body temperature, and/or blood pressure) of the subject is above or a threshold, amount of movement of the subject is above a threshold, subject is not detectable by the computer system, subject has not interacted with the computer system for a predetermined period of time, computer system has not detected the gaze of the for a predetermined period of time (e.g., 10-360 seconds) the eyes of the subject are closed), the computer system moves, via the audio generation component, the sound field in the first direction towards a second position (e.g., 724 at FIG. 7G) (e.g., a position relative to the user and/or a position relative to the user and the computer system) (e.g., the second position is along the first direction away from the first position) (e.g., the second position is removed from the first position) different from the first position. In some embodiments, the first direction, first position and/or second position are user specific. Moving the sound field further in the first direction when a set of prescribed conditions is met automatically allows the computer system to perform additional motion mitigation techniques to further alleviate discomfort a user may experience as a result of the motion thereby performing an operation when a set of conditions has been met without requiring further user input.

In some embodiments, altering the audio characteristic of the sound field (e.g., represented by 726 and/or 728 at FIGS. 7A-7H) includes directing (e.g., moving and/or redirecting), via the audio generation component, the sound field away from an initial position (e.g., a default position and/or a predefined position) (e.g., a position of the sound field before the motion is detected and/or a position of the sound field while the motion is detected) of the sound field to a first position (e.g., 724 at FIG. 7G). In some embodiments, while directing the sound field to the first position, the computer system detects, via the input device, an input (e.g., 705g) (e.g., a tap input, a voice command, a gaze, an air gesture, a depression of a physical input mechanism, and/or a rotation of a rotatable input mechanism). In some embodiments, in response to detecting the input, the computer system directs (e.g., moving and/or redirecting), via the audio generation component, the sound field at the initial position (e.g., 724 at FIG. 7H) without directing the sound field at the first position. In some embodiments, before detecting the motion, the computer system directs the sound field at the first position. Directing the sound field at the initial position in response to detecting the input allows the computer system to reset the positioning of the sound field when a user has indicated that the shifting of the sound field is not desired and/or warranted, thereby providing additional control options without cluttering the user interface with additional displayed controls and/or providing improved feedback.

In some embodiments, the first amount (e.g., represented by 724 at FIG. 7F) of motion (e.g., 714, 716, and/or 718 at FIG. 7F) is less than the second amount of motion (e.g., 714, 716, and/or 718 at FIG. 7G). In some embodiments, audio characteristic of the sound field (e.g., represented by 726 and/or 728 at FIGS. 7A-7H) is altered by a smaller magnitude when the audio characteristic of the sound field is altered by the first amount than when the audio characteristic of the sound field is altered by the second amount (e.g., represented by FIG. 7G). In some embodiments, the first amount of motion is more than the second amount of motion. In some embodiments, the audio characteristic of the sound field is altered by a greater magnitude when the audio characteristic of the sound field is altered by the first amount than when the audio characteristic of the sound field is altered by the second amount. In some embodiments, the first amount of motion and the first amount of alteration of the audio characteristic of the sound field and/or the second amount of motion and the second amount of alteration are directly correlated or have an inverse correlation. Altering an audio characteristic of a sound field by varying magnitudes depending on varying amounts of motion allows the computer system to automatically alter the sound field to compensate for and/or in proportion to the amount of motion without requiring user input, thereby performing an operation when a set of conditions has been met without requiring additional input.

Note that details of the processes described above with respect to method 900 (e.g., FIG. 9) are also applicable in an analogous manner to other methods described herein. For example, method 800 optionally includes one or more of the characteristics of the various methods described above with reference to method 900. For example, a sound field can be shifted using one or more techniques described here in relation to method 900, where the sound field is shifted based on the gaze of a user using one or more techniques described herein in relation to method 1100. For brevity, these details are not repeated herein.

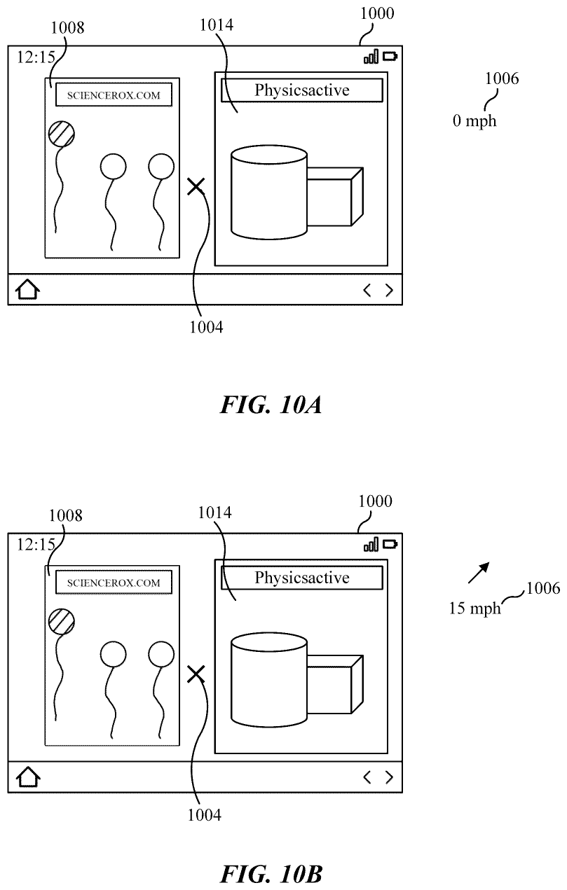

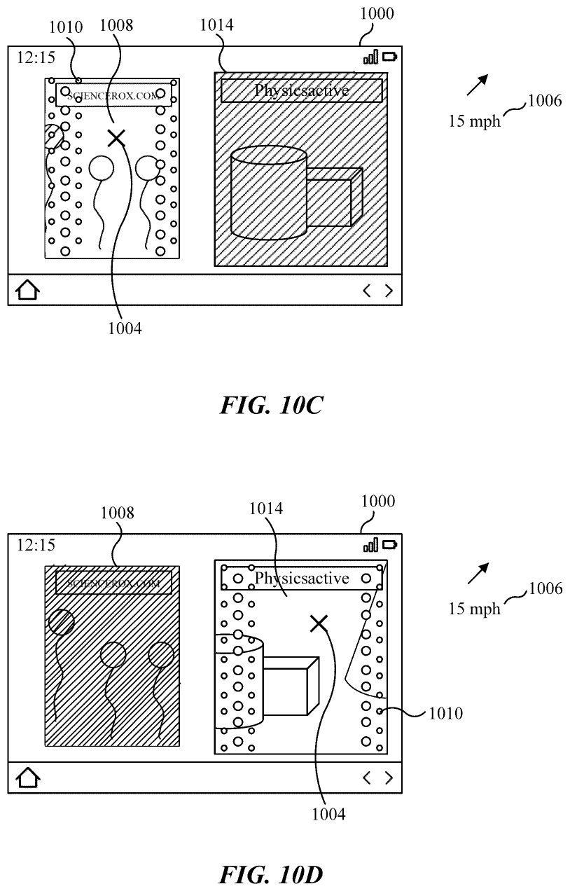

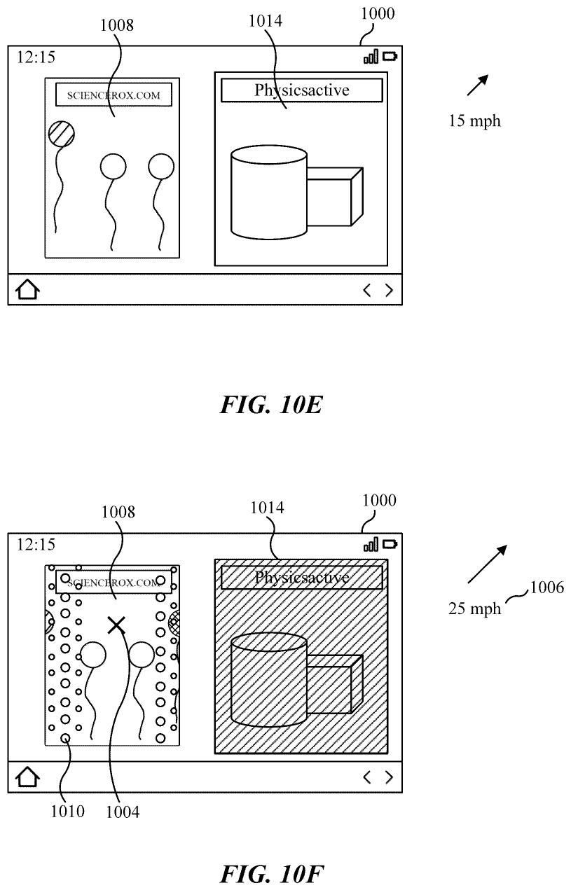

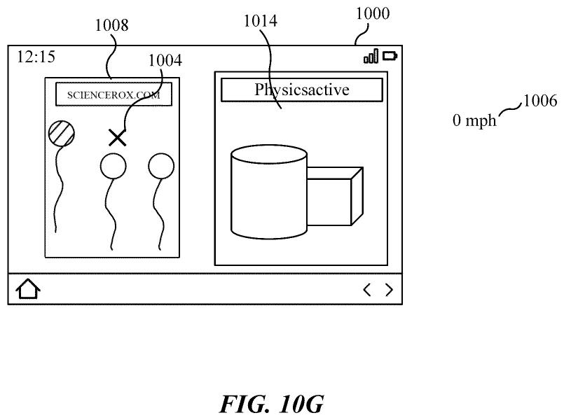

FIGS. 10A-10G illustrate exemplary user interfaces for altering content based on a gaze of a user in accordance with some embodiments. The user interfaces in these figures are used to illustrate the processes described below, including the processes in FIG. 11.

FIG. 10A illustrates computer system 1000 as a tablet. While computer system 1000 is depicted as a tablet, it should be recognized that computer system 1000 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 1000 includes and/or is in communication with one or more input devices and/or sensors (e.g., a camera, a LiDAR sensor, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being gaze inputs, other types of inputs can be used with techniques described herein, such as touch inputs that are detected via a touch-sensitive surface and/or air gestures detected via a camera (e.g., a camera that is in communication (e.g., wireless and/or wired communication) with computer system 1000. In some embodiments, computer system 1000 includes and/or is in communication with one or more output devices (e.g., a display screen, a projector, a touch-sensitive display, speaker, and/or a movement component). Such output devices are used to present information and/or cause different visual changes of computer system 1000. In some embodiments, computer system 1000 includes one or more components and/or features described above in relation to computer system 100, electronic device 200, and/or computer system 700.

As illustrated in FIG. 10A, computer system 1000 concurrently displays user interface 1008 and user interface 1014. User interface 1008 is a web browser that corresponds to an internet application that is installed on computer system 1000. User interface 1014 corresponds to a separate application that is installed on computer system 1000. In some embodiments, user interface 1008 and user interface 1014 correspond to a common application that is installed on computer system 1000. In some embodiments, computer system 1000 displays a single user interface with different sets of content. In some embodiments, computer system 1000 displays a single user interface with a single set of content.

FIGS. 10A-10G include gaze indication 1004. The positioning of gaze indication 1004 is representative of the position of the gaze of a user (e.g., a user that is currently using computer system 1000). At FIG. 10A, gaze indication 1004 is positioned between user interface 1008 and user interface 1014. Accordingly, at FIG. 10A, the user is directing their gaze between user interface 1008 and user interface 1014. Of note, gaze indication 1004 is a visual aid that is not displayed by computer system 1000.

In FIGS. 10A-10G, computer system 1000 is positioned within an external structure. Because computer system 1000 is within the external structure, as the external structure moves, computer system 1000 also moves. At FIG. 10A, the external structure is not moving. In some embodiments, computer system 1000's housing and/or enclosure is the external structure. In some embodiments, the external structure is an automobile, boat, train, subway, and/or airplane. In some embodiments, computer system 1000 is coupled to the external structure.

FIGS. 10A-10G include motion indication 1006. Motion indication 1006 provides an indication of the speed, direction and/or acceleration associated with computer system 1000. In some embodiments, motion indication 1006 indicates the motion and/or speed of an external structure that computer system 1000 is positioned within. At FIG. 10A, as a result of the external structure not moving, computer system 1000 is not moving. Accordingly, motion indication 1006 indicates that the speed of computer system 1000 is zero miles-per-hour. Similar to gaze indication 1004, motion indication 1006 is a visual aid and is not displayed by computer system 1000. In some embodiments, motion indication 1006 indicates motion and/or speed of the user relative to computer system 1000 and/or absolute motion and/or speed of the user. In some embodiments, motion indication 1006 indicates the motion and/or speed of computer system 1000 relative to the user and/or absolute motion and/or speed of computer system 1000.

At FIG. 10B, a determination is made that computer system 1000 begins to move in a rightward manner at fifteen miles-per-hour (e.g., the external structure causes computer system 1000 to move). Accordingly, at FIG. 10B motion indication 1006 includes an arrow that is directed to the right (e.g., that is indicative of the direction of motion of computer system 1000) and includes an indication of the speed of computer system 1000. At FIG. 10B, based on the positioning of gaze indication 1004, the gaze of the user continues to be directed between user interface 1008 and user interface 1014. At FIG. 10B, computer system 1000 does not modify the content that is included in user interface 1008 and user interface 1014, based on the determination that computer system 1000 begins to move in a rightward manner at fifteen miles-per-hour while the gaze of the user is directed between user interface 1008 and user interface 1014.

As explained in greater detail below, based on a determination being made that computer system 1000 is in motion (and/or the motion is above a motion threshold), computer system 1000 modifies the content within user interface 1008 and/or user interface 1014 based on the gaze of the user. Computer system 1000 modifies the appearance of content included within user interface 1008 and/or user interface 1014 to help alleviate discomfort the user is feeling as a result of the motion. However, computer system 1000 does not modify the content included within user interface 1008 and/or user interface 1014 when a determination is made that computer system 1000 is in motion (and/or the motion is above the motion threshold and/or the acceleration of computer system 1000 is above an acceleration threshold) and the gaze of the user is not directed towards user interface 1008 or user interface 1014. In some embodiments, computer system 1000 modifies the content included within user interface 1008 and user interface 1014 when a determination is made that computer system 1000 is in motion (and/or the motion is above the motion threshold and/or the acceleration of computer system 1000 is above an acceleration threshold) and the gaze of the user is not directed towards user interface 1008 or user interface 1014. In some embodiments, computer system 1000 does not modify the content included within user interface 1008 and/or user interface 1014 when a determination is made that the motion of computer system 1000 is less than the motion threshold and/or a determination is made that computer system 1000 is no longer in motion (e.g., not modifying user interface 1008 and/or user interface 1014 irrespective of the gaze of the user). In some embodiments, computer system 1000 modifies the content included within user interface 1008 and/or user interface 1014 based on a determination being made that the speed of computer system 1000 is greater than a speed threshold. In some embodiments, computer system 1000 modifies the content included within user interface 1008 and/or user interface 1014 based on a determination being made that an acceleration of computer system 1000 is greater than an acceleration threshold.

At FIG. 10C, as indicated by motion indication 1006, computer system 1000 continues to move in a rightward manner at 15 miles-per-hour. At FIG. 10C, as indicated by the positioning of gaze indication 1004, the user is directing their attention towards user interface 1008 (e.g., and not user interface 1014). At FIG. 10C, a determination is made that the gaze of the user is directed at user interface 1008 while computer system 1000 is in motion (and/or the motion is above the motion threshold and/or the acceleration of computer system 1000 is above an acceleration threshold). At FIG. 10C, because a determination is made that the gaze of the user is directed at user interface 1008 while computer system 1000 is in motion (and/or the motion is above the motion threshold and/or the acceleration of computer system 1000 is above an acceleration threshold), computer system 1000 modifies the content within user interface 1008. More specifically, at FIG. 10C, computer system 1000 displays visual cues 1010 (e.g., as described above with respect to FIGS. 4A-4C, 5A-5D, 6, 7A-7H, 8, and/or 9) as overlaid on top of user interface 1008. Visual cues 1010 include a pattern of user interface objects (e.g., user interface objects of a single shape or user interface objects of multiple shapes) that move based on the motion of computer system 1000. The above description of dynamic element 406, as described above in FIGS. 4A-4C and 5A-5D, and the above description of left visual elements 730 and/or right visual elements 732 as described above in FIGS. 7A-7H are hereby incorporated into visual cues 1010.

Computer system 1000 displays visual cues 1010 as a technique to mitigate discomfort that a user may experience as a result of the motion (e.g., the motion that corresponds to motion indication 1006). In some embodiments, the display of visual cues 1010 is dependent on the motion of computer system 1000. For example, computer system 1000 moves visual cues 1010 in a direction that is opposite the motion of computer system 1000 (e.g., the motion that corresponds to motion indication 1006). More specifically, computer system 1000 displays visual cues 1010 in a manner such that there is not a disconnect between the motion the user feels and the content the user is viewing. While the motion of computer system 1000 is to the right, the user experiences movement to the left. Accordingly, computer system 1000 moves visual cues 1010 to the left to match the motion that the user feels. In some embodiments, the speed at which computer system 1000 moves visual cues 1010 has a direct correlation with the motion of computer system 1000.

In addition to displaying visual cues 1010, because a determination is made that the gaze of the user is directed at user interface 1008 (e.g., and not user interface 1014), while computer system 1000 is in motion (and/or the motion is above the motion threshold and/or another motion threshold different from the motion threshold), computer system 1000 shifts the content included within user interface 1008 in a direction that is opposite the direction of motion of computer system 1000. Accordingly, at FIG. 10C, because the motion of computer system 1000 is to the right, computer system 1000 shifts the content within user interface 1008 to the left (e.g., in comparison to the positioning of the content of user interface 1008 at FIG. 10B). The shifting of the content within user interface 1008 is an additional motion mitigation technique that computer system 100 performs to increase the comfortability of the user. In some embodiments, when the motion of computer system 1000 is below the other motion threshold and above the motion threshold, computer system 1000 displays visual cues 1010 without shifting the content of user interface 1008. For example, based on a determination that computer system 1000 is moving at a speed of 10 miles-per-hour, computer system 1000 displays visual cues 1010 without shifting the display of content included within user interface 1008. In some embodiments, when the motion of computer system 1000 is below the other motion threshold and above the motion threshold, computer system 1000 shifts the display of content included within user interface 1008 without displaying visual cues 1010.

At FIG. 10C, because a determination is made that the gaze of the user is directed at user interface 1008 while computer system 1000 is in motion (and/or the motion is above the motion threshold and/or the acceleration of computer system 1000 is above an acceleration threshold), computer system 1000 blurs and/or otherwise deemphasizes the content of user interface 1014. In some embodiments, computer system 1000 blurs the content of user interface 1014 based on a determination that the gaze of the user is not directed at user interface 1014 while computer system 1000 is in motion (and/or the motion is above the motion threshold and/or the acceleration of computer system 1000 is above an acceleration threshold). In some embodiments, computer system 100 ceases to display user interface 1014 based on a determination that the gaze of the user is directed at user interface 1008 while computer system 1000 is in motion (and/or the motion is above the motion threshold and/or the acceleration of computer system 1000 is above an acceleration threshold). In some embodiments, computer system 1000 does not modify the appearance of user interface 1014 when a determination is made that the gaze of the user is directed at user interface 1008 while computer system 1000 is in motion (and/or the motion is above the motion threshold and/or the acceleration of computer system 1000 is above an acceleration threshold).

At FIG. 10D, as indicated by motion indication 1006, computer system 1000 continues to move in a rightward manner at 15 miles-per-hour. At FIG. 10D, as indicated by the positioning of gaze indication 1004, the user is now directing their attention at user interface 1014 (e.g., and not user interface 1008). At FIG. 10D, a determination is made that the gaze of the user is directed at user interface 1014 while computer system 1000 is in motion (and/or the motion is above the motion threshold and/or the acceleration of computer system 1000 is above an acceleration threshold). At FIG. 10D, because a determination is made that the gaze of the user is directed at user interface 1014 while computer system 1000 is in motion (and/or the motion is above the motion threshold and/or the acceleration of computer system 1000 is above an acceleration threshold), computer system 1000 modifies the content included within user interface 1014. Computer system 1000 modifies the content within user interface 1014 in the same manner in which computer system 1000 modified the content included within user interface 1008 at FIG. 10C. More specifically, as illustrated in FIG. 10D, computer system 1000 displays visual cues 1010 and shifts the content included within user interface 1014 to the left. In some embodiments, the appearance (e.g., size, shape, and/or color) of visual cues 1010 is based on the motion of computer system 1000. For example, the size of visual cues 1010 increases as the speed of computer system 1000 increases and/or the color of visual cues 1010 darkens as the speed of computer system 1000 increases. As illustrated in FIG. 10D, because a determination is made that the gaze of the user is directed at user interface 1014 while computer system 1000 is in motion (and/or the motion is above the motion threshold and/or the acceleration of computer system 1000 is above an acceleration threshold), computer system 1000 blurs and/or otherwise deemphasizes the content of user interface 1008.

At FIG. 10E, as indicated by the absence of gaze indication 1004, the user is not directing their attention towards computer system 1000. At FIG. 10E, a determination is made that the user is not directing their attention towards computer system 1000. At FIG. 10E, because the determination is made that the user is not directing their attention towards computer system 1000, computer system 1000 ceases modifying the content of user interface 1014 and ceases blurring and/or deemphasizing the content of user interface 1008. That is, when it is determined that the attention of the user is not directed at computer system 1000, computer system 1000 does not alter the appearance of the content included within user interface 1014 and/or the content included within user interface 1008. In some embodiments, computer system 1000 ceases modifying the content of user interface 1008 and/or user interface 1014 based on a determination that the gaze of the user is not directed at user interface 1008 nor user interface 1014. In some embodiments, computer system 1000 ceases displaying user interface 1008 and/or user interface 1014 based on a determination that the user is not directing their attention towards computer system 1000. In some embodiments, computer system 1000 ceases modifying the appearance of content included within user interface 1008 and/or user interface 1014 based on a determination that the motion of computer system 1000 transitions from being above the motion threshold to being below the motion threshold (e.g., computer system 1000 and/or the external structure that computer system 1000 is within has come to a rest) is slowing down).

At FIG. 10F, as indicated by motion indication 1006, computer system 1000 continues to move in a rightward manner. However, at FIG. 10F, the speed of computer system 1000 increases to twenty-five miles per hour (e.g., from fifteen miles per hour at FIG. 10E). At FIG. 10F, as indicated by the positioning of gaze indication 1004, the user is directing their attention at user interface 1008. At FIG. 10F, a determination is made that the attention of the user is directed at user interface 1008 while computer system 1000 is in motion. Because a determination is made that that the attention of the user is directed at user interface 1008 while computer system 1000 is in motion (and/or the motion is above the motion threshold and/or the acceleration of computer system 1000 is above an acceleration threshold), computer system 1000 displays visual cues 1010 as moving from right to left, shifts the content included within user interface 1008 to the left, and blurs and/or otherwise deemphasizes the content within user interface 1014 (e.g., using the techniques described above).

At FIG. 10F, because computer system 1000 is travelling at twenty-five miles per hour, as opposed to the fifteen miles per hour (e.g., the speed of computer system 1000 at FIGS. 10B-10E), computer system 1000 was previously travelling at, computer system 1000 shifts the content included within user interface 1008 by a greater magnitude in contrast to when computer system 1000 is traveling at fifteen miles per hour. In some embodiments, the number of visual cues 1010 that computer system 1000 displays is dependent on a magnitude of the motion of computer system 1000. For example, computer system 1000 displays more visual cues 1010 the faster computer system 1000 travels and/or accelerates or computer system 1000 displays fewer visual cues 1010 the faster computer system 1000 travels and/or accelerates. In some embodiments, the speed at which computer system 1000 displays visual cues 1010 moving is dependent on a magnitude of the motion of computer system 1000 (e.g., computer system 1000 displays visual cues 1010 as moving faster the faster computer system 1000 moves and/or accelerates or computer system 1000 displays visual cues 1010 as moving slower the faster computer system 1000 moves and/or accelerates). In some embodiments, the number of visual cues 1010 that computer system 1000 displays is dependent on the motion of computer system 1000 (e.g., computer system 1000 displays more visual cues 1010 the greater the speed of computer system 1000 travels and/or accelerates or computer system 1000 displays fewer visual cues 1010 the greater the motion of computer system 1000).

At FIG. 10G, as indicated by motion indication 1006, computer system 1000 is no longer moving (e.g., computer system 1000 and/or the external structure that computer system 1000 is within has come to a rest). At FIG. 10G, as indicated by the positioning of gaze indication 1004, the attention of the user remains directed at user interface 1008. At FIG. 10G, a determination is made that computer system 1000 is not in motion. Because a determination is made computer system 1000 is not in motion, computer system 1000 ceases to modify the appearance of the content included within user interface 1008 and user interface 1014. That is, though the attention of the user is directed at user interface 1014, because computer system 1000 is not in motion, computer system 1000 does not modify the appearance of user interface 1008 and 1014 (e.g., computer system 1000 displays user interface 1008 and user interface 1014 with their initial appearance). In some embodiments, based on a determination that computer system 1000 is not in motion, computer system 1000 ceases to display user interface 1008 and/or user interface 1014. In some embodiments, based on a determination that computer system 1000 is not in motion, computer system applies a visual effect (e.g., a blur, decrease in opacity, and/or fade out). In some embodiments, computer system 1000 ceases to detect the attention of the user based on a determination that computer system 1000 is not in motion. In some embodiments, computer system 1000 continues to detect the attention of the user based on a determination that computer system 1000 is not in motion.

FIG. 11 is a flow diagram illustrating a method (e.g., method 1100) for altering content based on a gaze of a user in accordance with some embodiments. Some operations in method 1100 are, optionally, combined, the orders of some operations are, optionally, changed, and some operations are, optionally, omitted.

As described below, method 1100 provides an intuitive way for altering content based on a gaze of a user. Method 1100 reduces the cognitive burden on a user, thereby creating a more efficient human-machine interface. For battery-operated computing devices, enabling a user to interact with such devices faster and more efficiently conserves power and increases the time between battery charges.

In some embodiments, method 1100 is performed at a computer system (e.g., 1000) (e.g., a watch, a phone, a tablet, a fitness tracking device, a processor, a head-mounted display (HMD) device, a communal device, a media device, a speaker, a television, and/or a personal computing device) that is in communication with (e.g., and/or includes) an input device (e.g., a motion detection device (e.g., gyroscope, force meter, accelerometer, and/or internal or external component able to detect and/or measure motion), a camera (e.g., one or more cameras with different fields of view in relation to the computer system (e.g., front, back, wide, and/or zoom)), a depth sensor, a microphone, a hardware input mechanism, a rotatable input mechanism, a heart monitor, a temperature sensor, and/or a touch-sensitive surface) and a display generation component (e.g., as discussed at FIG. 10A) (e.g., a display screen, a projector, and/or a touch-sensitive display).

While displaying, via the display generation component, content (e.g., 1008 and/or 1014) in a first manner (e.g., 1008 and/or 1014 at FIGS. 10A and/or 10B) (e.g., with a first set of one or more visual characteristics and/or a first visual appearance), the computer system detects (1102), via the input device, motion (e.g., represented as 1006 at FIGS. 10A-10G) (e.g., motion of the computer system, motion of a user, and/or motion of an external structure) (e.g., relative or absolute motion (e.g., motion of the input device relative to the computer system, motion of the input device relative to a physical environment, or absolute motion detected by the input device)). In some embodiments, the content includes a user interface, one or more user interface objects, one or more images, text, and/or one or more characters. In some embodiments, displaying the content in the first manner includes displaying, via the display generation component, maximized content, unmodified content, a first type of content, a first amount of content, and/or content with a first visual clarity. In some embodiments, detecting the motion includes detecting: force against and/or exerted on the input device, movement of the computer system relative to an object and/or surface (e.g., change as measured from a particular point) or absolute movement of the computer system within the environment (e.g., absolute measurement of displacement of the computer system), direction (e.g., movement in a direction, and/or change in direction), and/or acceleration detected by the input device. In some embodiments, detecting motion includes detecting relative motion (e.g., difference in motion as compared to another object, plane, and/or point) (e.g., motion of the computer system relative to a position (e.g., object, position within 3D space, and/or plane within an environment), relative to a direction (e.g., in a direction, from a direction, and/or change of direction), and/or relative to previous motion), and/or absolute motion (e.g., motion of the computer system irrespective of external factors and/or motion of the computer system without comparison to an object, position, and/or plane).

In response to (1104) detecting the motion, in accordance with a determination that a user is directing attention to a first portion of the content (e.g., position of 1004 on 1008 at FIG. 10C) (e.g., a subsection of the content, a majority of the content, a minority of the content, less than the entirety of the content, and/or a key portion of the content), the computer system displays (1106), via the display generation component, the first portion of the content in a second manner (e.g., inclusion of 1010 on 1008 at FIG. 10C), different from the first manner, based on the motion. In some embodiments, determining that the user is directing attention to the first portion of the content includes determining that the attention of the user is directed to, within, and/or on a user interface, user interface element, content, and/or output device. In some embodiments, determining that the user is directing attention to the first portion of the content includes detecting an input (e.g., gaze input, non-touch input, input corresponding to the computer system determining the position of a user's eyes in relation to the computer system) directed to the position within and/or on a user interface, user interface element, content, and/or output device. In some embodiments, determining that the user is direction attention to the first portion of the content includes determining proximity of the user to a position within and/or on a user interface, user interface element, content, and/or output device. In some embodiments, displaying the first portion of the content in the second matter includes changing an amount of the content in the first portion (e.g., adding and/or removing from the content), a visual characteristic (e.g., emphasis, clarity, size, boldness, and/or brightness) of the content, position (e.g., relative to the user interface, the computer system and/or relative to the motion), and/or type of content (e.g., altering the representation of the content (e.g., text to an image and/or video to an image) and/or summarizing). In some embodiments, displaying the first portion of the content in the second matter is based on the motion includes altering the first portion of the content to compensate for the motion (e.g., repositioning, resizing, emphasizing, and/or changing the content within the first portion of the content based on the motion). In some embodiments, displaying the first portion of the content in the second manner includes displaying a second portion, different from the first portion, of the content in the first manner, the second manner, and/or a third manner different from the first manner and/or the second manner.

In response to (1104) detecting the motion, in accordance with a determination that the user is directing attention to a second portion of the content (e.g., position of 1004 on 1014 at FIG. 10D) (e.g., a subsection of the content, a majority of the content, a minority of the content, less than the entirety of the content, and/or a key portion of the content) different from the first portion of the content (e.g., and not the first portion of the content), the computer system continues (1108) display of, via the display generation component, the first portion of the content in the first manner (e.g., 1008 at FIG. 10B). In some embodiments, continuing display of the first portion of the content in the first manner includes displaying, via the display generation component, the second portion of the content in the first manner, the second manner, the third manner, and/or a fourth manner different from the first manner, the second manner, and/or the third manner. In some embodiments, the first portion of the content and/or the second portion of the content are a subsection of the content based on relevance (e.g., relevance of the subsection of the content as compared to other portions of the content and/or relevance to current context of the environment (e.g., location, weather, time of day, and/or situation (e.g., the situation that caused the movement))), position (e.g., relative position as compared to the user interface and/or the other portions of the content), size, prominence, and/or type (e.g., text, image, and/or user interface element). Selectively altering a portion of content based on a user directing attention to the portion of content upon detecting motion allows the computer system to automatically alter a relevant portion of content without requiring user selection of the portion of the content, thereby performing an operation when a set of conditions has been met without requiring additional input.

In some embodiments, in response to detecting the motion (e.g., represented as 1006 at FIGS. 10A-10G) and in accordance with the determination that the user is directing attention to the first portion of the content (e.g., position of 1004 on 1008 at FIG. 10C), the computer system displays (e.g., adding and/or including), via the display generation component, one or more user interface elements (e.g., icons, widgets, controls, and/or windows) within (and/or on top of and/or a location corresponding to) the second portion of the content (e.g., 1014 at FIG. 10D) (e.g., without displaying one or more user interface elements within the first portion of the content). In some embodiments, the one or more user interface elements correspond to the motion, are reactive to the motion, and/or counteract and/or contradict the motion (e.g., the computer system displays the content and/or alters the one or more user interface elements to lessen a user's sensation of motion and/or feeling of motion). In some embodiments, displaying the one or more user interface elements includes displaying the first portion of the content and/or the second portion of the content with one or more visual alterations (e.g., repositioning, blurring, magnifying, shrinking, and/or changing one or more colors) to the first portion of the content and/or the second portion of the content. In some embodiments, displaying the one or more user interface elements includes altering the first portion of the content and/or the second portion of the content to compensate for and/or make room for the one or more user interface elements. In some embodiments, the computer system displays the one or more user interface elements as overlaid on (and/or positioned over) the second portion of the content. In some embodiments, in response to detecting the motion and in accordance with the determination that the user is directing attention to the first portion of the content, the computer system displays, via the display generation component, the second portion of the content with one or more user interface elements. Displaying additional user interface elements in a portion of content upon modifying another portion of the content allows the computer system to selectively add the user interface elements where a user is not directing attention without requiring a user selection, thereby performing an operation when a set of conditions has been met without requiring additional input.

In some embodiments, displaying the first portion of the content (e.g., 1008) in the second manner (e.g., 1008 at FIG. 10C) includes displaying, via the display generation component, the first portion of the content with one or more user interface elements (e.g., 1010 at FIG. 10C) (e.g., icons, widgets, controls, and/or windows). In some embodiments, the one or more user interface elements correspond to the motion, are reactive to the motion, and/or counteract and/or contradict the motion (e.g., the computer system displays the content and/or alters the one or more user interface elements to lessen a user's sensation of motion and/or feeling of motion). In some embodiments, displaying the one or more user interface elements includes displaying the first portion of the content and/or the second portion of the content with one or more visual alterations (e.g., repositioning, blurring, magnifying, shrinking, and/or changing one or more colors) to the first portion of the content and/or the second portion of the content. In some embodiments, displaying the one or more user interface elements includes altering the first portion of the content and/or the second portion of the content to compensate for and/or make room for the one or more user interface elements. In some embodiments, the computer system displays the one or more user interface elements as overlaid on (and/or positioned over) the first portion of the content. Displaying additional user interface elements in a portion of content upon modifying another portion of the content allows the computer system to selectively add the user interface elements where a user is directing attention without requiring a user selection, thereby performing an operation when a set of conditions has been met without requiring additional input.

In some embodiments, displaying the first portion of the content in the second manner (e.g., 1008 at FIG. 10F) includes moving (e.g., repositioning and/or displaying) the first portion of the content by a first amount (e.g., as discussed at FIG. 10E-10F) (and/or from a first location). In some embodiments, in response to detecting the motion (e.g., represented as 1006 at FIGS. 10A-10G) and in accordance with the determination that the user is directing attention to the first portion of the content (e.g., position of 1004 on 1008 at FIG. 10F), the computer system moves (e.g., repositioning and/or displaying) the second portion of the content by a second amount (e.g., difference between 1008 in FIGS. 10E and 10F) (and/or from the first location and/or a second location), wherein the second amount is less than the first amount. In some embodiments, moving the first portion of the content and/or the second portion of the content includes displaying, at a first time, the first portion of the content and/or the second portion of the content at a first location and second location respectively and, at a second time, different from the first time, respectively displaying the first portion of the content and the second portion of the content at a third location different from the first location and fourth location different from the second location (e.g., difference between the first location and third location and the second location and the fourth location corresponds to the first amount and/or the second amount). In some embodiments, the first amount and/or the second amount are based on the motion (e.g., depict the motion, are reactive to the motion, and/or counteract and/or contradict the motion (e.g., moving the first portion of the content and/or the second portion of the content to lesson a user's sensation of motion and/or feeling of motion)). In some embodiments, the second amount is greater than the first amount. Moving content at varying levels depending on where a user is directing attention allows the computer system to selectively move portions of content based on where the user is directing attention without requiring a user select the portion, thereby performing an operation when a set of conditions has been met without requiring additional input.

In some embodiments, displaying the first portion of the content in the second manner (e.g., 1008 at FIG. 10F) includes moving (e.g., repositioning and/or displaying) the first portion of the content by a first amount (and/or from a first location). In some embodiments, In response to detecting the motion (e.g., represented as 1006 at FIGS. 10A-10G) and in accordance with the determination that the user is directing attention to the first portion of the content (e.g., position of 1004 on 1008 at FIG. 10F), the computer system moves (e.g., repositioning and/or displaying), the second portion of the content by a second amount (e.g., difference between 1008 in FIGS. 10E and 10F) (and/or from the first location and/or a second location), wherein the second amount is greater than the first amount. In some embodiments, moving the first portion of the content and/or the second portion of the content includes displaying, at a first time, the first portion of the content and/or the second portion of the content at a first location and second location respectively and, at a second time, different from the first time, respectively displaying the first portion of the content and the second portion of the content at a third location different from the first location and fourth location different from the second location (e.g., difference between the first location and third location and the second location and the fourth location corresponds to the first amount and/or the second amount). In some embodiments, the first amount and/or the second amount are based on the motion (e.g., depict the motion, are reactive to the motion, and/or counteract and/or contradict the motion (e.g., moving the first portion of the content and/or the second portion of the content to lesson a user's sensation of motion and/or feeling of motion)). In some embodiments, the second amount is less than the first amount. Moving content at varying levels depending on where a user is directing attention allows the computer system to differently move portions of content based on where a user is directing attention without requiring a user select the portion, thereby performing an operation when a set of conditions has been met without requiring additional input.

In some embodiments, before detecting the motion (e.g., represented as 1006 at FIGS. 10A-10G), the second portion of the content is displayed with a first amount of visual obfuscation (e.g., 1014 at FIG. 10E) (and/or first level of blur). In some embodiments, in response to detecting the motion and in accordance with the determination that the user is directing attention to the first portion of the content (e.g., position of 1004 on 1008 at FIG. 10F) (e.g., at a second time, different from the first time), the computer system displays, via the display generation component, the second portion of the content with a second amount of visual obfuscation (e.g., 1014 at FIG. 10F) (and/or second level of blur) (and/or reduced visual clarity) that is greater than the first amount of visual obfuscation (e.g., difference of 1014 in FIGS. 10E-10F). In some embodiments, the computer system displays the first portion of the content with the first amount of visual obfuscation while the computer system displays the second portion of the content with the second amount of visual obfuscation. In some embodiments, the computer system displays the first portion of the content with a third amount of visual obfuscation while the computer system displays the second portion of the content with the second amount of visual obfuscation. In some embodiments, the second amount of visual obfuscation is less than the first amount of visual obfuscation. In some embodiments, the difference between the first amount of visual obfuscation and the second amount of visual obfuscation is based on the motion (e.g., increasing and/or decreasing the change in visual obfuscation depending on the intensity, duration, change, and/or direction of the motion). Selectively obfuscating a portion of content based on a user directing attention to another portion of content allows the computer system to automatically emphasize the other portion of content without a user selecting the other portion of content, thereby performing an operation when a set of criteria has been met without requiring additional input. In some embodiments, in response to detecting the motion and in accordance with the determination that the user is directing attention to the first portion of the content, the computer system increases the size of text included in the first portion of the content. In some embodiments, in response to detecting the motion and in accordance with the determination that the user is directing attention to the first portion of the content, the computer system decreases the amount of visual noise in the first portion of the content. In some embodiments, in response to detecting the motion and in accordance with the determination that the user is directing attention to the first portion of the content, the computer system decreases the amount of motion and/or animation of user interface objects included in the first portion of the content.

In some embodiments, before detecting the motion (e.g., represented as 1006 at FIGS. 10A-10G), the second portion of the content is displayed with a first amount of colors (e.g., 1014 at FIG. 10E) (e.g., a first range of colors, a first pallet of colors, and/or a first spectrum of colors) (and/or set of one or more colors). In some embodiments, in response to detecting the motion and in accordance with the determination that the user is directing attention to the first portion of the content (e.g., position of 1004 on 1008 at FIG. 10F), the computer system displays, via the display generation component, the second portion of the content with a second amount of colors (e.g., 1014 at FIG. 10F) (e.g., a second range of colors, a second pallet of colors, and/or a second spectrum of colors) (and/or set of one or more colors) that is less than the first amount of one or more colors (e.g., difference of 1014 in FIGS. 10E-10F). In some embodiments, displaying the second portion of the content with the second amount of colors includes displaying the first portion of the content with the first amount of colors. In some embodiments, displaying the second portion of the content with the second amount of colors includes displaying the first set of one or more colors with a third amount of colors, different from the first amount of colors and/or the second amount of colors. In some embodiments, the second amount of colors is smaller than the first amount of colors (e.g., a smaller pallet of colors, a smaller spectrum of colors, a more neutral pallet of colors, and/or a less contrasting pallet of colors). In some embodiments, the difference between the first amount of colors and the second amount of colors is based on the motion (e.g., increasing and/or decreasing the change in visual clarity depending on the intensity, duration, change, and/or direction of the motion). Selectively reducing an amount of colors of a portion of content based on a user directing attention to another portion of content allows the computer system to automatically emphasize the other portion of content without a user selecting the other portion of content, thereby performing an operation when a set of criteria has been met without requiring additional input.

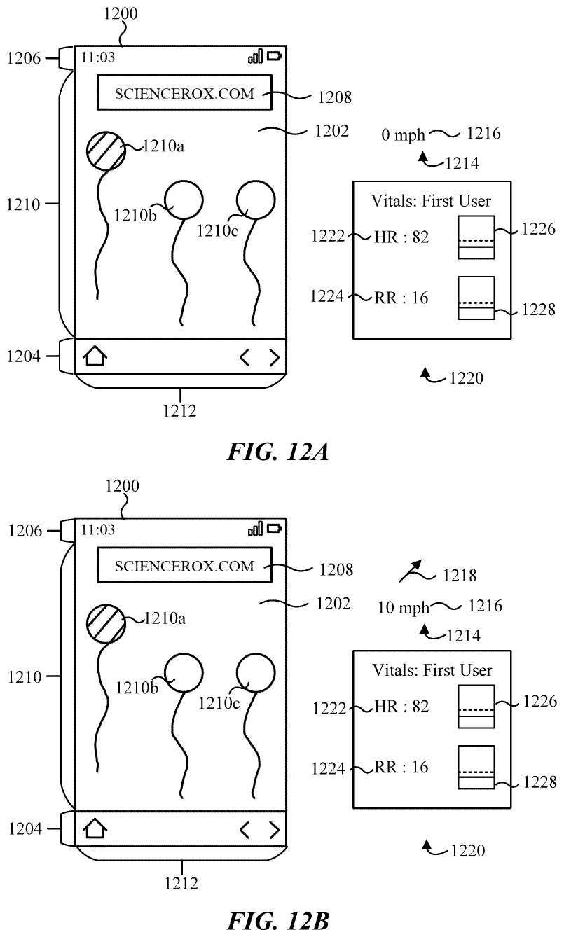

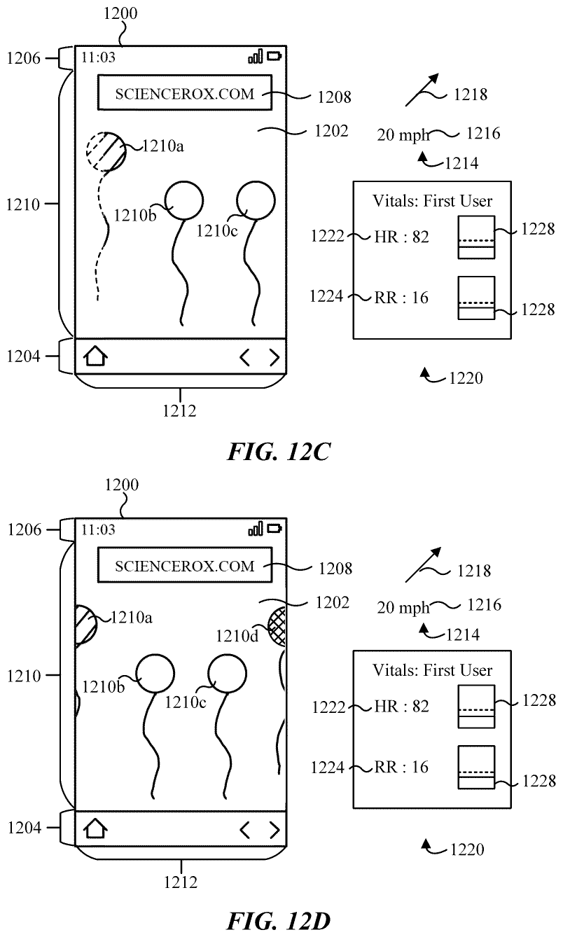

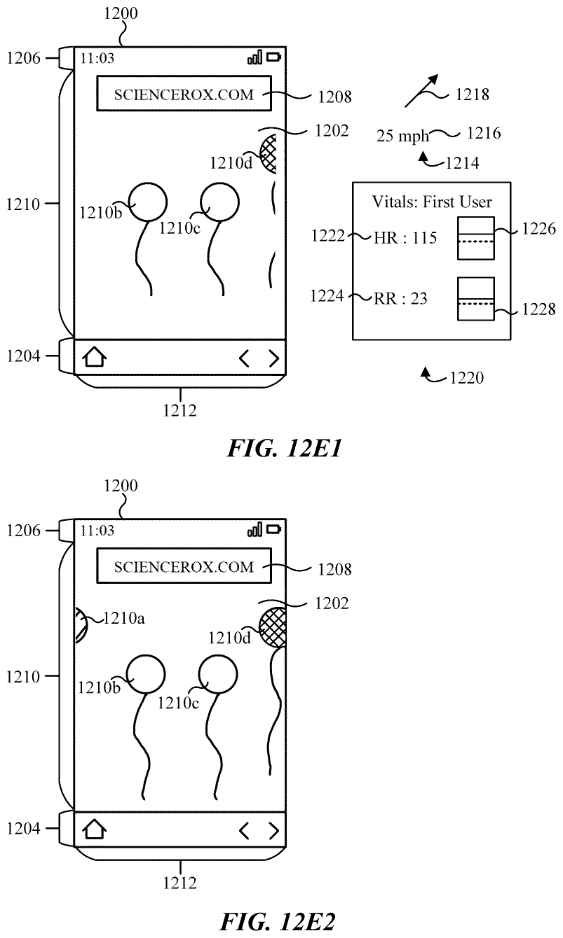

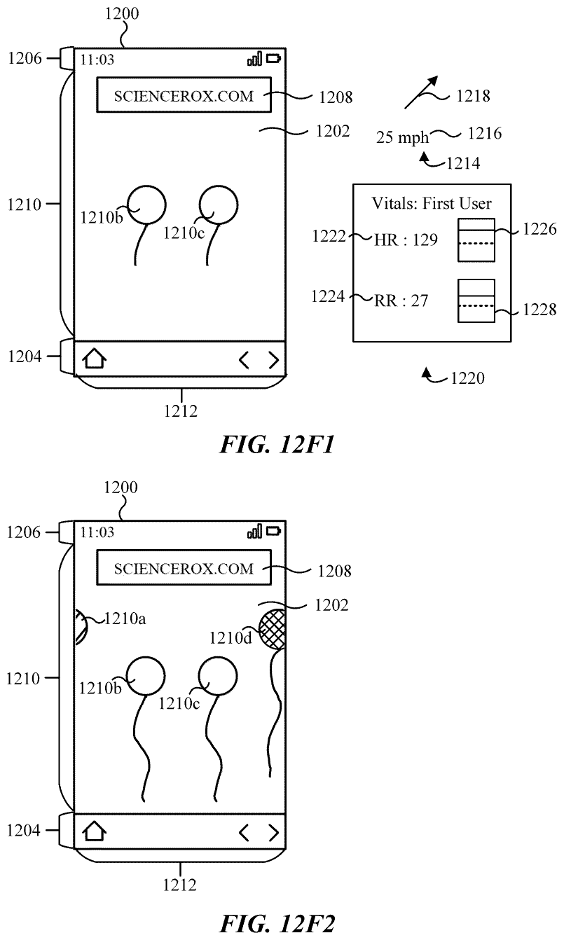

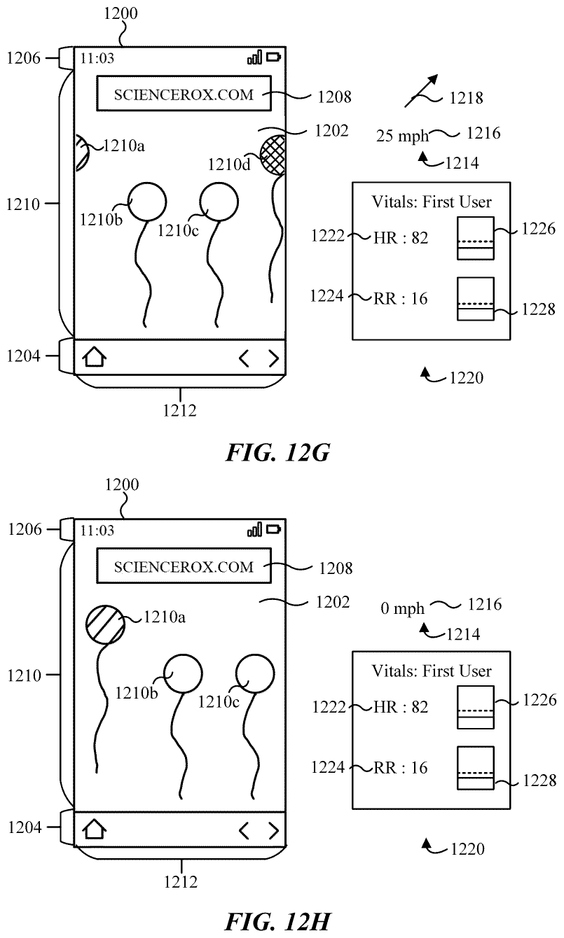

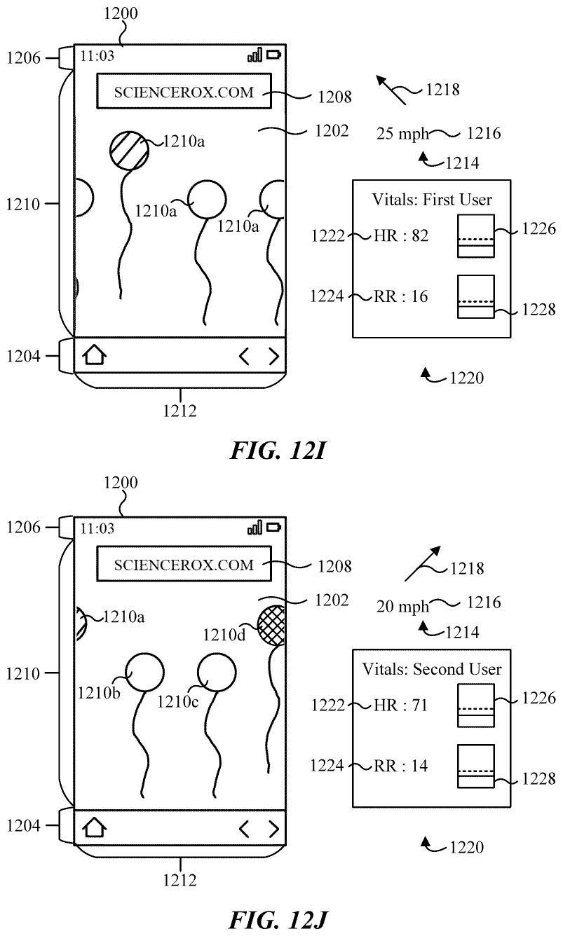

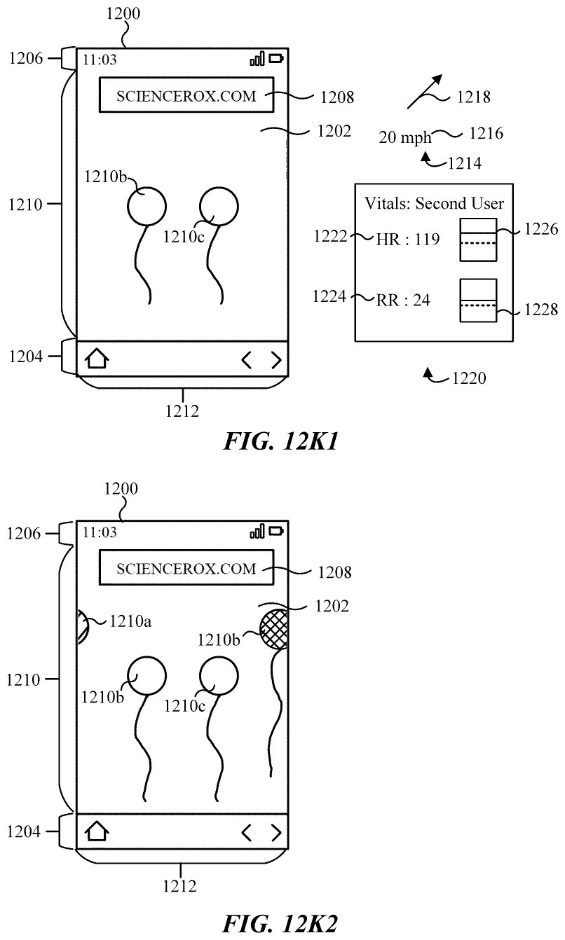

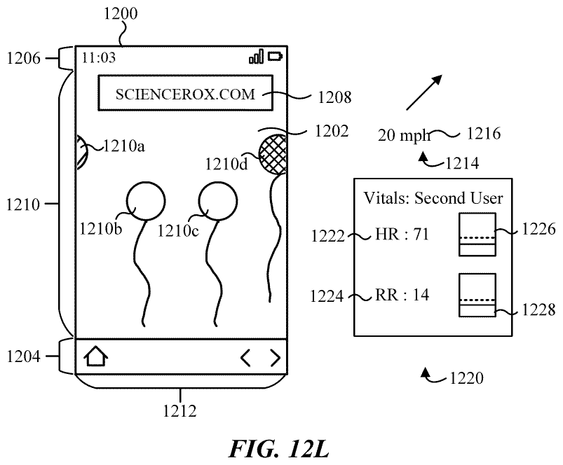

In some embodiments, while the first portion of the content is displayed in the second manner (e.g., 1008 at FIG. 10C) (e.g., and/or while the second portion of the content is displayed in the first manner), the computer system detects, via the input device, that the attention of the user moves from the first portion of the content to a third portion of the content (e.g., movement of 1004 in FIG. 10C to 10D) (e.g., a subsection of the content, a majority of the content, a minority of the content, less than the entirety of the content, and/or a key portion of the content). In some embodiments, detecting that the attention of the user moves from the first portion of the content to the third portion of the content includes detecting that the user is directing attention to a portion of the content at a first time and detecting that the user is direction attention to a different portion of the content at a second time, different than the first time. In some embodiments, detecting that the attention of the user moves from the first portion of the content to the third portion of the content includes detecting a change of attention of the user as compared to a user interface, user interface element, content, and/or output device. In some embodiments, detecting that the attention of the user moves from the first portion of the content to the third portion of the content includes detecting a first input and a second input, different from the first input (e.g., gaze input, non-touch input, input corresponding to the computer system determining the position of a user's eyes in relation to the computer system) directed to a position within and/or on a user interface, user interface element, content, and/or output device. In some embodiments, detecting that the attention of the user moves from the first portion of the content to the third portion of the content includes determining proximity of the user to a position within and/or on a user interface, user interface element, content, and/or output device. In some embodiments, in response to detecting that the attention of the user moves from the first portion of the content to the respective portion of the content, the computer system displays the first portion of the content in the first manner (e.g., 1008 at FIG. 12B). In some embodiments, displaying the first portion of the content in the first manner, after displaying the first portion of content in the second manner, includes the computer system reverting changes and/or alterations to the first portion of the content corresponding to the second manner. In some embodiments, in response to detecting that the attention of the user moves from the first portion of the content to the respective portion of the content, the computer system displays, via the display generation component, the third portion of the content in a third manner (1014 at FIG. 10D), different from the first manner (e.g., difference in amount of content, visual changes, position, and/or content). In some embodiments, the third portion of the content is a subsection of the first portion of the content and/or the second portion of the content. In some embodiments, the third portion of the content is different from the first portion of the content and/or the second portion of the content. In some embodiments, displaying the third portion of the content in the third matter includes changing an amount of the content in the first portion (e.g., adding and/or removing from the content), a visual characteristic (e.g., emphasis, clarity, size, boldness, and/or brightness) of the content, position (e.g., relative to the user interface, the computer system and/or relative to the motion), and/or type of content (e.g., altering the representation of the content (e.g., text to an image and/or video to an image) and/or summarizing). In some embodiments, displaying the third portion of the content in the third matter based on the motion includes altering the first portion of the content to compensate for the motion (e.g., repositioning, resizing, emphasizing, and/or changing the content within the first portion of the content based on the motion). In some embodiments, the third manner is different from the first manner and/or the second manner. In some embodiments, the third manner is the first manner. In some embodiments, the third manner is the second manner. In some embodiments, the third manner includes the second manner. In some embodiments, the third manner is additive to the second manner. Selectively modifying portions of content based on a user changing where the user is directing attention allows the computer system to automatically alter the portions of content as the user changes attention without requiring the user to select the portion of the content as the user's attention changes, thereby performing an operation when a set of criteria has been met without requiring additional input.

In some embodiments, in response to detecting the motion (e.g., represented as 1006 at FIGS. 10A-10G) and in accordance with the determination that the user is directing attention to the first portion of the content (e.g., position of 1004 on 1008 at FIG. 10F), in accordance with a determination that the motion is a first amount of motion (e.g., 1006 at 10E) (e.g., a first direction, intensity, and/or duration), displaying the first portion of the content in the second manner includes modifying a set of one or more visual characteristics (e.g., size, position, clarity, amount of content, and/or type of content) of the first portion of the content by a first amount (e.g., as discussed at FIG. 10C). In some embodiments, determining that the motion is the first amount of motion includes determining the force against and/or exerted on the input device, movement of the computer system relative to an object and/or surface (e.g., change as measured from a particular point) or absolute movement of the computer system within the environment (e.g., absolute measurement of displacement of the computer system), direction (e.g., movement in a direction, and/or change in direction), and/or acceleration detected by the input device. In some embodiments, determining that the motion is the first amount of motion includes determining the relative motion of the computer system (e.g., difference in motion as compared to another object, plane, and/or point) (e.g., motion of the computer system relative to a position (e.g., object, position within 3D space, and/or plane within an environment), relative to a direction (e.g., in a direction, from a direction, and/or change of direction), and/or relative to previous motion), and/or absolute motion of the computer system (e.g., motion of the computer system irrespective of external factors and/or motion of the computer system without comparison to an object, position, and/or plane). In some embodiments, the computer system modifies the set of one or more visual characteristics of the first portion of the content by the first amount by changing an amount of the content in the first portion (e.g., adding and/or removing from the content), a visual characteristic (e.g., emphasis, clarity, size, boldness, and/or brightness) of the content, position (e.g., relative to the user interface, the computer system and/or relative to the motion), and/or type of content (e.g., altering the representation of the content (e.g., text to an image and/or video to an image) and/or summarizing). In some embodiments, in response to detecting the motion (e.g., represented as 1006 at FIGS. 10A-10G) and in accordance with the determination that the user is directing attention to the first portion of the content (e.g., position of 1004 on 1008 at FIG. 10F), In accordance with a determination that the motion is a second amount of motion (e.g., 1006 at FIG. 10F) (e.g., a second direction, intensity, and/or duration), different than the first amount of motion (e.g., different in intensity, direction, and/or duration), displaying the first portion of the content in the second manner includes modifying the set of one or more visual characteristics of the first portion of the content by a second amount different from the first amount (e.g., as discussed at FIGS. 10E-10F). (and/or the second manner). In some embodiments, determining that the motion is the second amount of motion includes determining the force against and/or exerted on the input device, movement of the computer system relative to an object and/or surface (e.g., change as measured from a particular point) or absolute movement of the computer system within the environment (e.g., absolute measurement of displacement of the computer system), direction (e.g., movement in a direction, and/or change in direction), and/or acceleration detected by the input device. In some embodiments, determining that the motion is the second amount of motion includes determining the relative motion of the computer system (e.g., difference in motion as compared to another object, plane, and/or point) (e.g., motion of the computer system relative to a position (e.g., object, position within 3D space, and/or plane within an environment), relative to a direction (e.g., in a direction, from a direction, and/or change of direction), and/or relative to previous motion), and/or absolute motion of the computer system (e.g., motion of the computer system irrespective of external factors and/or motion of the computer system without comparison to an object, position, and/or plane). In some embodiments, the computer system modifies the set of one or more visual characteristics of the first portion of the content by the second amount by changing an amount of the content in the first portion (e.g., adding and/or removing from the content), a visual characteristic (e.g., emphasis, clarity, size, boldness, and/or brightness) of the content, position (e.g., relative to the user interface, the computer system and/or relative to the motion), and/or type of content (e.g., altering the representation of the content (e.g., text to an image and/or video to an image) and/or summarizing). Modifying a portion of content differently based on the intensity of motion allows the computer system to automatically change the manner of the modification without a user selection, thereby performing an operation when a set of criteria has been met without requiring additional input.

In some embodiments, while (e.g., after and/or in conjunction with) displaying the first portion of the content in the second manner, the computer system ceases to detect, via the input device, the attention of the user (e.g., lack of 1004 at FIG. 10E) (and/or detecting that the user is no longer directing attention to the content (and/or the first portion of the content and/or the second portion of the content)) (and/or for a predefined period of time). In some embodiments, ceasing to detect the attention of the user includes ceasing to detect the attention of the user directed at the first portion of the content. In some embodiments, ceasing to detect the attention of the user includes ceasing to detect the attention directed at any respective portion of the content. In some embodiments, in response to ceasing to detect the attention of the user (and/or detecting that the user is no longer directing attention to the content (and/or the first portion of the content and/or the second portion of the content)), the computer system displays, via the display generation component, the first portion of the content in the first manner (e.g., 1008 at FIG. 10E) (e.g., and ceasing display of, via the display generation component, the first portion of the content in the second manner). In some embodiments, displaying the first portion of the content in the first manner includes reverting the changes to the first portion of the content included in the second manner. In some embodiments, displaying the first portion of the content in the first manner includes transitioning the first portion of the content from the second manner to the first manner (e.g., changing the first portion of the content back to the first manner for a predefined amount of time and/or gradually reverting the changes made in the second manner to match the first manner). Reverting a portion of content to its original manner of display based on a user no longer directing attention to the portion of content allows the computer system to selectively modify portions of content without requiring the user revert the portion of the content, thereby performing an operation when a set of criteria has been met without requiring additional input.

In some embodiments, while displaying the first portion of the content in the second manner (e.g., 1008 at FIG. 10C), the computer system ceases to detect, via the input device, the motion (e.g., represented as 1006 at FIGS. 10A-10G) (and/or detecting the absence of the motion) (and/or for a predefined period of time). In some embodiments, in response to ceasing to detect the motion (and/or detecting the absence of the motion), the computer system displays, via the display generation component, the first portion of the content in the first manner (e.g., 1008 at FIG. 10E). In some embodiments, displaying the first portion of the content in the first manner includes reverting the changes to the first portion of the content included in the second manner. In some embodiments, displaying the first portion of the content in the first manner includes transitioning the first portion of the content from the second manner to the first manner (e.g., changing the first portion of the content back to the first manner of a predefined amount of time and/or gradually reverting the changes made in the second manner to match the first manner). Reverting a portion of content to its original manner of display based on no longer detecting motion allows the computer system to selectively modify portions of content without requiring the user revert the portion of the content, thereby performing an operation when a set of criteria has been met without requiring additional input.

In some embodiments, the computer system is in communication with a set of one or more cameras (e.g., as discussed at FIG. 10A). In some embodiments, while detecting the motion (e.g., represented as 1006 at FIGS. 10A-10G) (e.g., or before detecting the motion or after detecting the motion), the computer system detects, via the set of one or more cameras, the attention of the user (e.g., as represented by 1004 in FIGS. 10A-10G), wherein the determination that the user is directing attention to the first portion of the content is based on (and/or uses) the attention of the user detected via the set of one or more cameras (e.g., position of 1004 on 1008 at FIG. 10F), and wherein the determination that the user is directing attention to the second portion of the content is based on (and/or uses) the attention of the user detected via the set of one or more cameras (e.g., position of 1004 on 1014 at FIG. 10D). In some embodiments, the input device is the set of one or more cameras. In some embodiments, the computer system uses the set of one or more cameras along with one or more other input devices to detect the attention of the user to be used with respect to the determination that the user is directing attention to the first portion of the content and/or the determination that the user is directing attention to the second portion of the content. In some embodiments, detecting the attention of the user via the one or more cameras includes detecting gaze input, non-touch input, input corresponding to the computer system, and/or determining the position of a user's eyes in relation to the computer system. In some embodiments, detecting the attention of the user via the one or more cameras includes detecting that the attention of the user is directed to a position within and/or on a user interface, user interface element, content, and/or output device. In some embodiments, detecting the attention of the user via the one or more cameras includes determining a proximity of the user to a position within and/or on a user interface, user interface element, content, and/or output device. Detecting attention of a user through a set of one or more cameras allows the computer system to react to the attention of the user being directed to various portions of content based on the field of view of one or more of the cameras without requiring a user to select the portions of content, thereby performing an operation when a set of conditions has been met without requiring additional input.

In some embodiments, in response to detecting the motion (e.g., represented as 1006 at FIGS. 10A-10G) and in accordance with the determination that the user is directing attention to the second portion of the content (e.g., position of 1004 on 1014 at FIG. 10D) (e.g., and not the first portion of the content), the computer system displays, via the display generation component, the second portion of the content in the second manner (e.g., difference of 1014 from FIG. 10B to 10F) different from the first manner. In some embodiments, the determination that the user is directing attention to the second portion of the content includes a determination that the attention of the user is directed to, within, and/or on a user interface, user interface element, content, and/or output device. In some embodiments, the determination that the user is directing attention to the second portion of the content includes a determination that an input (e.g., gaze input, non-touch input, input corresponding to the computer system determining the position of a user's eyes in relation to the computer system) is directed to the position within and/or on a user interface, user interface element, content, and/or output device. In some embodiments, the determination that the user is directing attention to the second portion of the content includes a determination of proximity of the user to a position within and/or on a user interface, user interface element, content, and/or output device. In some embodiments, in response to detecting the motion and in accordance with the determination that the user is directing attention to the second portion of the content, the computer system changes an amount of the content in the first portion (e.g., adding and/or removing from the content), a visual characteristic (e.g., emphasis, clarity, size, boldness, and/or brightness) of the content, position (e.g., relative to the user interface, the computer system and/or relative to the motion), and/or type of content (e.g., altering the representation of the content (e.g., text to an image and/or video to an image) and/or summarizing). In some embodiments, in response to detecting the motion and in accordance with the determination that the user is directing attention to the second portion of the content the computer system alters the first portion of the content to compensate for the motion (e.g., repositioning, resizing, emphasizing, and/or changing the content within the first portion of the content based on the motion). In some embodiments, in response to detecting the motion and in accordance with the determination that the user is directing attention to the second portion of the content (e.g., and not the first portion of the content), the computer system displays the second portion of content in a third manner different from the second manner and/or the first manner. In some embodiments, the third manner includes the second manner and/or the first manner. In some embodiments, the third manner is additive to the second manner and/or first manner. Selectively modifying portions of content based on a user directing attention to another portion of the content allows the computer system to automatically alter the portions of content that correspond to the user's attention without requiring the user to select the portion of the content, thereby performing an operation when a set of criteria has been met without requiring additional input.

Note that details of the processes described above with respect to method 1100 (e.g., FIG. 11) are also applicable in an analogous manner to other methods described herein. For example, method 800 optionally includes one or more of the characteristics of the various methods described above with reference to method 1100. For example, the display of content can be shifted using one or more techniques described herein in relation to method 800, where the content is shifted based on the detected gaze of a user described herein relation to method 1100. For brevity, these details are not repeated herein.

FIGS. 12A-12L illustrate exemplary user interfaces for altering content based on a state of a user in accordance with some embodiments. The user interfaces in these figures are used to illustrate the processes described below, including the processes in FIG. 13.

The left sides of FIGS. 12A-12L illustrate computer system 1200 as a smart phone displaying different user interface objects. It should be recognized that computer system 1200 can be other types of computer systems with display components such as a tablet, a smart watch, a laptop, a personal gaming system, a desktop computer, a fitness tracking device, and/or a head-mounted display (HMD) device. In some embodiments, computer system 1200 includes and/or is in communication with one or more input devices and/or sensors (e.g., a camera, a LiDAR sensor, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. In some embodiments, computer system 1200 includes and/or is in communication with one or more audio output devices (e.g., speakers, headphones, earbuds, and/or hearing aids). In some embodiments, computer system 1200 includes one or more components and/or features described above in relation to computer system 100, electronic device 200, computer system 400, and/or computer system 700.

FIGS. 12A-12L illustrate computer system 1200 performing various display operations based on detected motions and the vitals of users. Computer system 1200 performs the various display operations to alleviate user discomfort that stems from the detected motion. In some embodiments described below, based on a determination that motion is detected (e.g., motion of computer system 1200, motion of a user, and/or motion of an external structure) computer system 1200 moves displayed content in a direction that is counter to the direction of the detected motion. In some embodiments described below, based on a determination that the vitals of a user are elevated, computer system 1200 further moves display content by an amount that correlates with the increases in the vitals of the user. In some embodiments, computer system 1200 performs the various display operations based on a determination that a speed of computer system 1200 is greater than a speed threshold. In some embodiments, computer system 1200 performs the various display operations based on a determination that an acceleration rate of computer system 1200 is greater than an acceleration threshold.

The right sides of FIGS. 12A-12L include motion diagram 1214 and vitals diagram 1220. As illustrated in FIGS. 12A-12L, motion diagram 1214 indicates the speed and/or direction of the detected motion. In some embodiments, the detected motion is the motion of an external structure that computer system 1200 is positioned within. For example, when the external structure is moving to the left at five miles per hour (“miles-per-hour”), the detected motion is to the left at five miles-per-hour. In some embodiments, the detected motion of computer system 1200 is detected via one or more inertial measurement unit sensors (IMU) of computer system 1200. In some embodiments, the detected motion of computer system 1200 is detected via one or more camera sensors connected to and/or in communication with computer system 700. In some embodiment, the detected motion of computer system 1200 is detected via a combination of methods mentioned above (e.g., IMU and/or camera sensor). In some embodiments, the detected motion is the motion of the head of the user. In some embodiments, the motion of the head of the user is detected via one or more camera sensors connected to and/or in communication with computer system 1200. In some embodiments, the motion of the head of the user is detected via one or more sensors embedded in one or more audio output devices that move with the head of the user such as earbuds and/or headphones. In some embodiments described in FIGS. 12A-12L, the detected motion is an absolute motion. In other embodiments, the detected motion is a relative motion, such as motion of computer system 1200 relative to a vehicle that computer system 1200 is within.

At FIGS. 12A-12L, computer system 1200 is in communication with one or more wearable devices capable of detecting the heart rate and/or respiratory rate of the user, such as a health tracking device and/or smart watch. In FIGS. 12A-12L, vitals diagram 1220 is a visual aid that indicates the detected vitals of the user (e.g., the first user or the second user). As illustrated in FIGS. 12A-12L, vitals diagram 1220 includes heart rate indication 1222 that indicates detected heart rate of the user and respiratory rate indication 1224 that indicates the detected respiratory rate of the user.

The discussion of FIGS. 12A-12I describes that computer system 1200 performs various display operations based on a determination that detected motion is greater than a motion threshold. However, it should be noted that in some embodiments, computer system 1200 performs the various display operations based on a determination that the acceleration rate, rotational rates (rad/s) and/or rotational positions (rad) of the detected motion is greater than a threshold.

FIGS. 12A-12I illustrate computer system 1200 performing various display operations when a first user is using computer system 1200. Vitals diagram 1220 in FIGS. 12A-12I indicate the vitals of the first user. FIGS. 12J-12L illustrate computer system 1200 performing various display operations when a second user (e.g., different from the first user) is using computer system 1200. Vitals diagram 1220 in FIGS. 12J-12L indicate the vitals of the second user. This is to illustrate that computer system 1200 reacts differently to different users. In some embodiments, computer system 1200 determines a level of discomfort of the user based on data (e.g., the appearance of the user and/or how much the user is moving) received via one or more cameras connected to and/or in communication with computer system 1200. Computer system 1200 uses the data in lieu of detected vitals of the user.

In FIGS. 12A-12I, the first user is engaged (e.g., using) computer system 1200. As illustrated in FIG. 12A, computer system 1200 displays the content of user interface 1202, navigation controls section 1204, and status indicator section 1206 via display 1212. As illustrated in FIG. 12A, user interface 1202 includes address bar 1208 and main body 1210. As illustrated in FIG. 12A, computer system 1200 displays main body 1210 with first object 1210a, second object 1210b, and third object 1210c below address bar 1208. As illustrated in FIG. 12A, computer system 1200 displays the objects (e.g., first object 1210a, second object 1210b, and third object 1210c) from left to right across user interface 1202 with first object 1210a displayed at a leftmost position and third object 1210c displayed at a rightmost position. In some embodiments, computer system 1200 displays more or less than three objects within main body 1210.

At FIG. 12A, as indicated by speed representation 1216 indicating zero miles-per-hour, no motion is detected. At FIG. 12A, as indicated by vitals diagram 1220, the vitals of the first user are a heart rate of eighty-two beats per minute, as indicated by heart rate indication 1222 and a respiratory rate of sixteen breaths per minute, as indicated by respiratory rate indication 1224. After FIG. 12A, motion in the rightward direction is detected (e.g., via one or more techniques discussed above).

At FIG. 12B, as indicated by motion diagram 1214, the detected motion is a right-hand turn at ten miles-per-hour. At FIG. 12B, speed representation 1216 indicates that the speed of the motion is ten miles-per-hour and direction representation 1218 indicates the direction of the motion is to the right. At FIG. 12B, a determination is made that a magnitude of the detected motion is not greater than a motion threshold (e.g., fifteen miles-per-hour). At FIG. 12B, based on the determination that the magnitude of the detected motion is not greater than the motion threshold, computer system 1200 does not change the display (e.g., does not alter) the display of user interface 1202. That is, computer system 1200 does not alter the appearance of user interface 1202 based on the detection of insignificant amounts of motion. After FIG. 12B, an increase in the speed of the detected motion is detected via one of the techniques discussed above.

FIGS. 12C-12D illustrate a process of shifting content off of display 1212 based on a determination that the magnitude of detected motion is greater than the motion threshold and the direction of the detected motion is in a particular direction. At FIG. 12C, computer system 1200 blurs and/or otherwise deemphasizes the content that will be shifted off of display 1212 and at FIG. 12D computer system 1200 shifts the display of content off of display 1212.

At FIG. 12C, as indicated by motion diagram 1214, the speed of the detected motion is twenty miles-per-hour and the direction of the detected motion is to the right. At FIG. 12C, a determination is made that a magnitude of the detected motion is greater than the motion threshold and a determination is made that the detected motion is in a rightward direction. At FIG. 12C, because the determination is made that the magnitude of the detected motion is greater than the motion threshold and the direction of the detected motion is to the right, computer system 1200 blurs and/or otherwise deemphasizes the left side of first object 1210a. Computer system 1200 blurs and/or otherwise deemphasizes displayed content as a preliminary measure to indicate what content will be shifted off of display 1212 as a result of the determination that the magnitude of the detected motion is greater than the motion threshold and the determination that the detected motion is to the right. At FIG. 12C, a change in the vitals of the first user is not detected.

At FIG. 12D, after computer system 122 has blurred the left side of first object 1210a, computer system 1200 shifts main portion 1210 (e.g., first object 1210a, second object 1210b, and third object 1210c) to the left by an amount that correlates to the magnitude of the detected motion. More specifically, at FIG. 12D, based on the determination that the magnitude of the detected motion is greater than the motion threshold and the direction of the detected motion is to the right, computer system 1200 shifts main body 1210 to the left within user interface 1202 by an amount that correlates to the magnitude of the detected motion. Computer system 1200 shifts main body 1210 to the left to help alleviate discomfort the first user is experiencing as a result of the motion. More specifically, computer system 1200 shifts the display of content included in main body 1210 in a direction that is opposite the direction of the detected motion such that the forces that the first user is experiences as a result of the detected motion align with what the first user views.

As illustrated in FIG. 12D, as a result of computer system 1200 shifting main body 1210 to the left within user interface 1202 by the amount that correlates to the magnitude of the detected motion, computer system 1200 continues to display a right portion of first object 1210a while ceasing to display a left portion of first object 1210a. As illustrated in FIG. 12D, as a result of computer system 1200 shifting main body 1210 to the left within user interface 1202 by the amount that correlates to the magnitude of the detected motion, computer system 1200 displays a left portion of fourth object 1210d. In some embodiments, computer system 1200 shifting main body 1210 to the left by the amount that corresponds to the magnitude of the detected motion does not result in computer system 1200 displaying any part of fourth object 1210d. As illustrated in FIG. 12D, computer system 1200 continues to display address bar 1208 in the same location within user interface 1202 as computer system 1200 displays address bar 1208 in FIG. 12C. That is, based on a determination that that the magnitude of the motion is greater than the motion threshold and the direction of the detected motion is to the right, computer system 1200 shifts the display of certain content without shifting the display of other content. After FIG. 12D, an increase in the magnitude of the motion is detected via one of the techniques discussed above.

FIGS. 12E1 and 12F1 include a second representation of computer system 1200 to illustrate how computer system 1200 displays the content of user interface 1202 if computer system 1200 does not detect a rise in the vitals of the first user.

At FIG. 12E1, as indicated by motion diagram 1214 the detected motion has a speed of twenty-five miles-per-hour and is in the rightward direction. At FIG. 12E1, a determination is made that a magnitude of the detected motion is above the motion threshold and a determination is made that the direction of motion is to the right. At FIG. 12E1, a determination is made that the vitals of the first user (e.g., the heart rate and/or the respiratory rate) of the first user increases above a vitals threshold. At FIG. 12E1, based on the determinations that the magnitude of the detected motion is above the motion threshold and the motion is in a rightward direction, computer system 1200 continues to shift main body 1210 to the left. The amount that computer system 1200 shifts main body 1210 corresponds to the magnitude of the detected motion. Accordingly, at FIG. 12E1, because the speed of the detected motion is twenty-five miles per hour (e.g., greater than the speed of the detected motion at FIG. 12D), computer system 1200 shifts main body 1210 by a larger magnitude than the shift of main body at FIG. 12D.

At FIG. 12E1, by heart rate indication 1222, the heart rate of the first user is one-hundred and fifteen beats per minute (e.g., above the heart rate of the first user of eighty-two beats per minute at FIG. 12D) and, as indicated by respiratory rate indication 1224, the respiratory rate of the first user is twenty-three breaths per minute (e.g., above the respiratory rate of sixteen indicated in FIG. 12D). At FIG. 12E, a determination is made that the vitals of the first user are greater than a vitals threshold. Based on the determination that the vitals of the first user are greater than the vitals threshold computer system 1200 uniformly ceases the display of a portion of the content along the perimeter of main body 1210. Computer system 1200 uniformly ceases the display of the portion of the content along the perimeter of main body 1210 to help alleviate discomfort the first user is feeling as a result of the detected motion. That is, computer system 1200 performs additional motion mitigation techniques when the current motion mitigation techniques being performed by the computer system 1200 are inadequate.

FIG. 12E2 depicts the display of main body 1210 when the vitals of the user do not increase above the threshold. At FIG. 12E2, computer system 1200 shifts the content included in main body 1210 based on the speed and/or direction of the detected motion. Accordingly, because at FIG. 12E2 the detected motion has a speed of twenty-five miles-per-hour to the right, as opposed to the speed of twenty miles-per-hour the detected motion had at FIG. 12D, computer system 1200 shifts the content included in main body 1210 to the left by a larger magnitude than the amount computer system 1200 shifts the content included in main body 1210 at FIG. 12D. Either of FIGS. 12E1 or FIG. 12E2 can follow FIG. 12D.

Between FIGS. 12E1 and FIGS. 12F1, the vitals of the first user further increase. At FIG. 12F1, as indicated by heart rate indication 1222, the heart rate of the user is one-hundred and twenty-nine beats per minute and, as indicated by respiratory rate indication 1224, the respiratory rate of the first user is twenty-seven breaths per minute. At FIG. 12F1, a determination is made that the difference between the vitals of the first user and the vitals threshold increases. Based on the determination that the difference between the vitals of the first user and the vitals threshold increases, computer system 1200 uniformly ceases to display an additional portion of the content along the perimeter of main body 1210. Accordingly, at FIG. 12F1, computer system 1200 displays less of second object 1210b and third object 1210c than what computer system 1200 displayed at FIG. 12E1. Computer system 1200 ceases more of the display of content included within main body to increase the magnitude of the motion mitigation technique that computer system 1200 performs. In some embodiments, computer system 1200 ceases to display of the additional portion of the content along the perimeter of main body 1210 when the increase of the vitals of the user is greater than a threshold.

FIG. 12F2 depicts the display of main body 1210 when the difference between the vitals threshold and the vitals of the first user does not increase. At FIG. 12F2, computer system 1200 shifts the content included in main body 1210 based on the speed and/or direction of the detected motion. Accordingly, at FIG. 12F2, because the detected motion has a speed of twenty-five miles-per-hour to the right (e.g., the same speed of direction as the detected motion at FIG. 12E2, computer system 1200 shifts the content included in main body 1210 to the left by the same magnitude that computer system 1200 shifts the content included in main body 1210 at FIG. 12E2.

Between FIGS. 12F1 and FIG. 12G, the vitals of the first user decrease. At FIG. 12G, as indicated by heart rate indication 1222, the heart rate of the first user is eighty-two (e.g., below the heart rate of one-hundred-twenty-nine indicated in FIG. 12F1) beats per minute and as indicated by the respiratory rate indication 1224 the respiratory rate of the first user is sixteen breaths per minute (e.g., below the respiratory rate of twenty-seven indicated in FIG. 12F). At FIG. 12G, a determination is made that the vitals of the first user are not above the threshold.

At FIG. 12G, based on the determination that the detected vitals of the first user are not above the vitals threshold, computer system 1200 does not uniformly cease to display content included around the perimeter of main body 1210. As illustrated in FIG. 12G, based on the determination that the detected vitals of the first user are not above the vitals threshold, computer system 1200 displays the user interface 1202 to the edges of display 1212. In some embodiments, computer system 1200 detects a decrease in the vitals of the first user equal to a heart rate of one-hundred-fifteen and a respiratory rate of twenty-three (e.g., the same level vitals as indicated in FIG. 12E). In such embodiments, a determination is made that the detected vitals of the first user are above the vitals threshold, which results in computer system 1200 displaying the same amount of user interface 1202 as computer system 1200 displaying in FIG. 12E.

At FIG. 12G, as indicated by motion diagram 1214, the speed of the detected motion is twenty-five miles-per-hour and the direction of the detected motion is to the right. At FIG. 12G, a determination is made that the magnitude of the detected motion is greater than the motion threshold and a determination is made that the detected motion is in a rightward direction. At FIG. 12C, because a determination is made that the magnitude of the detected motion is greater than the motion threshold and the direction of the detected motion is to the right, computer system 1200 continues to shift the content included main body 1210 to the left by an amount that correlates to the magnitude of the detected motion. Accordingly, the content included within main body 1210 at FIG. 12G is shifted further to the left than the shift of the content included within main body 1210 at FIG. 12D when the detected motion had a speed of twenty miles per hour. Between FIGS. 12G and 12H, the motion ceases to be detected.

At FIG. 12H, as indicated by motion diagram 1214, there is no detected motion. At FIG. 12H, a determination is made that there is no detected motion. At FIG. 12H, based on the determination that there is no detected motion, computer system 1200 ceases to shift the content included within main body 1210. At FIG. 12D, because computer system 1200 ceases to shift the content included within main body 1210, computer system 1200 does not display any portion of fourth object 1210d and computer system 1200 displays the entirety of first object 1210a, second object 1210b, and third object 1210c. In some embodiments, computer system 1200 continues to shift the content included within main body 1210 when a determination is made that there is no detected motion. In some embodiments, computer system 1200 ceases to shift the content included within main body 1210 based on a determination that the magnitude of the detected motion is below the motion threshold. Between FIGS. 12H and 12I, the detected motion is reinitiated at a speed of twenty-five miles-per-hour in the leftward direction.

At FIG. 12I, as indicated by motion diagram 1214, the speed of the detected motion is twenty-five MPH and the direction of the detected motion is to the left. At FIG. 12I, a determination is made that a magnitude of the detected motion is greater than the motion threshold and a determination is made that the detected motion is in a leftward direction. At FIG. 12I, because the determination is made that the magnitude of the detected motion is greater than the motion threshold and the direction of the detected motion is in the leftward direction, computer system 1200 shifts content included within main body 1210 to the right by an amount that correlates to the magnitude of the detected motion. As explained earlier, in order to help alleviate discomfort the first user may feel as a result of the detected motion, computer system 1200 shifts the display of content in an opposite direction than the direction of the detected motion. Accordingly, at FIG. 12I, because the detected motion is to the left (e.g., as opposed to the detected motion being to the right in FIGS. 12A-12I) computer system 1200 shifts the content included within main body 1210 to the right (e.g., as opposed to the leftward shift the content as discussed above).

In FIGS. 12J-12L, the second user is engaged with computer system 1200. Accordingly, vitals diagram 1220 at FIGS. 12J-12L correspond to the vitals of the second user. At FIG. 12J, as indicated by motion diagram 1214, the speed of the detected motion is twenty miles-per-hour and the direction of the detected motion is to the right. At FIG. 12J, a determination is made that a magnitude of the detected motion is above the motion threshold and a determination is made that the direction of the detected motion is to the right. At FIG. 12J, based on the determination that the magnitude of the detected motion is above the motion threshold and based on the determination that the direction of the detected motion is to the right, computer system 1200 shifts main body 1210 (e.g., including first object 1210a, second object 1210b, and third object 1210c) to the left within user interface 1202 by an amount that correlates to the magnitude of the detected motion.

However, at FIG. 12J, computer system 1200 shifts the content included within main body 1210 by a greater amount than when computer system 1200 shifted the content included within main body 1210 at FIG. 12C when the speed of the detected motion was twenty miles-per-hour and the first user was engaged with computer system 1000. That is, the amount that computer system 1200 shifts the content included within main body 1210 can be user specific. Because certain users require a larger magnitude of motion mitigation in order to alleviate discomfort felt as a result of the detected motion, computer system 1200 takes into account which user is using computer system 1200 when computer system 1200 determines how much to shift the content included within main body 1210. Between FIGS. 12J and 12K1 the vitals of the second user increase.

At FIG. 12K1, a determination is made that the detected motion has a speed of twenty miles-per-hour and a rightward direction. At FIG. 12K1, computer system 1200 continues to shift the content included in main body 1210 based on the speed and/or direction of the detected motion. Accordingly, because at FIG. 12K1 the detected motion has a speed of twenty miles-per-hour to the right, computer system 1200 shifts the content included in main body 1210 to the left by the same amount as the amount computer system 1200 shifts the content included in main body 1210 at FIG. 12J.

At FIG. 12K, as indicated by heart rate indication 1222, the heart rate of the user is one-hundred and nineteen beats per minute (e.g., above the heart rate of seventy-one indicated in FIG. 12J) and, as indicated by respiratory rate indication 1224, the second user has a respiratory rate of twenty-four breaths per minute (e.g., above the respiratory rate of fourteen indicated in FIG. 12J). At FIG. 12K1, a determination is made that the heart rate and respiratory rate of the second user increases above the vitals threshold.

At FIG. 12K1, based on the determination that the heart rate and respiratory rate of the second user increases above the vitals threshold, computer system 1200 ceases to display content around the perimeter of main body 1210. Computer system 1200 ceases to display the portion of the content around the perimeter of main body 1210 to help alleviate discomfort the second user is feeling as a result of the detected motion. That is, computer system 1200 performs additional motion mitigation techniques when the current motion mitigation techniques being performed by the computer system 1200 are not adequate. In some embodiments, the amount of the content that computer system 1200 ceases to display is dependent on the amount of the increase of the vitals of the second user. In some embodiments, the amount of the content that computer system 1200 ceases to display is dependent on which user is engaged with computer system 1200. For example, based on a determination that that the vitals of the user increases above the vitals threshold, computer system 1200 ceases to display a larger amount of content around the periphery of main body 1210 when the first user is using computer system 1200 than when the second user is using computer system 1200.

FIG. 12K2 depicts the display of main body 1210 when the vitals of the second user do not increase above the vitals threshold. At FIG. 12K2, computer system 1200 continues shifting the content included in main body 1210 based on the speed, direction and/or acceleration of the detected motion. Accordingly, because at FIG. 12K2 the detected motion has a speed of twenty miles-per-hour to the right, computer system 1200 shifts the content included in main body 1210 to the left by the same amount as the amount computer system 1200 shifts the content included in main body 1210 at FIG. 12J. At FIG. 12K2, computer system 1200 does not cease to display content around the perimeter of main body 1210 because the vitals of the second user do not increase above the vitals threshold.

At FIG. 12L, as indicated by heart rate indication 1222, the heart rate of the second user is seventy-one beats per minute and, as indicated by respiratory rate indication 1224, the second user has a respiratory rate of fourteen breaths per minute. At FIG. 12L, a determination is made that the vitals of the user are not greater than the vitals threshold. At FIG. 12L, because the determination is made that the vitals of the user are not greater than the vitals threshold, computer system 1200 forgoes ceasing display of content around the perimeter of main body 1210.

At FIG. 12L, a determination is made that the speed of the detected motion is greater than the motion threshold and a determination is made that the detected motion is in the rightward direction. Because the determinations are made that the magnitude of the detected motion is greater than the motion threshold and the detected motion is in the rightward direction, computer system 1200 continues to shift the content included within main body 1210 to the left by an amount that corresponds to the magnitude of the detected motion.

In some embodiments, based on a determination that the magnitude of detected motion is above the motion threshold, computer system 1200 changes how computer system 1200 displays content of different applications differently. For example, based on the determination that the magnitude of detected motion is greater than the motion threshold, computer system 1200 shifts content of a weather application installed on computer system 1200 by a first amount and computer system 1200 shifts content of an e-mail application installed on computer system 1200 by a second amount different from the first amount. In some embodiments, computer system 1200 does not alter the display of a user interface for a respective application when a determination is made that the magnitude of the detected motion is above the motion threshold.

In some embodiments, computer system 1200 does not change the display of content based on a determination that the magnitude of detected motion is above the motion threshold that if computer system 1200 has not detected the attention of the user (e.g., the first user and/or the second user) for a predetermined period. In some embodiments, computer system 1200 does not change how computer system 1200 displays the content based on a determination that the magnitude of the detected motion is above the motion threshold if a determination is made that the attention of the user (the first user and/or the second user) is not directed at computer system 1200. In some embodiments, computer system 1200 reverts a change to the displayed content made as a result of a determination that the magnitude of the detected motion is greater than the motion threshold in response to detecting a user input.

FIG. 13 is a flow diagram illustrating a method (e.g., method 1300) for altering content based on a state of a user in accordance with some embodiments. Some operations in method 1300 are, optionally, combined, the orders of some operations are, optionally, changed, and some operations are, optionally, omitted.

As described below, method 1300 provides an intuitive way for altering content based on a state of a user. Method 1300 reduces the cognitive burden on a user, thereby creating a more efficient human-machine interface. For battery-operated computing devices, enabling a user to interact with such devices faster and more efficiently conserves power and increases the time between battery charges.

In some embodiments, method 1300 is performed at a computer system (e.g., 1200) (e.g., a watch, a phone, a tablet, a fitness tracking device, a processor, a head-mounted display (HMD) device, a communal device, a media device, a speaker, a television, and/or a personal computing device) that is in communication with (e.g., and/or includes) an input device (e.g., a motion detection device (e.g., gyroscope, force meter, accelerometer, and/or internal or external component able to detect and/or measure motion), a camera (e.g., one or more cameras with different fields of view in relation to the computer system (e.g., front, back, wide, zoom, and/or combinations thereof)), a depth sensor, a microphone, a hardware input mechanism, a rotatable input mechanism, a heart monitor, a temperature sensor, and/or a touch-sensitive surface) and a display generation component (e.g., 1212) (e.g., a display screen, a projector, and/or a touch-sensitive display). In some embodiments, the computer system is in communication with (e.g., and/or includes) an output device (e.g., an audio component (e.g., smart speaker, home theater system, soundbar, headphone, earphone, earbud, speaker, television speaker, augmented reality headset speaker, audio jack, optical audio output, Bluetooth audio output, and/or HDMI audio output), a speaker, a haptic output device, a display screen, a projector, and/or a touch-sensitive display).

While displaying, via the display generation component, content (e.g., 1204, 1206, 1208, 1210a, 1210b, 1210c) (e.g., one or more user interfaces, one or more user interface objects, one or more images, text, and/or one or more characters), the computer system detects (1302), via the input device, motion (e.g., represented by 1212, 1216, and/or 1218) (e.g., motion of the computer system, motion of a user, and/or motion of an external structure) (e.g. translational motion and/or rotational motion) (e.g., relative motion and/or absolute motion). In some embodiments, the motion is detected via one or more cameras that captures movement of a user. In some embodiments, the motion is detected via a wearable device of the user.

In response to (1304) detecting the motion, the computer system continues (1306) display of, via the display generation component, a first portion of the content (e.g., remaining portions of 1210a, 1210b, 1210c, and/or 1210d at FIG. 7D) (e.g., less than the entirety of the content, a minority of the content, and/or a majority of the content).

In response to (1304) detecting the motion, the computer system ceases (1308) display of, via the display generation component, a second portion of the content (e.g., represented by partially blurred portion of 1210a at FIG. 12C) (e.g., less than the entirety of the content, a minority of the content, and/or a majority of the content) different from the first portion of the content. In some embodiments, the computer system ceases to display the second portion of the content based on the motion (e.g., if the motion is a leftward turn, the second portion of the content is a right portion of the content or if the motion is a rightward turn, the second portion of the content is a left portion of the content).

While (e.g., after and/or in conjunction) forgoing (e.g., ceasing) display of the second portion of the content (and/or displaying the first portion of the content), the computer system continues (1310) to detect, via the input device, the motion. In some embodiments, continuing to detect the motion includes detecting an acceleration and/or a deacceleration of the computer system.

In response to (1312) continuing to detect the motion (e.g., and while continuing display of the first portion of the content), in accordance with a determination that a user (e.g., represented by 1222, 1224, and/or 1228 in 1220 at FIGS. 12A-12L) (e.g., a user of the computer system, a non-user of the computer system, and/or a passenger (e.g., a primary passenger or a non-primary passenger) in a vehicle (e.g., an automobile, airplane, boat, and/or train)) satisfies a first set of one or more criteria (e.g., increased 1222 and/or 1224 at FIG. 12E) (e.g., one or more vital signs (e.g., the heart rate, respiratory rate, stress levels, body temperature, and/or blood pressure) of the subject is above or a threshold, amount of movement of the subject is above a threshold, subject is not detectable by the computer system, subject has not interacted with the computer system for a predetermined period of time, computer system has not detected the gaze of the for a predetermined period of time (e.g., 10-360 seconds) the eyes of the subject are closed), the computer system ceases (1314) display of, via the display generation component, a third portion of the content (e.g., difference between top and bottom portion of FIG. 12E) (e.g., 1210b, 1210c, 1210d at FIG. 12E) (e.g., and continuing to display the first portion of the content and/or a fourth portion (e.g., included in the first portion) of the content different from the first portion of the content) different from the first portion of the content and the second portion of the content, wherein the third portion of the content includes the second portion of the content.

In response to (1312) continuing to detect the motion, in accordance with a determination that the user does not satisfy the first set of one or more criteria (e.g., baseline 1222 and/or 1224 at FIG. 12A-12D) (e.g., one or more vital signs (e.g., the heart rate, respiratory rate, stress levels, body temperature, and/or blood pressure) of the subject is above or a threshold, amount of movement of the subject is below a threshold, subject is detectable by the computer system, subject has interacted with the computer system within a predetermined period of time, computer system has detected the gaze of the for a predetermined period of time (e.g., 10-360 seconds)), the computer system continues (1316) display of, via the display component, the first portion of the content without ceasing display of the third portion of the content. In some embodiments, the computer system displays all of the content in response to ceasing to detect the motion. In some embodiments, computer system displays all of the content in response to detecting that a characteristic (e.g., speed, acceleration, and/or deacceleration) of the motion is beneath a threshold. In some embodiments, the first set of one or more criteria is user specific. In some embodiments, while the computer system continues to detect the motion, in response to continuing to detect the motion and in accordance with a determination that the user does not satisfy the first set of one or more criteria, the computer system ceases displaying a third portion of the content (e.g., the third amount of the content is less than the second amount and/or the third amount of content is equal to, greater than, or less than the first amount). Ceasing to display the third portion of the content when a set of prescribed conditions is met (e.g., the user satisfies the first set of one or more criteria) automatically allows the computer system to perform additional motion mitigation measures when the current motion mitigation measures are not sufficient, thereby performing an operation when a set of conditions has been met without requiring further user input.

In some embodiments, the first set of one or more criteria includes a criterion that is satisfied when a determination is made that a set of one or more vitals (e.g., represented by 1222, 1224, and/or 1228 in 1220 at FIGS. 12A-12L) (e.g., heartrate, respiratory rate, blood pressure, body temperature, blood glucose level, and/or blood oxygen level) of the user is greater than a threshold (e.g., increased 1222 and/or 1224 at FIG. 12E). In some embodiments, the criterion is not satisfied when a determination is made that the set of one or more vitals of the user is less than the threshold. In some embodiments, the threshold is selected by the user or by the computer system. In some embodiments, the threshold is user specific. In some embodiments, the threshold is motion specific. In some embodiments, the computer system changes the threshold in response to detecting an input from the user. In some embodiments, the threshold is context specific (e.g., context of the user, context of the computer system and/or context of an external structure that the user and/or the computer system are positioned within). Ceasing display of the third portion of the content when a determination is made that one or more vitals of the user is greater than the threshold automatically allows the computer system to perform additional motion mitigation measures when the current motional mitigation measures are not adequate for the user, thereby performing an operation when a set of conditions has been met without requiring further user input and/or providing additional control options without cluttering the user interface with additional displayed controls

In some embodiments, the set of one or more vitals (e.g., represented by 1222, 1224, and/or 1228 in 1220 at FIGS. 12A-12L) is detected via a wearable device (e.g., a smartwatch, fitness tracker, and/or a head-mounted device) of the user (e.g., as discussed at FIGS. 12A-12L). In some embodiments, the set of one or more vitals are not detected via a wearable device. In some embodiments, the computer system is in communication (e.g., wireless and/or wired communication) with the wearable device. In some embodiments, the set of one or more vitals is detected via a set of one or more cameras (e.g., cameras of the computer system and/or cameras external to the computer system). In some embodiments, the vitals are detected via the wearable device and the set of one or more cameras.

In some embodiments, the first set of one or more criteria includes a criterion that is satisfied when a determination is made that the user has a first appearance (e.g., as discussed above at FIGS. 12A-12L) (e.g., the eyes of the user are closed, the user is sweating, the attention of the user is not directed at the computer system, the eyes of the user are dilated, and/or the user appears drowsy). In some embodiments, the criterion is not satisfied when a determination is made that the user does not have the first appearance. In some embodiments, the appearance of the user is detected via one or more cameras that the computer system is in communication with. In some embodiments, the first set of one or more criteria includes a criterion that is satisfied when a determination is made that the user had the first appearance withing a predetermined period of time (e.g., 1-15 seconds). Ceasing display of the third portion of the content based on the appearance of the user automatically allows the computer system to perform additional motion mitigation measures when the current motional mitigation measures are not adequate for the user, thereby performing an operation when a set of conditions has been met without requiring further user input and/or providing additional control options without cluttering the user interface with additional displayed controls.

In some embodiments, while forgoing display of the third portion of the content (e.g., 1210b, 1210c, and/or 1210d at FIG. 12D) (e.g., while one or more vitals of the user are elevated over a threshold and/or while detecting the motion), the computer system detects, via the input device, (e.g., and/or via a wearable device of the user (e.g., a smartwatch and/or a fitness tracker), via one or more sensors of the computer system, and/or one or more cameras of the computer system) that a set of one or more vitals (e.g., represented by 1222, 1224, and/or 1228 in 1220 at FIGS. 12A-12L) (e.g., heartrate, respiratory rate, blood pressure, body temperature, blood glucose level, and/or blood oxygen level) of the user increases (e.g., increased 1222 and/or 1224 at FIG. 12E) (e.g., increases by a predetermined magnitude, increases over a threshold, and/or increases by a predetermined percentage) (and/or worsens). In some embodiments, in response to detecting that the set of one or more vitals of the user increases, the computer system ceases display of, via the display generation component (e.g., 1212), a fourth portion of the content (e.g., 1210b, 1210c, 1210d at FIG. 12E) (e.g., a minority of the displayed content or a majority of the displayed content) different from the first portion of content, the second portion of content and the third portion of content, wherein the fourth portion of content includes the third portion of the content (e.g., the fourth portion is larger than the third portion). In some embodiments, the fourth portion does not include the third portion. In some embodiments, the fourth portion does not include the first portion. In some embodiments, the computer redisplays the fourth portion while forgoing display of the third portion in accordance with a determination that the vitals of the user decreases. Ceasing display of the fourth portion of the content in response to detecting that the set of one or more vitals of the user increases allows the computer system to perform additional motion mitigation techniques to provide additional help in alleviating discomfort a user is experiencing as a result of the motion, thereby providing additional control options without cluttering the user interface with additional displayed controls and/or providing improved feedback.

In some embodiments, detecting that the set of one or more vitals (e.g., represented by 1222, 1224, and/or 1228 in 1220 at FIGS. 12A-12L) of the user increases includes detecting that a magnitude (e.g., average magnitude, absolute magnitude, and/or median magnitude) of the set of one or more vitals of the user increases over a threshold (e.g., as discussed at FIGS. 12D-12E) (e.g., a default threshold and/or a user specific threshold). In some embodiments, detecting that the set of one or more vitals of the user increases does not include detecting that the magnitude of the set of one or more vitals of the user increases over the threshold. In some embodiments, detecting that the set of one or more vitals of the user increases includes detecting that the magnitude increases by a particular percentage. In some embodiments, detecting that the set of one or more vitals of the user increases includes detecting that the magnitude increases by a particular amount. In some embodiments, the magnitude is an absolute value of the motion. Ceasing display of the fourth portion of the content in response to detecting that the set of one or more vitals of the user increases over a threshold allows the computer system to not cease the display of content based on insignificant increases in the vitals of the user, thereby providing additional control options without cluttering the user interface with additional displayed controls and/or providing improved feedback.

In some embodiments, in accordance with a determination that the set of one or more vitals (e.g., represented by 1222, 1224, and/or 1228 in 1220 at FIGS. 12A-12L) of the user increases by a first magnitude (e.g., difference between 1220 and/or 1224 at FIGS. 12D and 12E) (e.g., 5%, 10%, 15% or 20%), the fourth portion of the content (e.g., 1210b, 1210c, 1210d at FIG. 12E) includes a first amount of the content (e.g., as discussed at FIG. 12E) (e.g., a majority of the content or a minority of the content, a percentage of the content). In some embodiments, in accordance with a determination that the set of one or more vitals of the user increases by a second magnitude (e.g., difference between 1220 and/or 1224 at FIGS. 12E and 12F) (e.g., 5%, 10%, 15% or 20%) different from the first magnitude, the fourth portion of the content includes a second amount of the content (e.g., as discussed at FIG. 12F) (e.g., a majority of the content or a minority of the content) different from the first amount of the content. In some embodiments, the first magnitude is greater than the second magnitude and the first amount of content is greater than the second amount of content or vice versa. In some embodiments, the first magnitude is greater than the second magnitude and the second amount of content is greater than the first amount of content or vice versa. In some embodiments, the fourth portion of the content includes an amount of the content irrespective of the vitals of the user. In some embodiments, the amount of the content included in the fourth portion varies as the set of one or more vitals of the user varies. In some embodiments, the magnitude is an absolute value of the motion. In some embodiments, ceasing to display a particular amount of the content when a set of prescribed conditions is met (e.g., the user's vitals increase by a particular amount) automatically allows the computer system to provide an indication of the state of the vitals of the user, thereby performing an operation when a set of conditions has been met without requiring further user input.

In some embodiments, while forgoing display of the third portion of the content (e.g., difference between top and bottom portion of FIG. 12E) (e.g., 1210b, 1210c, 1210d at FIG. 12E) (e.g., and/or while the user satisfies the first set of one or more criteria), the computer system continues to detect, via the input device, the motion (e.g., represented by 1212, 1216, and/or 1218) (e.g., and/or separate motion). In some embodiments, continuing to detect the motion includes detecting a change in one or more characteristics of the motion. In some embodiments, in response to continuing to detect the motion and in accordance with a determination that the user does not satisfy the first set of one or more criteria, the computer system displays, via the display generation component (e.g., 1212), the third portion of the content (e.g., and the first portion of the content) without displaying a fourth portion of the content (e.g., 1210b, 1210c, 1210d at FIG. 12H) different from the third portion of the content. In some embodiments, the fourth portion of the content is the same the second portion. In some embodiments, in response to continuing to detect the motion and in accordance with the determination that the user does not satisfy the first set of one or more criteria, the computer system displays the third portion of the content and the second portion of the content. In some embodiments, in response to continuing to detect the motion and in accordance with the determination that the user satisfies the first set of one or more criteria, the computer system continues to forgo display of the third portion of the content. Displaying the third portion of the content without displaying the fourth portion of the content when a set of prescribed conditions is met automatically allows the computer system to cease performing motion mitigation techniques when the motion mitigation techniques are no longer necessary, thereby performing an operation when a set of conditions has been met without requiring further user input.

In some embodiments, detecting the motion (e.g., represented by 1212, 1216, and/or 1218) includes detecting that a magnitude (e.g., an average media or a media magnitude) of the motion is greater than a threshold (e.g., as discussed at 12E-12F) (e.g., a threshold that is selected by the user and/or a threshold that is selected by the computer system). In some embodiments, the threshold is a user specific threshold. In some embodiments, the threshold is a context specific threshold. In some embodiments, the magnitude is an absolute value of the motion. In some embodiments, the magnitude of the motion is not greater than the threshold. Ceasing display of the second portion of the content in response to detecting that the magnitude of the motion is greater than a threshold allows the computer system to not cease the display of content based on the detection of insignificant amount of motion, thereby performing an operation when a set of conditions has been met without requiring further user input.

In some embodiments, while forgoing display of a fourth portion of the content (e.g., 1210a, 1210b, 1210c, and/or 1210d at FIG. 12G) (e.g., the second portion, the third portion of the content and/or a portion of content different from the second portion and/or the third portion), the computer system ceases to detect, via the input device, the motion (e.g., and/or any motion). In some embodiments, in response to ceasing to detect the motion, the computer system displays, via the display generation component (e.g., 1212), the content (e.g., 1210a, 1210b, and/or 1210c at FIG. 12H) without forgoing display of the fourth portion (e.g., any portion) of the content (e.g., the computer system displays the entirety of the content) (e.g., the computer system redisplays the fourth portion of the content and/or any of portion of the content that the computer system did not display prior to ceasing to detect the motion). In some embodiments, in response to ceasing to detect the motion, the computer system continues to forgo display of the fourth portion of the content. In some embodiments, the computer system displays the content without forgoing display of a portion of the content in response to detecting an input. Displaying the content without forgoing display of the fourth portion of the content in response to ceasing to detect the motion allows the computer system to provide a state of the computer system and/or a state of the user (e.g., the computer system and/or the user are not in motion), thereby performing an operation when a set of conditions has been met (e.g., no motion is detected) without requiring further user input, providing additional control options without cluttering the user interface with additional displayed controls and/or providing improved feedback.

In some embodiments, while forgoing display of a fourth portion of the content (e.g., 1210a, 1210b, 1210c, and/or 1210d at FIG. 12D) (e.g., the second portion and/or the third portion of the content), the computer system continues to detect, via the input device, the motion (e.g., represented by 1212, 1216, and/or 1218). In some embodiments, continuing to detect the motion includes detecting a change in one or more characteristics (e.g., acceleration, deacceleration, turning force, direction, and/or direction) In some embodiments, in response to continuing to detect the motion and in accordance with a determination that the motion is less than a threshold (e.g., as discussed at FIG. 12B) (e.g., a user defined threshold, a computer system defined threshold, or a default threshold) (e.g., while continuing to detect the motion), the computer system displays, via the display generation component (e.g., 1212), the content without forgoing display of the fourth portion (e.g., any portion) of the content (e.g., 1210a, 1210b, and/or 1210c at FIG. 12B) (e.g., the computer system displays the entirety of the content) (e.g., the computer system redisplays the fourth portion of the content and/or any of portion of the content that the computer system did not display prior to ceasing to detect the motion). In some embodiments, in response to continuing to detect the motion and in accordance with a determination that the motion is greater than the threshold, the computer system continues to forgo display of the respective portion of the content. Displaying the content without forgoing display of the fourth portion of the content when a set of conditions is met (e.g., the motion is less than a threshold) automatically allows the computer system to provide a state of the computer system and/or a state of the user (e.g., the computer system and/or the user are coming to a rest), thereby performing an operation when a set of conditions has been met without requiring further user input, providing additional control options without cluttering the user interface with additional displayed controls and/or providing improved feedback.

In some embodiments, continuing to detect the motion includes detecting, via the input device, a change in one or more characteristics (e.g., speed, acceleration, deacceleration, direction and/or turning force) of the motion (e.g., as discussed at FIGS. 12A-12L). In some embodiments, the change in the one or more characteristics of the motion is greater than a threshold. In some embodiments, the change in the one or more characteristics of the motion happens without user intervention. In some embodiments, continuing to detect the motion does not include detecting a change in one or more characteristics of the motion.

In some embodiments, in response to continuing to detect the motion (e.g., represented by 1212, 1216, and/or 1218) and in accordance with the determination that the user satisfies the first set of one or more criteria, the computer system displays, via the display generation component (e.g., 1212), a fourth portion of the content (e.g., 1210a, 1210b, 1210c) (e.g., a majority of the content or a minority of the content) different from the first portion of the content. In some embodiments, the fourth portion of the content includes more content or less content than the third portion of the content. In some embodiments, the first portion of the content includes more content or less content than the fourth portion of the content. In some embodiments, the fourth content separates the second and the third content. Displaying the fourth of the content when a set of prescribed settings is met automatically allows the computer system to maintain the display of a portion of the content such that the user is able to view and/or interact with content while the computer system performs techniques to alleviate discomfort a user may experience as a result of the motion, thereby performing an operation when a set of conditions has been met without requiring further user input.

In some embodiments, while forgoing display of the third portion of the content (e.g., 1210a, 1210b, 1210c, and/or 1201d at FIG. 12G) (e.g., and/or while forgoing display of the second portion of the content), the computer system ceases to detect, via the input device, the motion (e.g., represented by 1212, 1216, and/or 1218 at 12H) (e.g., or any motion). In some embodiments, in response to ceasing to detect the motion, the computer system displays, via the display generation component (e.g., 1212), the third portion of the content (e.g., 1210a, 1210b, and/or 1210c) (e.g., and continuing to forgo the display of the second portion of the content) (e.g., the computer system concurrently displays the third portion of the content and the first portion of the content). In some embodiments, in response to ceasing to detection the motion, the computer system displays the second portion of the content. In some embodiments, the computer system applies a visual effect to the third portion of the content as part of displaying the third portion of the content. Displaying the third portion of the content in response to ceasing to detect the motion allows the computer system to cease performing motion mitigation techniques at a point in time when the motion mitigation techniques are no longer necessary, thereby providing additional control options without cluttering the user interface with additional displayed controls and/or providing improved feedback.

In some embodiments, while forgoing display of the third portion (e.g., 1210a, 1210b, 1210c, and/or 1201d at FIG. 12D), the computer system continues to detect the motion (e.g., represented by 1212, 1216, and/or 1218 at 12B) (e.g., or any motion). In some embodiments, continuing to detect the motion includes detecting a change in one or more characteristics of the motion. In some embodiments, in response to continuing to detect the motion and in accordance with a determination that a magnitude (e.g., average magnitude and/or media magnitude) of one or more characteristics of the motion (e.g., speed, acceleration rate, deacceleration rate, turning force, braking force, and/or direction) is less than a threshold (e.g., as discussed at FIG. 12B) (e.g., a user specific threshold, a context specific threshold, and/or default threshold), the computer system displays, via the display generation component (e.g., 1212), the third portion of the content (e.g., 1210a, 1210b, and/or 1210c) (e.g., while forgoing display of the second portion). In some embodiments, in accordance with a determination that the one or more characteristics of the motion is above the threshold, the computer system continues to forgo display of the third portion. In some embodiments, in response to continuing to detect the motion and in accordance with a determination that the one or more characteristics of the motion is below a threshold, the computer system displays the second portion. In some embodiments, the computer system applies a visual effect to the third portion of the content as part of displaying the third portion of the content. Displaying the third portion of the content when a set of conditions is met automatically allows the computer system to cease performing motion mitigation techniques at a point in time when the motion mitigation techniques are no longer necessary, thereby providing additional control options without cluttering the user interface with additional displayed controls and/or providing improved feedback.

In some embodiments, in accordance with a determination that the user is a first user (e.g., 1220 at FIGS. 12A-12H) (e.g., a primary user, a user registered with the computer system, a tracked user (e.g., a user that is tracked by the computer system and/or a user that is tracked by a set of one or more external cameras), a non-tracked user (e.g., a user that is not tracked by the computer system), first individual, and/or a user not registered with the computer system), the second portion of the content corresponds to (and/or is) a first section (e.g. segment, fraction, fragment, and/or piece) of the content (e.g., as discussed at FIG. 12H). In some embodiments, in accordance with a determination that the user is a second user (e.g., 1220 at FIGS. 12I-12L) (e.g., a primary user, a user registered with the computer system, a tracked user (e.g., a user that is tracked by the computer system), a non-tracked user (e.g., a user that is not tracked by the computer system), second individual, and/or a user not registered with the computer system) different from the first user, the second portion of the content corresponds to (and/or is) a second section (e.g., segment, fraction, fragment, and/or piece) of the content (e.g., as discussed at FIG. 12I) different from the first section of the content (e.g., the second section is larger than the first section, the second section is smaller than the first section, the second section includes different content than the first section). In some embodiments, the second portion of the content is not user dependent. In some embodiments, the second section includes the first section. In some embodiments, content included in the first section corresponds to the first user and content included in the second section corresponds to the second user. Ceasing to display a section of the content when a set of prescribed conditions is met (e.g., whether the user is a first user or a second user) automatically allows the computer system to tailor the performance of motion mitigation techniques on a user-by-user basis, thereby performing an operation when a set of conditions has been met without requiring further user input.

In some embodiments, in accordance with a determination that the motion (e.g., represented by 1212, 1216, and/or 1218 at 12H) has a first set of one or more characteristics (e.g., as discussed at FIGS. 12A-12L) (e.g., speed, acceleration rate, direction, turning force, and/or deacceleration rate), the second portion of the content corresponds to (and/or is) first section of the content (e.g., as discussed at FIGS. 12A-12L) (e.g., segment, fraction, fragment, and/or piece). In some embodiments, in accordance with a determination that the motion has a second set of one or more characteristics (e.g., as discussed at FIGS. 12A-12L) (e.g., speed, acceleration rate, direction, turning force, and/or deacceleration rate) different from the first set of one or more characteristics the second portion of the content corresponds to (and/or is) a second section of the content (e.g., as discussed at FIGS. 12A-12L) (e.g., segment, fraction, fragment, and/or piece) different from the first section of the content (e.g., the second section is larger than the first section, the second section is smaller than the first section, the second section includes different content than the first section). In some embodiments, the second portion of the content is not motion dependent. In some embodiments, the first section of the content corresponds to the first set of one or more characteristics of the motion and the second section of the content corresponds to the second set of one or more characteristics of the motion. Ceasing to display a section of the content when a set of prescribed conditions is met (e.g., whether the motion has a first set of one or more characteristics or a second set of one or more characteristics) automatically allows the computer system to tailor the performance of motion mitigation techniques based on the detected motion, thereby performing an operation when a set of conditions has been met without requiring further user input.

In some embodiments, the first portion is larger (e.g., includes more content and/or covers more of the display generation component) than the second portion (e.g., as discussed at FIGS. 12A-12L). In some embodiments, the second portion is larger than the first portion.

In some embodiments, ceasing display of the second portion of the content includes applying a visual treatment to the second portion of the content (e.g., change of 1210a from FIG. 12B to 12C to 12D) (e.g., and not the first portion of the content) (e.g., fading out the second portion of the content, increasing the opacity of the second portion of the content, dissolving the second portion of the content, and/or animating the second portion of the content). In some embodiments, the computer system does not apply a visual treatment to the second portion of the content as a part of ceasing display of the second portion of the content. In some embodiments, the computer system applies a visual treatment to the first portion of the content as a part of ceasing display of the second portion of the content. In some embodiments, when the computer system applies the same visual treatment or different visual treatments to the first portion of the content and the second portion of the content, Applying a visual treatment to the second portion of the content as a part of ceasing to display the second portion of the content allows the computer system to cease the display of the second portion of the content in a manner that is not visually unpleasant to the user, thereby providing improved feedback and/or providing additional control options without cluttering the user interface with additional displayed controls and/or providing improved feedback.

Note that details of the processes described above with respect to method 1300 (e.g., FIG. 13) are also applicable in an analogous manner to the methods described herein. For example, method 800 optionally includes one or more of the characteristics of the various methods described herein with reference to method 1300. For example, the display of content can be shifted using one or more techniques described herein in relation to method 800, where the content is shifted based on a state of a user described herein relation to method 1300. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. A method, comprising:
at a computer system that is in communication with a display and one or more input devices:
while displaying, via the display, a user interface object in an initial manner, detecting, via the one or more input devices, acceleration in a first direction;
in response to detecting the acceleration in the first direction, displaying, via the display, the user interface object in a subsequent manner different than the initial manner based on the acceleration;
after displaying the user interface object in the subsequent manner based on the acceleration, continuing to detect, via the one or more input devices, the acceleration in the first direction; and
in response to continuing to detect the acceleration in the first direction, displaying, via the display, the user interface object in the initial manner.

2. The method of claim 1, wherein the acceleration in the first direction is a first acceleration, the method further comprising:
before detecting the first acceleration, detecting, via the one or more input devices, a second acceleration; and
in response to detecting the second acceleration, displaying, via the display, the user interface object.

3. The method of claim 1, wherein displaying the user interface object in the subsequent manner includes displaying the user interface object with a particular size, opacity, shape, color, or any combination thereof.

4. The method of claim 1, wherein displaying the user interface object in the subsequent manner includes changing a first visual characteristic of the user interface object at a first point in time, and wherein displaying the user interface object in the subsequent manner includes changing a second visual characteristic of the user interface object, different from the first visual characteristic of the user interface object, at the first point in time.

5. The method of claim 1, further comprising:
while displaying the user interface object, ceasing to detect the acceleration in the first direction; and
in response to ceasing to detect the acceleration in the first direction, ceasing to display the user interface object.

6. The method of claim 1, further comprising:
in response to detecting the acceleration in the first direction:
in accordance with a determination that the first direction is in a first orientation, moving, via the display, the user interface object in a first manner; and
in accordance with a determination that the first direction is in a second orientation different from the first orientation, moving, via the display, the user interface object in a second manner different from the first manner.

7. The method of claim 1, further comprising:
displaying, via the display, content, wherein displaying the user interface object includes overlaying the user interface object on the content.

8. The method of claim 1, wherein the acceleration in the first direction is a first acceleration, the method further comprising:
after detecting the first acceleration, detecting, via one or more input devices, a second acceleration in the first direction;
in response to detecting the second acceleration, ceasing to display, via the display, the user interface object.

9. The method of claim 8, further comprising:
after ceasing display of the user interface object, detecting, via the one or more input devices, a third acceleration in the first direction; and
in response to detecting the third acceleration, displaying, via the display, the user interface object in the initial manner.

10. The method of claim 1, wherein displaying the user interface object includes moving the user interface object, and wherein:
in accordance with a determination that the acceleration has a first magnitude, the user interface object is moved at a first rate; and
in accordance with a determination that the acceleration has a second magnitude, different from the first magnitude, the user interface object is moved at a second rate different from the first rate.

11. The method of claim 1, further comprising:
while displaying the user interface object, detecting, via the input device, that a magnitude of the acceleration is less than an acceleration threshold; and
in response to detecting that the magnitude of the acceleration is less than the acceleration threshold, ceasing to display, via the display, the user interface object.

12. The method of claim 1, wherein continuing to detect the acceleration includes detecting, via the input device, a change in one or more attributes of the acceleration.

13. The method of claim 1, further comprising:
while displaying the user interface object, ceasing to detect, via the input device, the acceleration in the first direction; and
in response to ceasing to detect the acceleration in the first direction, ceasing to display, via the display, the user interface object.

14. The method of claim 1, wherein a magnitude of the acceleration in the first direction is greater than an acceleration threshold.

15. The method of claim 1, wherein the acceleration in the first direction corresponds to an external structure.

16. The method of claim 1, wherein the user interface object is a first user interface object, wherein the first user interface object is displayed at a first location while detecting the acceleration in the first direction, wherein the first user interface object is displayed at a second location, different from the first location, in response to detecting the acceleration in the first direction, the method further comprising:
while displaying the first user interface object in the initial manner, displaying, via the display, a second user interface object, different from the first user interface object, at a third location different from the first location, wherein the first location is in a first direction from the second location; and
in response to detecting the acceleration in the first direction, displaying, via the display, the second user interface object at a fourth location different from the second location and the third location, wherein the fourth location is in the first direction from the third location, wherein a distance between the second location and the first location is a first distance, wherein a distance between the fourth location and the third location is a second distance, and wherein the second distance is the same as the first distance.

17. The method of claim 16, further comprising:
while displaying the first user interface object at the first location and the second user interface object at the third location, displaying, via the display, a third user interface object, different from the first user interface object and the second user interface object, at a fifth location different from the first location and the third location, wherein the first location is in a second direction, different from the first direction, from the fourth location; and
in response to detecting the acceleration in the first direction, displaying, via the display, the third user interface object at a sixth location different from the second location and the fourth location, wherein the fourth location is in the second direction from the third location, wherein a distance between the sixth location and the fifth location is a third distance, and wherein the third distance is the same as the first distance and the second distance.

18. The method of claim 17, wherein the first user interface object is displayed in the initial manner at the same location as the second user interface object, wherein the third user interface object is displayed in the initial manner at a different horizontal location than the first user interface object, and wherein the third user interface object is not displayed in the initial manner at the same location as the first user interface object and the second user interface object.

19. A non-transitory computer-readable storage medium storing one or more programs configured to be executed by one or more processors of a computer system that is in communication with a display and one or more input devices, the one or more programs including instructions for:
while displaying, via the display, a user interface object in an initial manner, detecting, via the one or more input devices, acceleration in a first direction;
in response to detecting the acceleration in the first direction, displaying, via the display, the user interface object in a subsequent manner different than the initial manner based on the acceleration;
after displaying the user interface object in the subsequent manner based on the acceleration, continuing to detect, via the one or more input devices, the acceleration in the first direction; and
in response to continuing to detect the acceleration in the first direction, displaying, via the display, the user interface object in the initial manner.

20. A computer system comprising:
a display;
one or more input devices;
one or more processors; and
memory storing one or more programs configured to be executed by the one or more processors, the one or more programs including instructions for:
while displaying, via the display, a user interface object in an initial manner, detecting, via the one or more input devices, acceleration in a first direction;
in response to detecting the acceleration in the first direction, displaying, via the display, the user interface object in a subsequent manner different than the initial manner based on the acceleration;
after displaying the user interface object in the subsequent manner based on the acceleration, continuing to detect, via the one or more input devices, the acceleration in the first direction; and
in response to continuing to detect the acceleration in the first direction, displaying, via the display, the user interface object in the initial manner.
